(19) United States
(12) Patent Application Publication
(10) Pub. No.: US 2018/0267653 A1
(43) Pub. Date: Sep. 20, 2018

(54) SENSING CONTROLLER

(71) Applicant: Tactual Labs Co., New York, NY (US)

(72) Inventors: David Holman, Toronto (CA); Bruno Rodrigues De Araujo, Toronto (CA); Braon Moseley, Round Rock, TX (US); Ricardo Jorge Jota Costa, Toronto (CA); Kaan Duman, Leesburg, VA (US); Steven Leonard Sanders, New York, NY (US); Darren Leigh, Round Hill, VA (US); Robert Alack, JR., Austin, TX (US); Jonathan Deber, Toronto (CA)

(73) Assignee: Tactual Labs Co., New York, NY (US)

(21) Appl. No.: 15/926,478

(22) Filed: Mar. 20, 2018

Related U.S. Application Data
(60) Provisional application No. 62/473,908, filed on Mar. 20, 2017.
(60) Provisional application No. 62/488,753, filed on Apr. 22, 2017.
(60) Provisional application No. 62/588,267, filed on Nov. 17, 2017.
(60) Provisional application No. 62/619,656, filed on Jan. 19, 2018.
(60) Provisional application No. 62/621,117, filed on Jan. 24, 2018.
(60) Provisional application No. 62/533,405, filed on Jul. 17, 2017.

(51) Int. Cl. G06F 3/047; G06F 3/044; G06F 3/041

(52) U.S. Cl. CPC G06F 3/047; G06F 3/044; G09G 2310/0264; G06F 2203/04112; G06F 3/0416

(57) ABSTRACT

A heterogeneous touch manifold is disclosed. In an embodiment, a layer of row conductors, a layer of column conductors and a layer of additional row conductors are provided, each of the column conductors and the additional row conductors are adapted for connection to receiving circuitry that receives signals thereon and provide a heatmap of signal strength for each of a plurality of unique orthogonal signals. In another embodiment, a layer of row conductors, a layer of column conductors and interleaved antennas are provided, each of the column conductors and the interleaved antennas are adapted for connection to receiving circuitry that receives signals thereon and provide a heatmap of signal strength for each of a plurality of unique orthogonal signals. In an embodiment, a plurality of unique orthogonal signals is provided by a signal generator, unique ones of them being provided to the row conductors, and at least one additional unique orthogonal signal being provided to a signal injector.

This application claims the benefit of U.S. Provisional Patent Application No. 62/473,908, entitled “Hand Sensing Controller,” filed Mar. 20, 2017; U.S. Provisional Patent Application No. 62/488,753, entitled “Heterogenous Sensing Apparatus and Methods” filed on Apr. 22, 2017; U.S. Provisional Patent Application No. 62/588,267, entitled “Sensing Controller” filed on Nov. 17, 2017; U.S. Provisional Patent Application No. 62/619,656, entitled “Matrix Sensor with Receive Isolation” filed on Jan. 19, 2018; and U.S. Provisional Patent Application No. 62/621,117, entitled “Matrix Sensor with Receive Isolation” filed on Jan. 24, 2018, the contents of all aforementioned applications are hereby incorporated herein by reference.

### FIELD

The disclosed system and method relate, in general, to the field of contact and non-contact sensing, and in particular to a sensing controller and methods for sensing and interpreting contact and non-contact events.

### BACKGROUND

This application relates to user interfaces such as the fast multi-touch sensors and other methods and techniques disclosed in: U.S. Pat. No. 9,019,224 filed Mar. 17, 2014 entitled “Low-Latency Touch Sensitive Device”; U.S. Pat. No. 9,235,307 filed Mar. 17, 2014 entitled “Fast Multi-Touch Stylus And Sensor”; U.S. patent application Ser. No. 14/217,015 filed Mar. 17, 2014 entitled “Fast Multi-Touch Sensor With User-Identification Techniques”; U.S. patent application Ser. No. 14/216,791 filed Mar. 17, 2014 entitled “Fast Multi-Touch Noise Reduction”; U.S. Pat. No. 9,158,411 filed Nov. 1, 2013 entitled “Fast Multi-Touch Post Processing”; U.S. patent application Ser. No. 14/603,104, filed 22 Jan. 2015, entitled “Dynamic Assignment of Possible Channels in a Touch Sensor”; U.S. patent application Ser. No. 14/614,295, filed 4 Feb. 2015, entitled “Frequency Conversion in a Touch Sensor”; U.S. patent application Ser. No. 14/466,624, filed 22 Aug. 2014, entitled “Orthogonal Signaling Touch User, Hand and Object Discrimination Systems and Methods”; U.S. patent application Ser. No. 14/812,529, filed 29 Jul. 2015, entitled “Differential Transmission for Reduction of Cross-Talk in Projective Capacitive Touch Sensors”; and U.S. patent application Ser. No. 15/162,240, filed 23 May 2016, entitled “Transmitting and Receiving System and Method for Bidirectional Orthogonal Signaling Sensors”. The entire disclosures of those applications are incorporated herein by reference.

In recent years, the capacitive touch sensors for touch screens have gained popularity, in addition to the development of multi-touch technologies. A capacitive touch sensor comprises rows and columns of conductive material in spatially separated layers (sometimes on the front and back of a common substrate). To operate the sensor, a row is stimulated with an excitation signal. The amount of coupling between each row and column can be affected by an object proximate to the junction between the row and column (i.e., taxel). In other words, a change in capacitance between a row and column can indicate that an object, such as a finger, is touching the sensor (e.g., screen) near the region of intersection of the row and column. By sequentially exciting the rows and measuring the coupling of the excitation signal at the columns, a heatmap reflecting capacitance changes, and thus proximity, can be created.

Generally, taxel data is aggregated into heatmaps. These heatmaps are then post-processed to identify touch events, and the touch events are streamed to downstream processes that seek to understand touch interaction, including, without limitation, gestures, and the objects in which those gestures are performed.

In 2013, the application leading to U.S. Pat. No. 9,019,224 was filed (hereinafter the “'224 patent”). The '224 patent describes a fast multi-touch sensor and method. Among other things, the '224 patent describes simultaneous excitation of the rows using unique, frequency orthogonal signals on each row. According to the '224 patent, the frequency spacing (Δf) between the signals is at least the reciprocal of the measurement period (τ). Thus, as illustrated in the '224 patent, frequencies spaced by 1 KHz (i.e., having a Δf of 1,000 cycles per second) required at least a once per millisecond measurement period (i.e., having τ of 1/1,000th of a second). Numerous patent applications have been filed concerning interaction sensing using a sensor driven by a simultaneous orthogonal signaling scheme, including, without limitation, Applicant's prior U.S. patent application Ser. No. 13/841,436, filed on Mar. 15, 2013 entitled “Low-Latency Touch Sensitive Device” and U.S. patent application Ser. No. 14/069,609 filed on Nov. 1, 2013 entitled “Fast Multi-Touch Post Processing.”

These systems and methods are generally directed to multi-touch sensing on planar sensors. Obtaining information to understand a user's touch, gestures and interactions with an object introduces a myriad of possibilities, but because handheld objects, for example, come in a multitude of shapes, it can be difficult to incorporate capacitive touch sensors into objects such as a controller, ball, stylus, wearable device, and so on, so that the sensors can thereby provide information relative to a user's gestures and other interactions with the handheld objects.

While fast multi-touch sensors enable faster sensing on planar and non-planar surfaces, they lack substantial capabilities to provide detailed detection of non-contact touch events occurring more than a few millimeters from the sensor surface. Fast multi-touch sensors also lack substantial capabilities to provide more detailed information relative to the identification, and/or position and orientation of body parts (for example, the finger(s), hand, arm, shoulder, leg, etc.) while users are performing gestures or other interactions.

### BRIEF DESCRIPTION OF THE DRAWINGS

The foregoing and other objects, features, and advantages of the disclosure will be apparent from the following more particular descriptions of embodiments as illustrated in the accompanying drawings, in which the reference characters refer to the same parts throughout the various views. The drawings are not necessarily to scale, with emphasis instead being placed upon illustrating principles of the disclosed embodiments.

FIG. 1 provides a high-level block diagram illustrating an embodiment of a low-latency touch sensor device having two conductive layers.

FIG. 2A shows a setup for amplitude measurements.

FIG. 2B shows another view of a setup for amplitude measurements.

FIG. 3 is a table of illustrative amplitude measurements, in mVpp, for injected signals conducted across areas of a hand.

FIG. 4 shows an embodiment of a wiring and shielding scheme for an antenna sensor.

FIG. 5 illustrates a setup with a 2×2 grid of antenna sensors on a rectangular grid.

FIG. 6 illustrates a wearable glove, in accordance with an embodiment, with the wearable glove having both signal injection conductors and an electrode to support the isolation of frequencies in the fingers.

FIG. 7A illustrates results for an injected frequency, in dB, achieved using a 2-by-2 grid of antenna sensors and a frequency injected index finger moving among the antenna sensors.

FIG. 7B illustrates results for an injected frequency, in dB, achieved using a 2-by-2 grid of antenna sensors and a frequency injected index finger moving among the antenna sensors.

FIG. 7C illustrates results for an injected frequency, in dB, achieved using a 2-by-2 grid of antenna sensors and a frequency injected index finger moving among the antenna sensors.

FIG. 7D illustrates results for an injected frequency, in dB, achieved using a 2-by-2 grid of antenna sensors and a frequency injected index finger moving among the antenna sensors.

FIG. 8A illustrates results for an injected frequency, in dB, achieved using a 2-by-2 grid of antenna sensors as an index finger and a middle finger simultaneously touch two antenna sensors.

FIG. 8B illustrates results for an injected frequency, in dB, achieved using a 2-by-2 grid of antenna sensors as an index finger and a middle finger simultaneously touch two antenna sensors.

FIG. 8C illustrates results for an injected frequency, in dB, achieved using a 2-by-2 grid of antenna sensors as an index finger and a middle finger simultaneously touch two antenna sensors.

FIG. 9A illustrates results for an injected frequency, in dB, achieved using a 2-by-2 grid of antenna sensors as a hand moves towards and away from the antenna sensors.

FIG. 9B illustrates results for an injected frequency, in dB, achieved using a 2-by-2 grid of antenna sensors as a hand moves towards and away from the antenna sensors.

FIG. 9C illustrates results for an injected frequency, in dB, achieved using a 2-by-2 grid of antenna sensors as a hand moves towards and away from the antenna sensors.

FIG. 9D illustrates results for an injected frequency, in dB, achieved using a 2-by-2 grid of antenna sensors as a hand moves towards and away from the antenna sensors.

FIG. 10A illustrates results for two injected frequencies, in dB, achieved using a 2-by-2 grid of antenna sensors as an index finger moves among the antenna sensors.

FIG. 10B illustrates results for two injected frequencies, in dB, achieved using a 2-by-2 grid of antenna sensors as an index finger moves among the antenna sensors.

FIG. 10C illustrates results for two injected frequencies, in dB, achieved using a 2-by-2 grid of antenna sensors as an index finger moves among the antenna sensors.

FIG. 10D illustrates results for two injected frequencies, in dB, achieved using a 2-by-2 grid of antenna sensors as an index finger moves among the antenna sensors.

FIG. 11A illustrates results for two injected frequencies, in dB, achieved using a 2-by-2 grid of antenna sensors as a ring finger moves among the antenna sensors.

FIG. 11B illustrates results for two injected frequencies, in dB, achieved using a 2-by-2 grid of antenna sensors as a ring finger moves among the antenna sensors.

FIG. 11C illustrates results for two injected frequencies, in dB, achieved using a 2-by-2 grid of antenna sensors as a ring finger moves among the antenna sensors.

FIG. 11D illustrates results for two injected frequencies, in dB, achieved using a 2-by-2 grid of antenna sensors as a ring finger moves among the antenna sensors.

FIG. 12A illustrates results for two injected frequencies, in dB, achieved using a 2-by-2 grid of antenna sensors as an index finger and a ring finger simultaneously move among the antenna sensors.

FIG. 12B illustrates results for two injected frequencies, in dB, achieved using a 2-by-2 grid of antenna sensors as an index finger and a ring finger simultaneously move among the antenna sensors.

FIG. 12C illustrates results for two injected frequencies, in dB, achieved using a 2-by-2 grid of antenna sensors as an index finger and a ring finger simultaneously move among the antenna sensors.

FIG. 12D illustrates results for two injected frequencies, in dB, achieved using a 2-by-2 grid of antenna sensors as an index finger and a ring finger simultaneously move among the antenna sensors.

FIG. 13A illustrates results for two injected frequencies, in dB, achieved using a 2-by-2 grid of antenna sensors as a hand moves towards and away from the antenna sensors.

FIG. 13B illustrates results for two injected frequencies, in dB, achieved using a 2-by-2 grid of antenna sensors as a hand moves towards and away from the antenna sensors.

FIG. 13C illustrates results for two injected frequencies, in dB, achieved using a 2-by-2 grid of antenna sensors as a hand moves towards and away from the antenna sensors.

FIG. 13D illustrates results for two injected frequencies, in dB, achieved using a 2-by-2 grid of antenna sensors as a hand moves towards and away from the antenna sensors.

FIG. 14 illustrates an embodiment of a conductor layer for use in a heterogeneous sensor.

FIG. 15 illustrates a schematic layout of an exemplary heterogeneous layer sensor.

FIG. 16 shows an illustration of an embodiment of a heterogeneous sensor having interleaved antenna sensors and two conductive layers.

FIG. 17 shows an illustration of the connection between interleaved antenna sensors and their associated receiver circuitry.

FIG. 18 shows an illustration of an embodiment of a heterogeneous sensor having interleaved antenna sensors and two conductive layers as shown in FIG. 16, with connections between the interleaved antenna sensors and their associated circuitry.

FIG. 19 shows an illustration of another embodiment of a heterogeneous sensor having interleaved antenna sensors and signal injection conductors and two conductive layers.

FIG. 20 shows an illustration of the connection between interleaved antenna sensors and their associated receiver circuitry and signal injection conductors and their associated signal drive circuitry in an embodiment like FIG. 19.

FIG. 21 shows an illustration of an embodiment of a heterogeneous sensor having interleaved antenna sensors and their associated receiver circuitry and signal injection conductors and their associated signal drive circuitry and two conductive layers as shown in FIG. 19.

FIG. 22 is an illustration of an embodiment of a handheld controller.

FIG. 23A is an illustration of a strap configuration for a controller.

FIG. 23B is another illustration of a strap configuration for a controller.

FIG. 24 is an illustration of an embodiment of a multi-layer sensor manifold that can be used on a curved surface, such as a handheld controller.

FIG. 25 is an illustration of an embodiment of a multi-layer sensor manifold that has antenna sensors.

FIG. 26 is an illustration of an embodiment of a multi-layer sensor manifold as generally shown in FIG. 24 additionally having antenna sensors.

FIG. 27 is an illustration of another embodiment of a multi-layer sensor manifold having antenna sensors.

FIG. 28 is an illustration of another embodiment of a multi-layer sensor manifold having a different row and column design than that shown in FIGS. 24 and 26.

FIG. 29 is an illustration of another embodiment of a multi-layer sensor manifold having a different row and column design and having antenna sensors and signal injection conductor electrodes.

FIG. 30 is an illustration of another embodiment of multi-layer sensor manifolds having a split or distributed row and column design and having antenna sensors and signal injection conductor electrodes.

FIG. 31A shows illustrative embodiments of sensor patterns for use in connection with a thumb-centric portion of a controller.

FIG. 31B shows illustrative embodiments of sensor patterns for use in connection with the thumb-centric portion of a controller.

FIG. 31C shows an illustrative embodiment of a three-layer sensor pattern for use in connection with the thumb-centric portion of a controller.

FIG. 31D shows an illustrative embodiment of a three-layer sensor pattern for use in connection with the thumb-centric portion of a controller.

FIG. 31E shows an illustrative embodiment of a three-layer sensor pattern for use in connection with the thumb-centric portion of a controller.

FIG. 32A shows an illustrative embodiment of sensor patterns for use in connection with the thumb-centric portion of a controller as generally shown in FIGS. 31A and 31B additionally having antenna sensors and how the antenna sensors can be located on a separate manifold, yet when viewed from the top down appear to overlap the rows and columns of another manifold.

FIG. 32B shows illustrative embodiments of sensor patterns for use in connection with the thumb-centric portion of a controller as generally shown in FIGS. 31A and 31B additionally having antenna sensors, and how the antenna sensors can be located on a separate manifold, yet when viewed from the top down appear to overlap the rows and columns of another manifold.

FIG. 32C illustrates how the antenna sensors can be located on a separate manifold, yet when viewed from the top down appear interleaved within the rows and columns of another manifold.

FIG. 32D illustrates how the antenna sensors can be located on a separate manifold, yet when viewed from the top down appear interleaved within the rows and columns of another manifold.

FIG. 33 shows an illustration of the human hand and a series of joints and bones in the hand that are relevant to a device, in accordance with one embodiment of the invention.

FIG. 34 illustrates a high-level, flow diagram showing one embodiment of a method of using sensor data to infer the skeletal position of the hand and fingers relative to the sensor.

FIG. 35 is a block diagram showing an embodiment of a skeletal hand and finger reconstruction model creation workflow.

FIG. 36 is a block diagram showing an embodiment of a real-time skeletal hand and finger reconstruction workflow.

FIG. 37 illustrates a heatmap of fingers grasping a controller.

FIG. 38 shows a flowchart of a composite process to process motion in separated regions.

FIG. 39 shows an illustrative heatmap reflecting digit positions recorded on a handheld controller such as the one shown in FIG. 22.

FIG. 40 shows an illustration of the results of a segmented local maxima computation on the heatmap shown in FIG. 39.

FIG. 41 shows a superimposition of local maxima illustrated in FIG. 40 on the heatmap of FIG. 39.

FIG. 42A shows an illustrative example of a circle-fit and an illustration of an exemplary method for rejecting superfluous data.

FIG. 42B shows an illustrative example of a circle-fit and an illustration of an exemplary method for rejecting superfluous data.

FIG. 43 shows finger separation superimposed on the non-superfluous local maxima shown in FIG. 39.

FIG. 44 shows an illustration showing enlarged local maxima in bounding boxes.

FIG. 45 shows an illustration showing enlarged local maxima in bounding boxes for a different hand than the one shown in FIG. 44.

FIG. 46 shows an illustrative finger separation superimposed on enlarged the local maxima in bounding boxes shown in FIG. 45.

FIG. 47 provides an illustration showing a small segment error resulting from bunched fingers on the digit positions reflected in FIG. 46.

FIG. 48 shows an embodiment of a handheld controller having a strap, with the strap and other concealing material moved to show a signal infusion area.

FIG. 49 shows a superimposition of a heatmap (graph) of signal infusion data and illustrative finger separation on the heatmap of FIG. 39.

FIG. 50A shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50B shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50C shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50D shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50E shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50F shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50G shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50H shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50I shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50J shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50K shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 50L shows a heatmap reflecting digit positions recorded on a handheld controller such as the one shown in FIG. 22; the non-superfluous local maxima calculated from the heatmap reflecting digit position; a heatmap (graph) of signal infusion data; and superimposed finger separation lines.

FIG. 51 shows a flowchart of a composite process to process the position and motion of the thumb.

FIG. 52 shows a table reflecting representation of skeleton data as illustrated in FIG. 33, in accordance with an embodiment of the invention.

FIG. 53 shows an embodiment of a data structure that can be used to represent a user's finger information.

FIG. 54 is a table illustrating an embodiment of skeleton poses for an exemplary right hand. All positions (x,y,z) are in meters. The axes for each bone takes into account any rotation done by any of the bone's ancestors, as illustrated in FIG. 33. All translation and rotation is relative to a bone's parent. All quantities given are accurate to five decimal places. By default, all scale values (sx, sy, sz) have values of 1.0 and are not included in the tables.

FIG. 55 is a table illustrating an embodiment of skeleton poses for an exemplary right hand. All positions (x,y,z) are in meters. The axes for each bone takes into account any rotation done by any of the bone's ancestors, as illustrated in FIG. 33. All translation and rotation is relative to a bone's parent. All quantities given are accurate to five decimal places. By default, all scale values (sx, sy, sz) have values of 1.0 and are not included in the tables.

FIG. 56A shows an embodiment where multiple signals are being injected into the user from one or more devices.

FIG. 56B shows an embodiment where multiple signals are being injected into the user from one or more devices.

FIG. 57 shows diagrams illustrating where multiple signals are being injected into multiple users from one or more devices, which the users may or may not be holding themselves.

FIG. 58 is a schematic illustration of one embodiment of a signal injection system for a hand.

FIG. 59 is a schematic illustration of another embodiment of the signal injection system shown in FIG. 58.

FIG. 60A is an illustration of a hand pose with respect to an object such as a game controller.

FIG. 60B is an illustration of a hand pose with respect to an object such as a game controller.

FIG. 60C is an illustration of a hand pose with respect to an object such as a game controller.

FIG. 60D is an illustration of a hand pose with respect to an object such as a game controller.

FIG. 60E is an illustration of a hand pose with respect to an object such as a game controller.

FIG. 60F is an illustration of a hand pose with respect to an object such as a game controller.

FIG. 61 is a schematic illustration of a bimanual variation of the embodiment of the signal injection system shown in FIG. 58.

FIG. 62A illustrates the sensitivity of a soft sensor according to one embodiment of the inventions herein.

FIG. 62B illustrates the sensitivity of a soft sensor according to one embodiment of the inventions herein.

FIG. 62C illustrates the sensitivity of a soft sensor according to an embodiment.

FIG. 63 shows an embodiment of a soft foam sensor being used to infer skeletal positioning in accordance with another embodiment.

FIG. 64 shows two frequency-injected occupants in a car being separately identified as they access a common interface.

### DETAILED DESCRIPTION

Throughout this disclosure, the terms “touch”, “touches”, “contact”, “contacts”, “hover”, or “hovers” or other descriptors may be used to describe events or periods of time in which a user's finger, a stylus, an object, or a body part is detected by a sensor. In some sensors, detections occur only when the user is in physical contact with a sensor, or a device in which it is embodied. In some embodiments, and as generally denoted by the word “contact”, these detections occur as a result of physical contact with a sensor, or a device in which it is embodied. In other embodiments, and as sometimes generally referred to by the term “hover”, the sensor may be tuned to allow for the detection of “touches” that are hovering at a distance above the touch surface or otherwise separated from the sensor device and causes a recognizable change, despite the fact that the conductive or capacitive object, e.g., a finger, is not in actual physical contact with the surface. Therefore, the use of language within this description that implies reliance upon sensed physical contact should not be taken to mean that the techniques described apply only to those embodiments; indeed, nearly all, if not all, of what is described herein would apply equally to “contact” and “hover”, each of which being a “touch”. Generally, as used herein, the word “hover” refers to non-contact touch events or touch, and as used herein the term “hover” is one type of “touch” in the sense that “touch” is intended herein. Thus, as used herein, the phrase “touch event” and the word “touch” when used as a noun include a near touch and a near touch event, or any other gesture that can be identified using a sensor. “Pressure” refers to the force per unit area exerted by a user contact (e.g., presses their fingers or hand) against the surface of an object. The amount of “pressure” is similarly a measure of “contact”, i.e., “touch”. “Touch” refers to the states of “hover”, “contact”, “pressure”, or “grip”, whereas a lack of “touch” is generally identified by signals being below a threshold for accurate measurement by the sensor. In accordance with an embodiment, touch events may be detected, processed, and supplied to downstream computational processes with very low latency, e.g., on the order of ten milliseconds or less, or on the order of less than one millisecond.

As used herein, and especially within the claims, ordinal terms such as first and second are not intended, in and of themselves, to imply sequence, time or uniqueness, but rather, are used to distinguish one claimed construct from another. In some uses where the context dictates, these terms may imply that the first and second are unique. For example, where an event occurs at a first time, and another event occurs at a second time, there is no intended implication that the first time occurs before the second time. However, where the further limitation that the second time is after the first time is presented in the claim, the context would require reading the first time and the second time to be unique times. Similarly, where the context so dictates or permits, ordinal terms are intended to be broadly construed so that the two identified claim constructs can be of the same characteristic or of different characteristic. Thus, for example, a first and a second frequency, absent further limitation, could be the same frequency—e.g., the first frequency being 10 Mhz and the second frequency being 10 Mhz; or could be different frequencies—e.g., the first frequency being 10 Mhz and the second frequency being 11 Mhz. Context may dictate otherwise, for example, where a first and a second frequency are further limited to being orthogonal to each other in frequency, in which case, they could not be the same frequency.

The presently disclosed heterogeneous sensors and methods provide for the detection of touch and non-contact touch events and detect more data and resolve more accurate data resulting from touch events occurring on the sensor surface and touch events (including near and far non-contact touch events) occurring away from the sensor surface.

### Fast Multi-Touch Sensing (FMT)

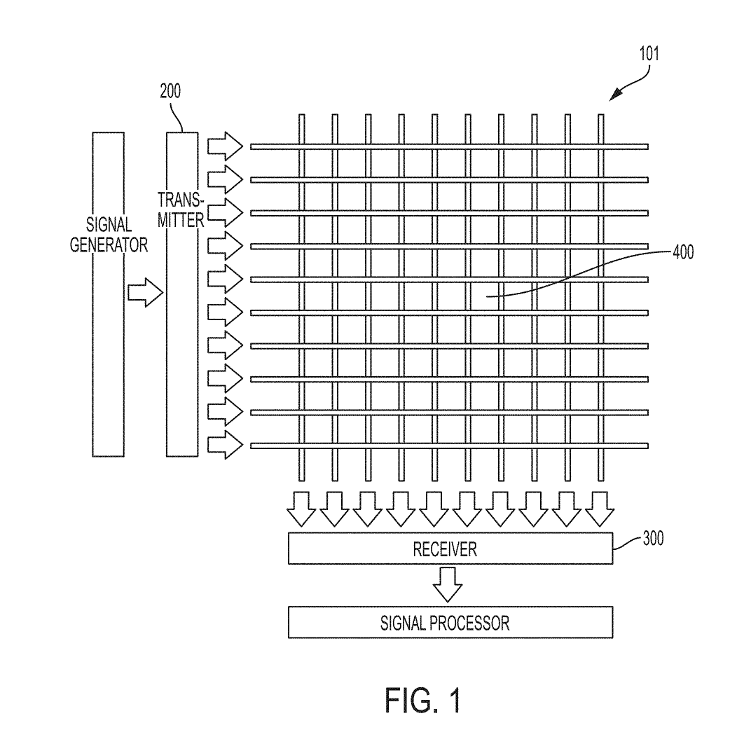

FIG. 1 illustrates certain principles of a fast multi-touch sensor 100 in accordance with an embodiment. Transmitter 200 transmits a different signal into each of the surface's rows. Generally, the signals are “orthogonal”, i.e. separable and distinguishable from each other. Receiver 300 is attached to each column. The receiver 300 is designed to receive any of the transmitted signals, or an arbitrary combination of them, and to individually measure the quantity of each of the orthogonal transmitted signals present on that column. The touch surface 400 of the sensor 100 comprises a series of rows and columns (not all shown), along which the orthogonal signals can propagate.

In an embodiment, a touch event proximate to, or in the vicinity of, a row-column junction causes a change in coupling between the row and column. In an embodiment, when the rows and columns are not subject to a touch event, a lower or negligible amount of signal may be coupled between them, whereas, when they are subject to a touch event, a higher or non-negligible amount of signal is coupled between them. In an embodiment, when the rows and columns are not subject to a touch event, a higher amount of signal may be coupled between them, whereas, when they are subject to a touch event, a lower amount of signal is coupled between them. As discussed above, the touch, or touch event does not require a physical touching, but rather an event that affects the level of the coupled signal.

Because the signals on the rows are orthogonal, multiple row signals can be coupled to a column and distinguished by the receiver. Likewise, the signals on each row can be coupled to multiple columns. For each column coupled to a given row, the signals found on the column contain information that will indicate which rows are being touched simultaneously with that column. The signal strength or quantity of each signal received is generally related to the amount of coupling between the column and the row carrying the corresponding signal, and thus, may indicate a distance of the touching object to the surface, an area of the surface covered by the touch, and/or the pressure of the touch.

In an embodiment, the orthogonal signals being transmitted into the rows may be unmodulated sinusoids, each having a different frequency, the frequencies being chosen so that they can be easily distinguished from each other in the receiver. In an embodiment, frequencies are selected to provide sufficient spacing between them such that they can be easily distinguished from each other in the receiver. In an embodiment, no simple harmonic relationships exist between the selected frequencies. The lack of simple harmonic relationships may mitigate nonlinear artifacts that can cause one signal to mimic another.

In an embodiment, a “comb” of frequencies may be employed. In an embodiment, the spacing between adjacent frequencies is constant. In an embodiment, the highest frequency is less than twice the lowest. In an embodiment, the spacing between frequencies, Δf, is at least the reciprocal of the measurement period τ. In an embodiment, to determine the strength of row signals present on a column the signal on the column is received over a measurement period τ. In an embodiment, a column may be measured for one millisecond (τ) using frequency spacing (Δf) of one kilohertz (i.e., Δf=1/τ). In an embodiment, a column is measured for one millisecond (τ) using frequency spacing (Δf) greater than or equal to one kilohertz (i.e., Δf>1/τ). In an embodiment, a column may be measured for one millisecond (τ) using frequency spacing (Δf) greater than or equal to one kilohertz (i.e., Δf≥1/τ). It will be apparent to one of skill in the art in view of this disclosure that the one millisecond measurement period (τ) is merely illustrative, and that other measurement periods can be used. It will be apparent to one of skill in the art in view of this disclosure that frequency spacing may be substantially greater than the minimum of Δf=1/τ to permit robust design.

In an embodiment, unique orthogonal sinusoids may be generated by a drive circuit or signal generator. In an embodiment, unique orthogonal sinusoids may be transmitted on separate rows by a transmitter. To identify touch events, a receiver receives signals present on a column and a signal processor analyzes the signal to determine the strength of each of the unique orthogonal sinusoids. In an embodiment, the identification can be supported with a frequency analysis technique, or by using a filter bank. In an embodiment, the identification can be supported with a Fourier transform. In an embodiment, the identification can be supported with a fast Fourier transform (FFT). In an embodiment, the identification can be supported with a discrete Fourier transform (DFT). In an embodiment, a DFT is used as a filter bank with evenly-spaced bandpass filters. In an embodiment, prior to analysis, the received signals can be shifted (e.g., heterodyned) to a lower or higher center frequency. In an embodiment, when shifting the signals, the frequency spacing of the unique orthogonal signals is maintained.

Once the signals' strengths have been calculated (e.g., for at least two frequencies (corresponding to rows) or for at least two columns), a two-dimensional heatmap can be created, with the signal strength being the value of the map at that row/column intersection. In an embodiment, the signals' strengths are calculated for each frequency on each column. In an embodiment, the signal strength is the value of the heatmap at that row/column intersection. In an embodiment, post processing may be performed to permit the heatmap to more accurately reflect the events it portrays. In an embodiment, the heatmap can have one value represent each row-column junction. In an embodiment, the heatmap can have two or more values (e.g., quadrature values) represent each row/column junction. In an embodiment, the heatmap can be interpolated to provide more robust or additional data. In an embodiment, the heatmap may be used to infer information about the size, shape, and/or orientation of the interacting object.

In an embodiment, a modulated or stirred sinusoid may be used in lieu of, in combination with, and/or as an enhancement of, the sinusoid embodiment. In an embodiment, frequency modulation of the entire set of sinusoids may be used to keep them from appearing at the same frequencies by “smearing them out.” In an embodiment, the set of sinusoids may be frequency modulated by generating them all from a single reference frequency that is, itself, modulated. In an embodiment, the sinusoids may be modulated by periodically inverting them on a pseudo-random (or even truly random) schedule known to both the transmitter and receiver. Because many modulation techniques are independent of each other, in an embodiment, multiple modulation techniques could be employed at the same time, e.g. frequency modulation and direct sequence spread spectrum modulation of the sinusoid set. Although potentially more complicated to implement, such multiple modulated implementation may achieve better interference resistance.

While the discussion above focused on magnitude, phase shift of the signal may also provide useful information. It has been understood that a measure corresponding to signal strength in a given bin (e.g., (I²+Q²) or (I²+Q²)^{1/2}) changes as a result of a touch event proximate to a pixel. Because the square-root function is computationally expensive, the former (I²+Q²) is often a preferred measurement. Attention has not been focused on phase shift occurring as a consequence of touch or other sensor interaction, likely because in an uncorrelated system, the phases of the signals received tend to be random from frame to frame. The recent development of frame-phase synchronization overcame certain conditions in which noise or other artifacts produce interference with, jitter in, or phantom touches on an FMT sensor. Nonetheless, frame-phase synchronization was used in an effort to better measure the signal strength.

Synchronization of the phase from frame to frame, however, led to the discovery that touch events affect the phase of signals, and thus, touch events can be detected by examining changes in the phase corresponding to a received frequency (e.g., a bin). Thus, in addition to the received signal strength, the received signal phase also informs detection. In an embodiment, phase changes are used to detect events. In an embodiment, a combination of changes in signal strength and changes in phase are used to detect touch events. In an embodiment, an event delta (a vector representing a change of phase and the change in signal strength of the received signal) is calculated. In an embodiment, events are detected by examining the change in a delta over time.

The implementation of frame-phase synchronization provides an opportunity for obtaining another potential source of data that can be used for detecting, identifying and/or measuring an event. At least some of the noise that affects the measurement of the signal strength may not affect the measurement of phase. Thus, this phase measurement may be used instead of, or in combination with a signal strength measurement to detect, identify and/or measure a touch event. The measurement of received signal can refer to measurement of the phase, determination of signal strength and/or both. For the avoidance of doubt, it is within the scope of detecting, identifying and/or measuring an event to detect, identify and/or measure hover (non-touch), contact and/or pressure.

Absent frame-phase synchronization, even in the absence of other stimuli (such as touch), phase may not remain stable from one frame to another. In an embodiment, if phase were to change from one frame to another (e.g., due to lack of synchronization) the information that could be extracted from changes in the phase may not reveal meaningful information about an event. In an embodiment, synchronization of phase for each frame (e.g., by methods discussed) in the absence of other stimuli, phase remains stable frame-to-frame, and meaning can be extracted from frame-to-frame changes in phase.

Many applications for capacitive sensing have involved touch screens. Accordingly, the level of visual transparency of a touch sensor has been important to persons of skill in the art. But it will be apparent to a person of skill in the art in view of this disclosure that because of the properties of the presently disclosed technology and innovations in some embodiments, visual transparency is not a primary consideration. In some embodiments, visual transparency may be a secondary consideration. In some embodiments, visual transparency is not a consideration at all.

### Frequency Injection (Infusion)

Generally, as the term is used herein, frequency injection (also referred to as infusion) refers to the process of transmitting signals of a particular frequency (or of particular frequencies) to the body of a user, effectively allowing the body (or parts of the body) to become an active transmitting source. In an embodiment, an electrical signal is injected into the hand (or other part of the body), and this signal can be detected by the capacitive touch detector even when the hand (or fingers or other part of the body) are not in direct contact with the touch surface. This allows the proximity and orientation of the hand (or finger or some other body part) to be determined, relative to a surface. In an embodiment, signals are carried (e.g., conducted) by the body, and depending on the frequencies involved, may be carried near the surface or below the surface as well. In an embodiment, frequencies of at least the KHz range may be used in frequency injection. In an embodiment, frequencies in the MHz range may be used in frequency injection.

In an embodiment, frequency injection interactions can provide hover information up to 10 cm away. In an embodiment, frequency injection interactions can provide hover information at distances greater than 10 cm. In an embodiment, frequency injection interactions provide a signal level (in dB) that is roughly linear with distance. In an embodiment, received signal levels can be achieved by injecting a low amplitude voltage, e.g., 1 Volt peak-to-peak (Vpp). Single or multiple frequencies can be injected by each signal injection conductor. As used herein, the term “signal injection conductor” refers to an electrode; the terms “electrode”, “electrode dot”, “dot electrode” and “dot” may also be used interchangeably with the term “signal injection conductor”. In an embodiment, for skin contact, a dot electrode may employ a contact substance that is effective in converting between the ionic signal and the electrical signal. In an embodiment, the dot electrode can use a silver or silver chloride sensing element. In an embodiment, a Red Dot™ Monitoring Electrode with Foam Tape and Sticky Gel, available from 3M, may be employed as a signal injection conductor.

In an embodiment, a single dot electrode can be used to inject one or more frequencies. In an embodiment, each of a plurality of dot electrodes spaced from one another can be used to inject single or multiple frequencies. In an embodiment, dot electrodes may be used to inject signal into a plurality of the digits on a hand. In an embodiment, dot electrodes may be used to inject one or more frequencies into or onto a user at one, or a plurality of other body parts. These might include ears, the nose, the mouth and jaw, feet and toes, elbows and knees, chest, genitals, buttocks, etc. In an embodiment, dot electrodes may be used to inject signal to a user at one, or a plurality of locations on a seat, rest, or restraint.

In an embodiment, the degree of contact between the user and the dot electrode may dictate the amplitude voltage used. In an embodiment, if a highly conductive connection is made between the user and the dot electrode, a lower amplitude voltage may be used, whereas if a less conductive connection is made between the user and the dot electrode, a higher amplitude voltage may be used. In an embodiment, actual contact is not required between the dot electrode and the skin of the user. In an embodiment, clothing and/or other layers may exist between the dot electrode and the user.

In an embodiment, where the injection point is generally closer to the user interaction point, a lower amplitude voltage may be used; although care must be taken to allow the user's body to conduct the signal, and not to have the injection point so close to the user interaction point that the dot electrode itself interacts at a meaningful level with the various receivers measuring interaction. When referring to an injection point or an interaction point herein, it should be understood that this refers not to an actual point, but rather to an area where the signal is injected or where the interaction takes place, respectively. In an embodiment, the injection point is relatively small area. In an embodiment, the interaction point is a relatively small area. In an embodiment, the interaction point is a finger pad. In an embodiment, the interaction point is a large area. In an embodiment, the interaction point is an entire hand. In an embodiment, the interaction point is an entire person.

In an embodiment, dot electrodes are located at the mid-finger and fingertips may be used as the body-side of the interaction area. In an embodiment, where multiple injection points are used on a body, other locations of the body may be grounded to better isolate the signals. In an embodiment, frequencies are injected at the mid-finger on a plurality of digits, while a grounding contact is placed near one or more of the proximal knuckles. Grounding contacts may be similar (or identical) in form and characteristics with electrode dots. In an embodiment, for application directly to the skin, similar dot electrodes employing a silver or silver chloride sensing element may be used. In an embodiment, the identity of the fingers near a particular sensor is enhanced by injecting different frequencies to each finger and grounding around, and/or between them. As an example, five injector pads may be positioned proximate to the five knuckles where the fingers join to the hand, and ten unique, frequency orthogonal signals (frequency orthogonal with the other injected signals and the signals used by the touch detector) are injected into the hand via each of the five injector pads. In the example, each of the five injector pads injects two separate signals, an in an embodiment, each pair of signals are at relatively distant frequencies from each other because higher and lower frequencies have differing detection characteristics.

In an embodiment, dot electrodes can be used for both injecting (e.g., transmitting) and receiving signals. In an embodiment, the signal or signals injected may be periodic. In an embodiment, the signal or signals injected may be sinusoidal. In an embodiment, an injected signal can comprise one or more of a set of unique orthogonal signals. In an embodiment, an injected signal can comprise one or more of a set of unique orthogonal signals, where other signals from that set are transmitted on other dot electrodes. In an embodiment, an injected signal can comprise one or more of a set of unique orthogonal signals, where other signals from that set are transmitted on the rows of a heterogeneous sensor. In an embodiment, an injected signal can comprise one or more of a set of unique orthogonal signals, where other signals from that set are transmitted on both other dot electrodes and the rows of a heterogeneous sensor. In an embodiment, the sinusoidal signals have a 1 Vpp. In an embodiment, the sinusoidal signals are generated by a drive circuitry. In an embodiment, the sinusoidal signals are generated by a drive circuitry including a waveform generator. In an embodiment, an output of the waveform generator is fed to each dot electrode that is used to inject signal. In an embodiment, more than one output of the waveform generator is fed to each dot electrode that is used to inject signal.

In an embodiment, it is not required that the transmitted sinusoids are of very high quality, but rather, the disclosed system and methods can accommodate transmitted sinusoids that have more phase noise, frequency variation (over time, temperature, etc.), harmonic distortion and other imperfections than may usually be allowable or desirable in radio circuits. In an embodiment, a number of frequencies may be generated by digital means and then employ a relatively coarse analog-to-digital conversion process. In an embodiment, the generated orthogonal frequencies should have no simple harmonic relationships with each other, any non-linearities in the described generation process should not cause one signal in the set to “alias” or mimic another.

In an exemplary embodiment, a single frequency is injected into a hand via a dot electrode placed at one of numerous different locations on the hand. Experimental measurements have shown that—using 1 Vpp, at least at some frequencies—the hand is a good conductor, and an injected signal can be measured with almost no loss from every location of the hand. In an embodiment, a signal injected hand can provide additional data for touch, including hover.

Thus, in an embodiment, a signal injected hand can be regarded as a source of signal for the receiving antenna or rows. As used herein, the term antenna or receive antenna refers to conductive material appropriately connected to a receiver that can detect signals incident on the antenna; “dot sensor”, “dot”, “point”, “spot”, or “localized spot”, may also be used interchangeably with the term antenna.

In an embodiment, different locations of the hand are injected with different orthogonal frequencies. Despite the spatially separate locations of the signal injection conductors, within a certain frequency and Vpp range, all injected frequencies have a uniform amplitude throughout the hand. In an embodiment, grounding regions can be used to isolate different frequencies in different portions of the hand.

Consider an example where one frequency is injected via an electrode located on the index finger, and an orthogonal frequency is injected via another electrode located on the ring finger. In an embodiment, both injected frequencies have relatively uniform amplitude throughout the hand. In an embodiment, a conductive material, for example, but not limited to, copper tape, can be deployed around the proximal knuckles and connected to ground to achieve substantial isolation of frequencies injected into the fingers. In an embodiment, a ground runs around and between all four fingers, and provides isolation for each of those fingers. In an embodiment, a ground sink may be deployed by connecting a dot electrode to ground and placing the dot electrode in contact with the skin at a location between the two injection electrodes. In an embodiment, a grounded conductor may cause the amplitude nearer to one injector to be considerably higher than the amplitude of another more distant injector, especially if the path from the more distant injector to the measuring point crosses the grounded conductor. In an embodiment, a grounded conductor around the knuckles may cause the amplitude of the index finger frequency to be considerably higher than the amplitude of the ring finger frequency.

In an embodiment, isolating the fingers allows for the identification of different fingers from the sensor data, from the frequency or frequencies with the highest amplitude signal where they are received, e.g., on rows, on antennas, or dot sensors.

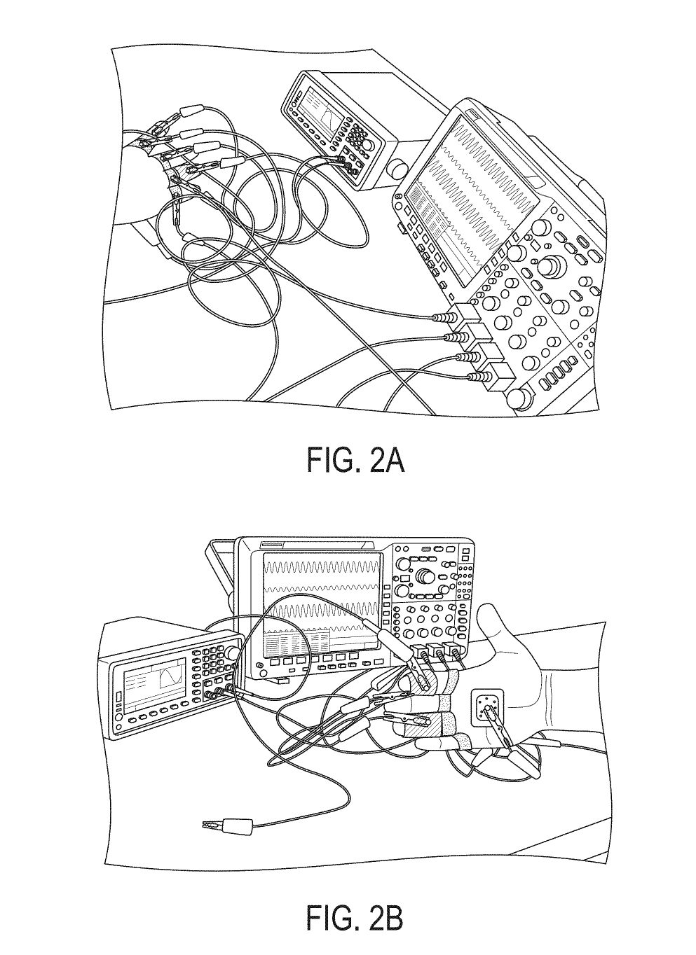

FIGS. 2A and AB show an exemplary measurement setup. In an embodiment, an injection signal conductor is placed in the backside of the index finger and measurements are taken at dot electrodes placed on the palm side of the index finger, middle finger, ring finger, and the palm. In an embodiment, the ground is established using copper tape covering all the knuckles on the back and front side of the hand. In an embodiment, ground may be established using braided copper around the knuckles.

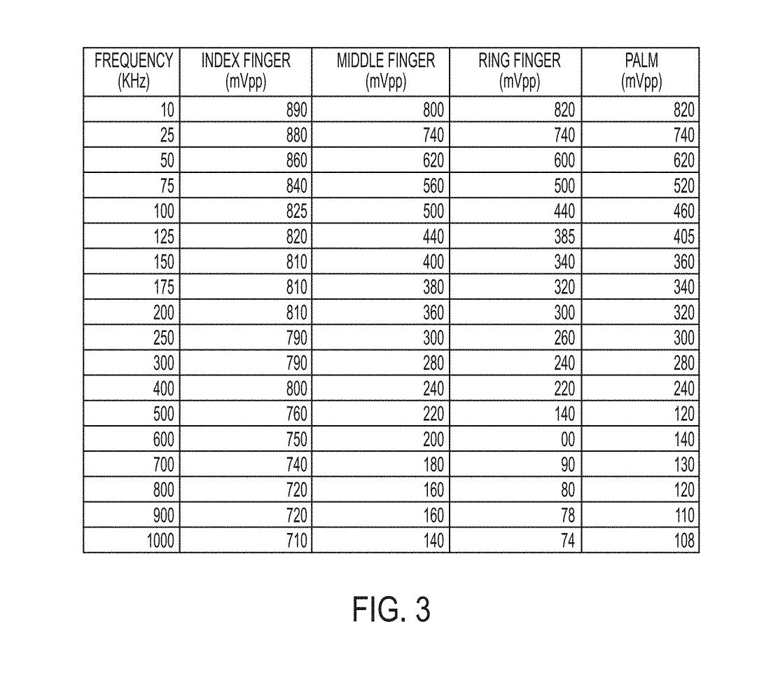

FIG. 3 shows exemplary amplitude measurements from the frequency injected index finger for increasing frequencies of a 1 Vpp sinusoidal signal for variations dot electrode locations, i.e., the index finger, middle, ring finger and palm.

FIG. 3 illustrates that in an embodiment, the amplitude measured at the injection finger, i.e., the index finger, is higher than at the other locations, for every frequency. In an embodiment, the difference in amplitude between the isolated finger and other regions increases with increasing frequency. In an embodiment, within a range, higher frequencies can be better isolated than lower frequencies. In the exemplary embodiment, the palm measurements are higher than the ring finger measurements. The palm measurements may be higher than the ring finger measurements because the palm electrode is closer to the injection electrode. The palm measurements may be higher than the ring finger measurements because there is more ground cover between the ring and index finger. In the exemplary embodiment, the middle finger measurements are higher than the ring finger and palm measurements. The middle finger measurements may be higher than the ring finger and palm measurements because there is current leakage between the index and middle finger, as they are proximate to each other. Nonetheless, in an embodiment, using a ground and signal injector, locations other than the index finger show similar voltages in that they are considerably lower than the index finger (i.e., the source of the frequency of interest), especially for higher frequencies. In an embodiment, the frequencies in each finger may be isolated so that a receiving sensor can identify the finger interacting with it by its frequency.

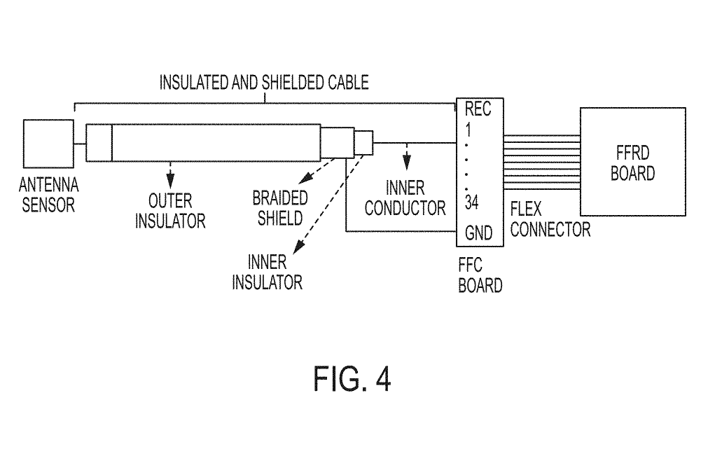

Turning to FIG. 4, a wiring and shielding scheme for a localized dot sensor is shown. In an embodiment, there are two main components, the dot sensor and an adapter board (labeled FFC Board). In an embodiment, the dot sensor may have a surface area of between several square centimeters and a fraction of a square centimeter. In an embodiment, the dot sensor may have a surface area of approximately 1 cm². In an embodiment, the surface of the dot sensor is generally flat. In an embodiment, the surface of the dot sensor is domed. In an embodiment, the surface of the dot sensor is oriented normal to direction of intended sensitivity. The dot sensor may be any shape. In an embodiment, the dot sensor is square. In an embodiment, the dot sensor is 10 mm by 10 mm. In an embodiment, the dot sensor's interior is made using copper braid and the dot sensor's exterior is made from copper tape.

In an embodiment, the dot sensor is electrically connected to a receiver channel on an adapter board. In an embodiment, the dot sensor is electrically connected to a receiver channel on an adapter board via a shielded coax cable. In an embodiment, one end of the inner conductor cable from the shielded coax cable is soldered to the dot sensor. In an embodiment, one end of the inner conductor cable from the coax cable is soldered to the copper braid interior of the dot sensor and the other end of the inner conductor is connected to a receiver channel on the adapter board. In an embodiment, the coax braided shield (i.e., outer conductor) is grounded. In an embodiment, the coax braided shield is grounded to a grounding point on the adapter board. In an embodiment, grounding the coax shielding may reduce interference (EMI/RFI) between the receiver's channel and dot sensor. In an embodiment, grounding the coax shielding may reduce interference or crosstalk between the receive signal and other cables or electronic devices. In an embodiment, grounding the coax shielding reduces the capacitance effect from the coax cable itself.

An adapter board is the interface between the dot sensors and the circuitry (FIG. 4 labeled FFC Board) that can measure strength of orthogonal signals received at the dot sensors. An adapter board can also be used as the interface between circuitry that can generate signals and injection electrodes. An adapter board should be selected to have sufficient receive channels for the number of dot sensors desired. In an embodiment, the adapter board should be selected to have sufficient signal generation channels for the number of desired injection signal conductors. In an embodiment, a flex connector may be used to connect the adapter board with circuitry that can generate orthogonal signals or measure strength of received orthogonal signals.

In an embodiment, frequency injection allows for a more accurate measurement of hover, i.e., non-contact touch. In an embodiment, FMT capacitive sensing can be improved when supported by frequency injection. For a description of the FMT capacitive sensor, see, generally, Applicant's prior U.S. patent application Ser. No. 13/841,436, filed on Mar. 15, 2013 entitled “Low-Latency Touch Sensitive Device” and U.S. patent application Ser. No. 14/069,609 filed on Nov. 1, 2013 entitled “Fast Multi-Touch Post Processing.” Because frequency injection applies a frequency, or multiple frequencies, to a user's body, the user's body can act as a conductor of that frequency onto an FMT capacitive sensor. In an embodiment, an injected frequency is frequency orthogonal to the frequencies that are transmitted on the FMT capacitive sensor transmitters. In an embodiment, a plurality of injected frequencies are both frequency orthogonal with respect to each other, and frequency orthogonal to the frequencies that are transmitted on the FMT capacitive sensor transmitters. In an embodiment, when combining frequency injection with FMT, the columns are additionally used as receivers to listen for the injected frequency or frequencies. In an embodiment, when combining frequency injection with FMT, both the rows and the columns are additionally used as receivers to listen for the injected frequency or frequencies. In an embodiment, interaction between a frequency injected body and a fast multi-touch sensor provides hover information at further distances than a similar interaction without using frequency injection.

### Demonstrative Frequency Injection Embodiments

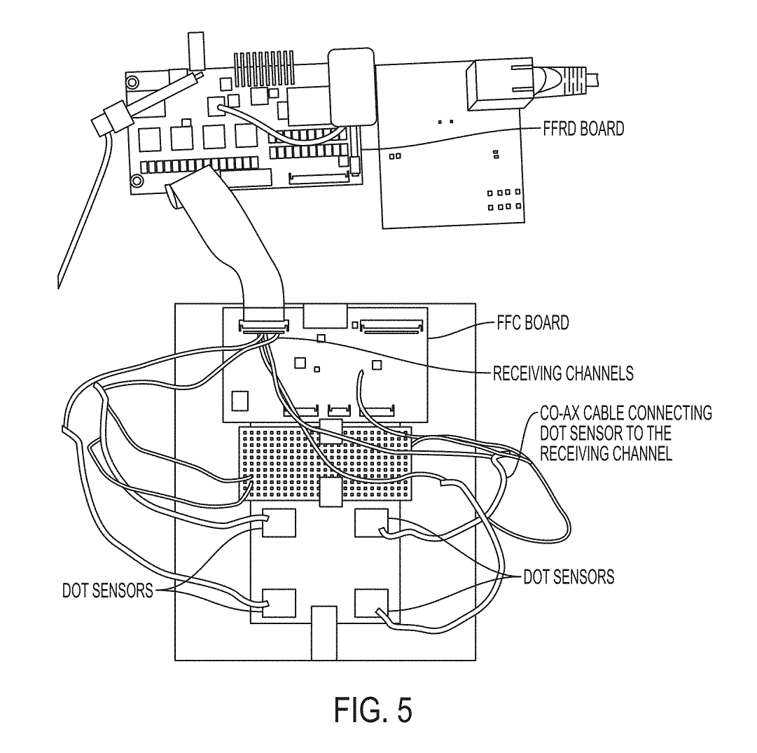

In an embodiment, a first frequency is applied to one of the two finger electrodes, and a second electrode is connected to ground. In an embodiment, a first frequency is applied to one of the two finger electrodes, and a second frequency is applied to the other of the two finger electrodes, while the third electrode is connected to ground. In an embodiment, a first frequency is applied to one of the three finger electrodes, a second frequency is applied to one of the other two finger electrodes, a third frequency is applied to the other finger electrode, and a fourth electrode is connected to ground. In an embodiment, a first frequency is applied to one of the four finger electrodes, a second frequency is applied to one of the other three finger electrodes, a third frequency is applied to one of the other two finger electrodes, a fourth frequency is applied to the other finger electrode, and a fifth electrode is connected to ground. In an embodiment, a first frequency is applied to one of the five finger electrodes, a second frequency is applied to one of the other four finger electrodes, a third frequency is applied to one of the other three finger electrodes, a fourth frequency is applied to one of the other two finger electrodes, and a fifth frequency is applied to the other finger electrode, while a sixth electrode is connected to ground. In an embodiment, heatmaps with signal strength values from the receiving channels are produced as the fingers in the hand wearing such a glove move in the space above, and come in contact with, the different dot sensors, such as shown in FIG. 5.

FIG. 5 shows an exemplary embodiment, comprised of a 2 by 2 grid of dot sensors arranged in square and circular fashion on a flat surface equidistantly. As used herein, the term exemplary embodiment reflects that the embodiment is a demonstrative embodiment or an example embodiment; the term exemplary is not intended to infer that the embodiment is preferred over or more desirable than another embodiment, nor that it represents a best-of-kind embodiment. In an embodiment, each dot sensor is placed 10-15 mm apart from one another. Each of the dot sensors are connected to the receiving channels of the adapter board (labeled FFC board) via a shielded coax cable. In an embodiment, the coax shielding is grounded. In an embodiment, a voltage buffer with an op-amp is also referenced. In an embodiment, instead of grounding the outer shield of the coax, it is connected to the output of the voltage buffer, whereas the input of the buffer is connected to the receiving channels of the adapter board.

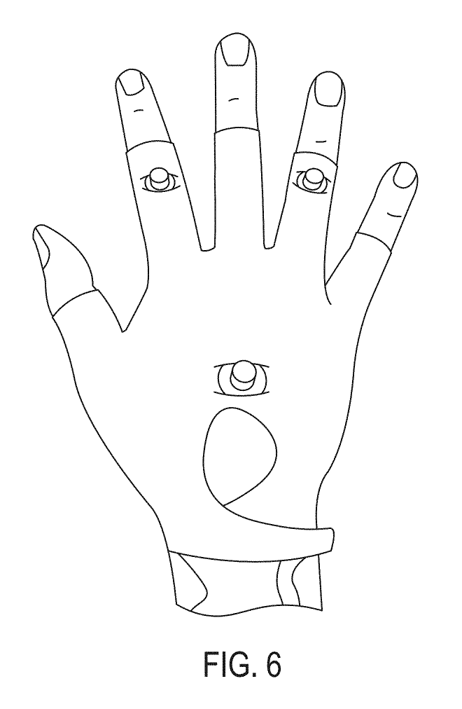

FIG. 6 shows an exemplary embodiment placing dot electrodes at various locations on the hand and fingers. In an embodiment, two dot electrodes are positioned on the back of the index and ring finger, respectively, while a third dot electrode is positioned on the back of the hand. The two dot electrodes positioned on the fingers are used as injection signal conductors, while the third dot electrode is connected to ground to support the isolation of separate orthogonal frequencies sent to the electrodes on the fingers. In an embodiment, a fingerless glove can be employed with electrodes attached to its inner side. In an embodiment, other means of deploying the electrodes may be used (e.g., fingered gloves, gloves of different materials and sizes, straps, a harness, self-stick electrodes, etc.).

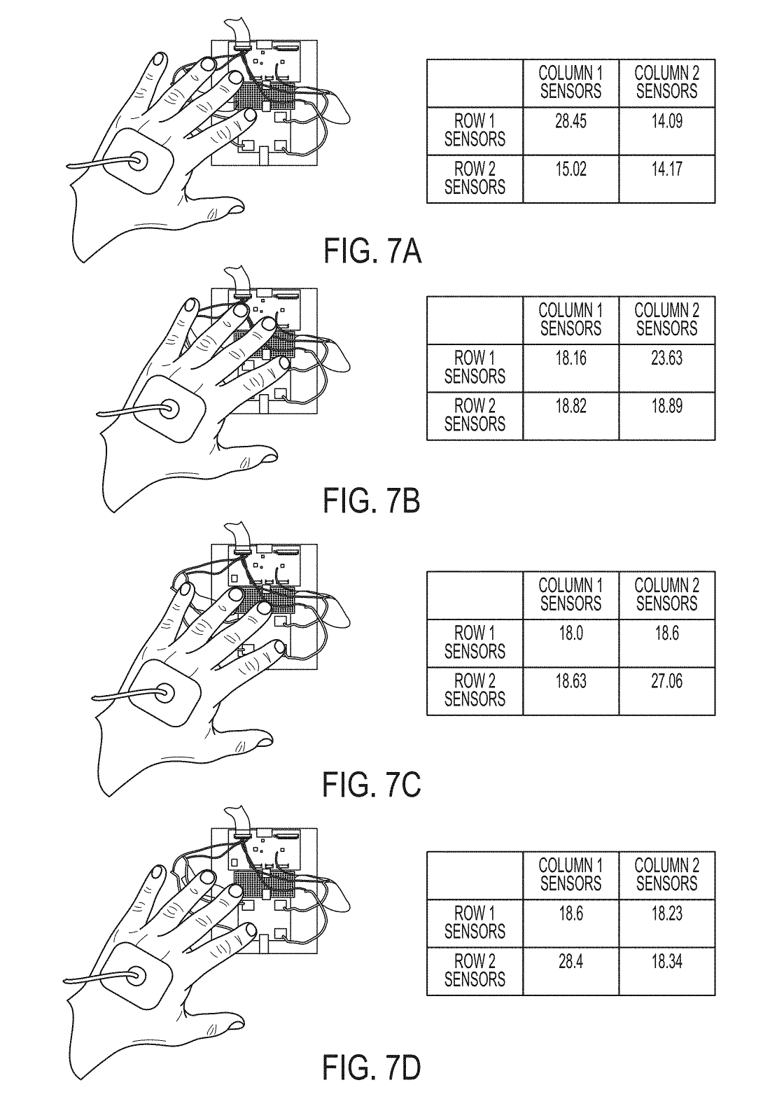

FIGS. 7A-7D show 2 by 2 heatmaps that result from the injection of a single frequency through a signal injection electrode placed on the back of a user's hand when the hand hovers near, and contacts, the 2-by-2 dot sensor grid shown in FIG. 5. In this embodiment, the human body (i.e., hand) acts as an active signal source to the receiving dot sensors. In an exemplary embodiment, a 1 Vpp sinusoidal wave of 117,187.5 Hz is injected through an electrode placed on the back of the hand. The received signal levels for each dot sensor is measured via FFT values of the signal in dB (20×log 10 of the FFT of the received signal for the injected frequency). In an embodiment, the stronger the received signals, the higher the FFT values. The dB values shown in the results are the positive difference from a reference value for each sensor captured when the frequency injected hand was lifted 10 cm above the dot sensor grid. The 2-by-2 heatmap (also referred to herein as a FFT grid) reflects one value for each of the four dot sensors. In an embodiment, multiple (e.g., quadrature) values could be provided for each of the dot sensors. The interacting hand is the only transmitting source in this exemplary embodiment, thus values on the FFT grid increase as the hand moves from a distant hover to contact with the dot sensor. In FIGS. 7A-7D, the FFT grid shows the greatest amplitude for the dot sensor that the finger contacts, and that contact produces values more than 20 dB from the 10-cm reference calibration.

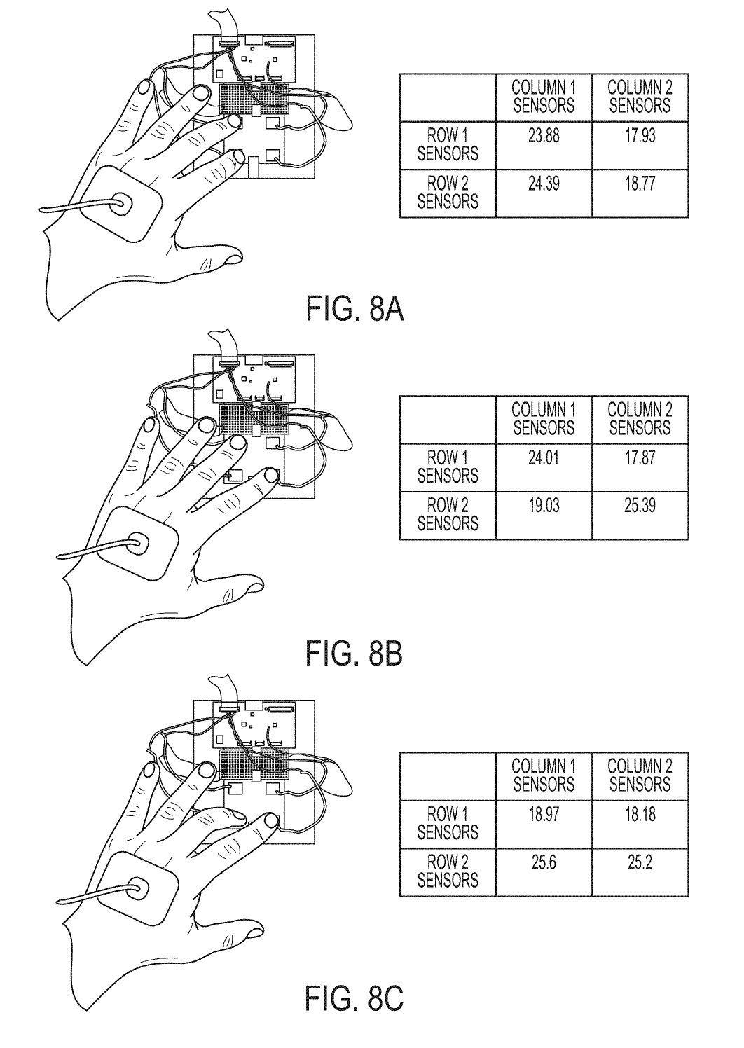

FIGS. 8A-8C similarly show the FFT grid reflecting the results where the same hand is making contact with two dot sensors. As with FIG. 7, the FFT grid shows a greater amplitude for the dot sensors that the fingers contact. Note that in the testing embodiment, sensors without contact often show values over 15 dB; these high signal values are believed to be due to unwanted cross-talk between the receiving channels on the current board, and can be prevented by isolating the channels more effectively.

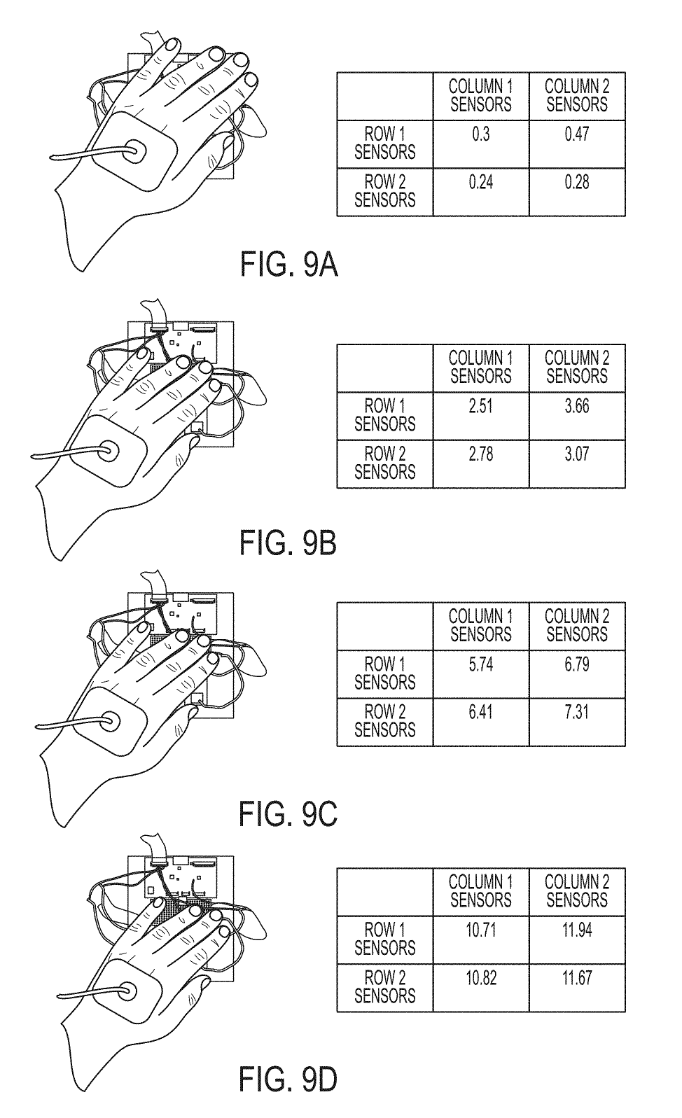

FIGS. 9A-9D show the FFT grid reflecting the results when the hand is moved toward the dot sensor grid. FIG. 9A-9D, shows a more than 11 dB difference in signal values as the frequency injected hand is moved toward the dot sensor grid from about 10 cm away. In an embodiment, the dB values change in a substantially linear manner for all of the dot sensors in the grid.

In an embodiment, using multiple frequencies has the advantage of being able to identify the interacting fingers simultaneously. In an embodiment, the FFT grid for each frequency, enables for the detection of contact with a sensor based on the amplitude. In an embodiment, the amplitudes for each grid also enable identification where multiple injected fingers touch different sensors at the same time. In an embodiment, multiple frequency injection using multiple electrodes is an effective way to characterize different parts of the hand to map them continuously on a sensor grid using touch signal strengths (i.e., hover and contact signal strength) at each frequency.

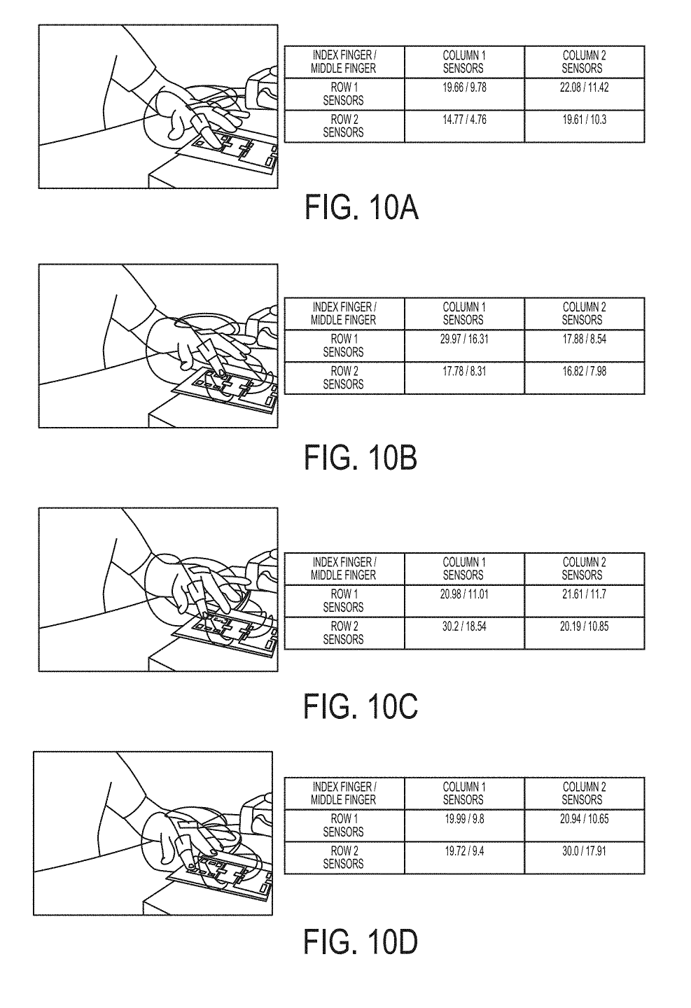

FIGS. 10A-10D show a 2 by 2 heatmap resulting from various hand movements where two orthogonal frequencies are injected. In an exemplary embodiment, two orthogonal frequencies are injected through two separate injection electrodes—one on an index finger and one on a ring finger—and a ground electrode is placed on the back of the hand, which moves (i.e., hovers and makes contact) in range of the 2-by-2 dot sensor grid shown in FIG. 5. In this exemplary embodiment, although the hand acts as an active signal source of the two orthogonal frequencies, due to the described exemplary configuration, the amplitude of the two orthogonal frequencies varies across portions of the hand. In an exemplary embodiment, two 1 Vpp sinusoidal waves of 117,187.5 Hz and 121,093.75 Hz are sent to the index and finger electrodes, respectively. The received signal levels for each dot sensor is measured via FFT values of the signal in dB (20×log 10 of the FFT of the received signal for the injected frequency). In an embodiment, stronger received signals are reflected as higher FFT values. As above, the dB values shown in the results are the positive difference from a reference value for each sensor captured when the frequency injected fingers are lifted 10 cm above the dot sensor grid. The 2-by-2 heatmap (also referred to herein as a FFT grid) reflects one value for each of the four dot sensors on the top and one value for each of the four dot sensors below—the two sets of values corresponding to the strength of the two orthogonal signals. In an embodiment, multiple (e.g., quadrature) values could be provided for each of the frequencies for each of the dot sensors. The interacting fingers are the only transmitting sources in this exemplary embodiment, thus values on the FFT grid increase as the fingers move their touch from a distant hover to contact. The position of the injected index finger and the values for each sensor for each frequency can be seen in FIGS. 10A-10D. The FFT grid shows the greatest amplitude for the dot sensor that the injected index finger contacts, and that contact produces values more than 20 dB from the 10-cm reference calibration.

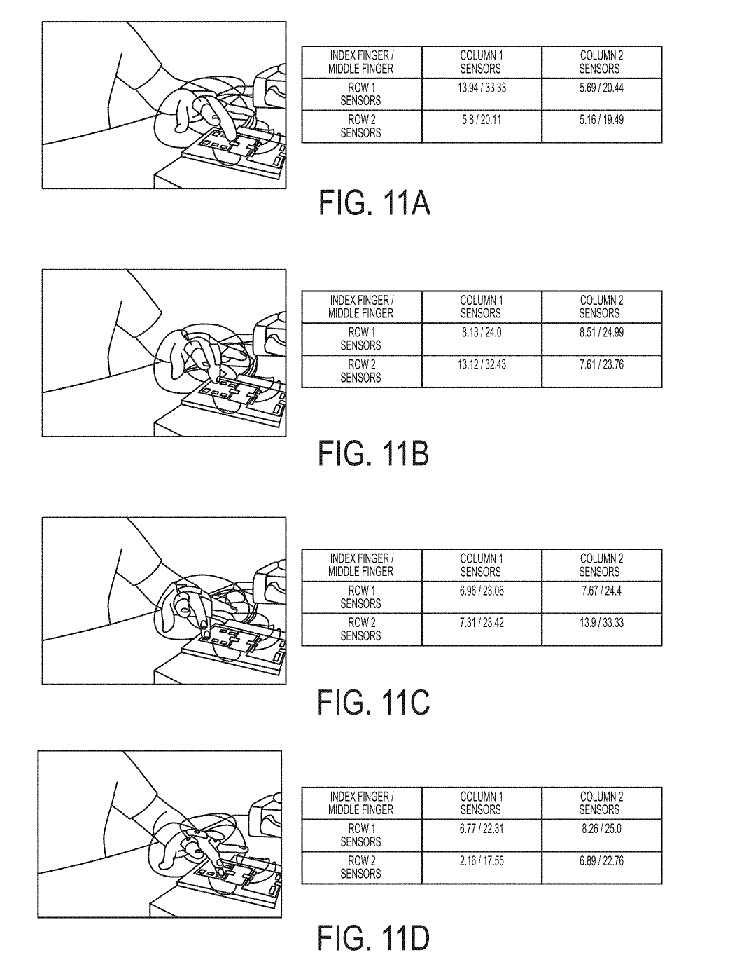

The position of the injected ring finger and the values for each sensor for each frequency can be seen in FIGS. 11A-11D. The FFT grid shows the greatest amplitude for the dot sensor that the injected ring finger contacts, and the contact produces values of at least 22 dB, and often in excess of 30 dB, from the 10 cm reference calibration. As discussed above, in the demonstrative embodiments, high signal level values of the non-contact sensors are believed to be due to unwanted cross-talk between the receiving channels on the testing environment board. The unwanted cross-talk can be mitigated by isolating the channels more effectively.

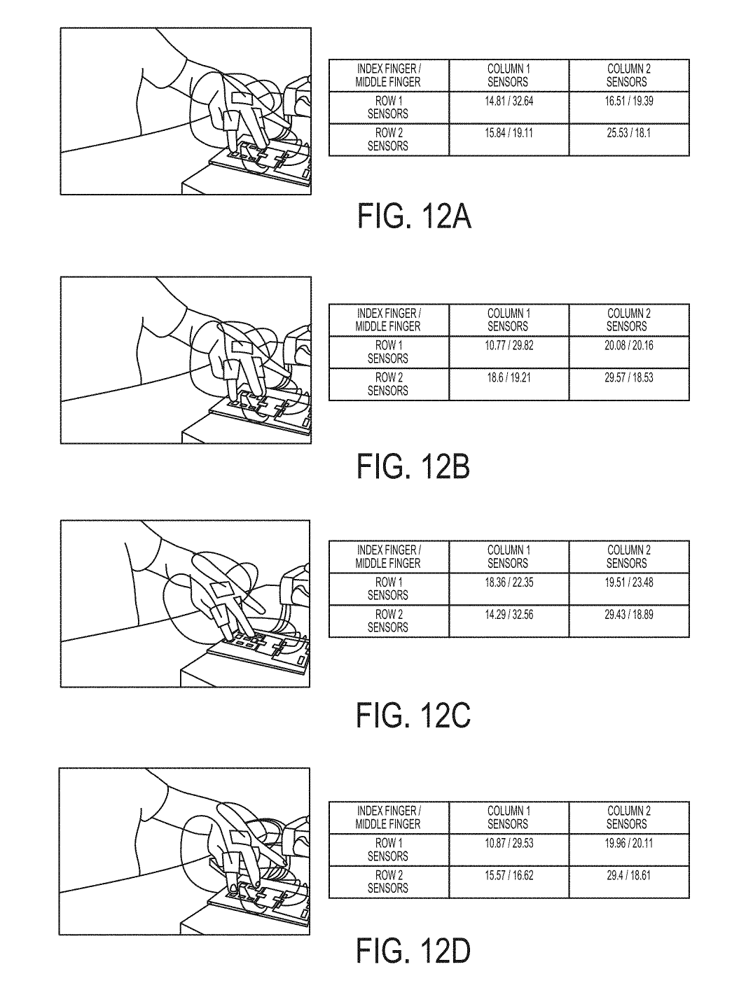

FIGS. 12A-12D show a 2 by 2 heatmap resulting from various hand movements where two orthogonal frequencies are injected into fingers, and both injected fingers move about and make contact with the dot sensors. The measurements are taken using the same exemplary setup as described in connection with FIGS. 10A-10D and 11A-11D. The position of the injected index finger and injected ring finger, and the values for each sensor for each frequency can be seen in FIGS. 12A-12D. As above, the FFT grid shows the greatest amplitude for the dot sensor that the injected fingers contacts, and that contact produces values of greater than 20 dB from the 10 cm reference calibration. As above, in the demonstrative set-up, the values of the non-contact sensors often show high signal levels that are believed to be due to unwanted cross-talk between the receiving channels on the testing environment board. The unwanted cross-talk can be mitigated isolating the channels more effectively.

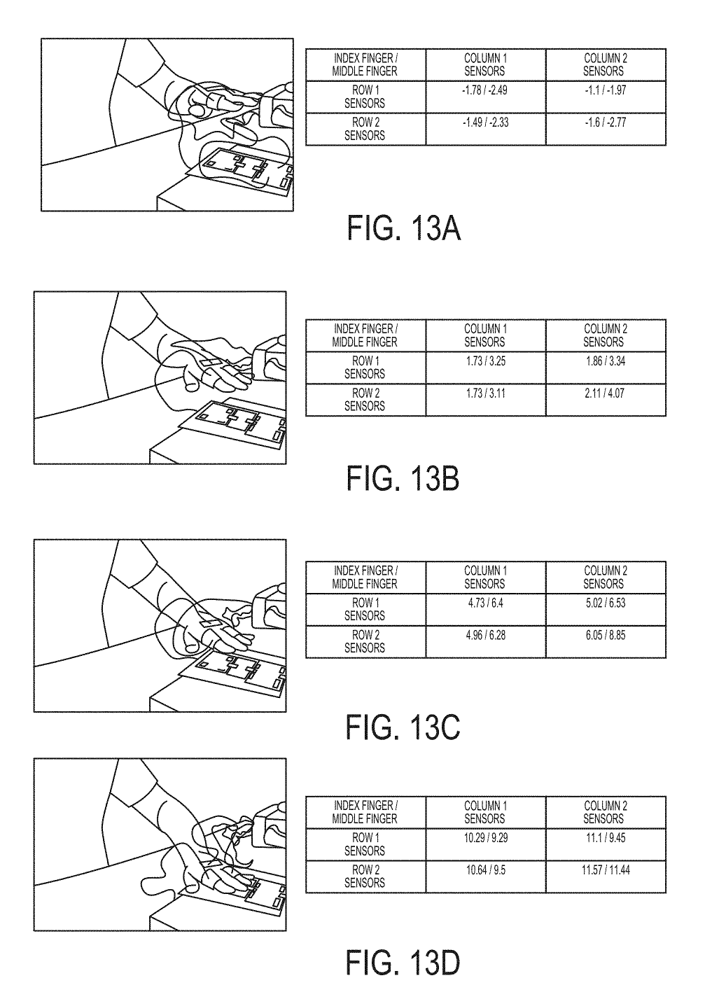

FIGS. 13A-13D show a 2 by 2 heatmap resulting from various hand movements where two orthogonal frequencies are injected into fingers, and the hand moves above, and makes contact with, the dot sensor grid. The measurements are taken using the same exemplary setup as described in connection with FIGS. 10A-10D and 11A-11D. The position of the hand having the injected index finger and injected ring finger, and the values for each sensor for each frequency can be seen in FIGS. 12A-12D. Note that unlike FIGS. 12A-12D, the fingers are touching each other, thus mitigating the isolating effect of the ground electrode. The FFT grid shows a substantially linear change in amplitude, which increases as the dual-frequency injected hand approaches the dot sensor. Contact produces values of near 10 dB in all of the dot sensors.

These illustrative and exemplary embodiments demonstrate the frequencies that the dot sensors receive, which provide reliable non-contact touch (i.e., hover) information, far more than is available from traditional capacitive sensing systems or fast multi-touch systems as shown in FIG. 1. However, due at least in part to the size and spacing of the dot sensors, the resolution at near-contact, and sensitivity to contact, may be less than the sensitivity produced by traditional capacitive sensing or fast multi-touch systems.

In an embodiment, the efficiency of conductivity through the body may be affected by the frequency of an injected signal. In an embodiment, grounding electrodes or strips may be positioned to cause the frequency of an injected signal to affect the efficiency of conductivity through the body. In an embodiment, multiple orthogonal frequencies are injected from a single electrode. A variety of meaningful information can be determined from differing amplitudes of orthogonal signals injected by the same electrode. Consider, as an example, a lower frequency and a higher frequency signal both injected through a single electrode. In an embodiment, the lower frequency signal (e.g., 10 KHz signal) is known to lose amplitude over distance at a slower rate than the higher frequency signal (e.g., 1 MHz signal). In an embodiment, where the two frequencies are detected (e.g., a row or dot sensor), the difference in amplitude (e.g., Vpp) may be used to determine information about the distance traversed by the signal. In an embodiment, multi-frequency injection done at one side of a hand can be distinguished at the tips of each finger. In an embodiment, the signals received at a variety of locations on the body can be used to provide information about the location of the electrode providing those signals. In an embodiment, the delta between amplitude in two signals injected by the same injection electrode and sensed at another location on the body can provide information about the path from the electrode to the sensing point and/or the relative location of the electrode with respect to the sensing point. It will be apparent to a person of skill in the art in view of this disclosure that, in an embodiment, an injection configuration may comprise multiple electrodes, each using multiple frequencies.

### Heterogeneous Sensor Manifold

In an embodiment, the patterns of the sensor, heterogeneous or not, may be formed in a manifold that can be laid upon, with, within, or wrapped around an object. In an embodiment, the patterns of the sensor may be formed by a plurality of manifolds that can be laid upon, with, within, or wrapped around an object or other manifolds. The term “patterns” as used in the two prior sentences refer generally to the conductive material, which in some embodiments is a grid or mesh, and which is affected by the movements or other things sensed by the sensor. In an embodiment, the patterns are disposed on a substrate. In an embodiment, the patterns are produced in layers. In an embodiment, the rows and columns may be formed on opposite sides of the same substrate (e.g., film, plastic, or other material provide the requisite physical distance and insulation between them). In an embodiment, the rows and columns may be formed on the same sides of the same substrate, in different spatial locations (e.g., film, plastic, or other material provide the requisite physical distance and insulation between them). In an embodiment, the rows and columns may be formed on the same side of a flexible substrate. In an embodiment, the rows and columns may be formed on opposite sides of a flexible substrate. In an embodiment, the rows and columns may be formed on separate substrates and those substrates brought together as a manifold or as part of a manifold.

In an embodiment, a sensor manifold can be placed on a surface to enable sensing of contact and non-contact events on, or near, or at some distance from, the surface. In an embodiment, the sensor manifold is sufficiently flexible to be curved about at least one radius. In an embodiment, the sensor manifold is sufficiently flexible to withstand compound curvature, such as to the shape of a regular or elongated sphere, or a toroid. In an embodiment, the sensor manifold is sufficiently flexible to be curved around at least a portion of a game controller. In an embodiment, the sensor manifold is sufficiently flexible to be curved around at least a portion of a steering wheel. In an embodiment, the sensor manifold is sufficiently flexible to be curved around at least a portion of an arbitrarily shaped object, for example, and not by way of limitation, a computer mouse.

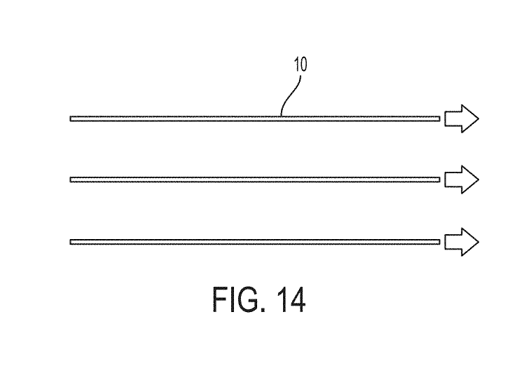

FIG. 14 illustrates an embodiment of a conductor layer for use in a heterogeneous sensor. In an embodiment, as illustrated in FIG. 14, additional row conductors 10 are provided on a layer that is joined with the sensor manifold. In an embodiment, the rows and columns are disposed on each side of a plastic substrate providing a physical gap between their layers, while the additional row conductors 10 are disposed on a separate piece of plastic and the two plastic sheets brought in close proximity as part of the sensor manifold.

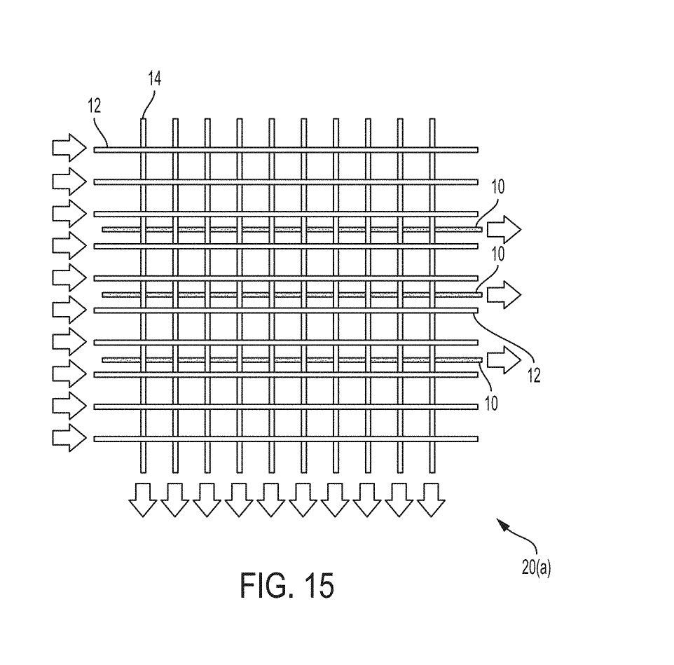

FIG. 15 illustrates a schematic layout of an exemplary heterogeneous sensor 20(a) having row conductors 12 and column conductors 14. In an embodiment, additional row conductors 10 (in a separate layer) are oriented substantially parallel with the other row conductors 12. In an embodiment, the row conductors 12 and the additional row conductors 10 may be on opposite sides of a common substrate (not shown in FIG. 15 for ease of viewing). In an embodiment, the row conductors 12 and the additional row conductors 10 may be on different substrates. In an embodiment, the additional row conductors 10 are each associated with a row receiver circuitry that is adapted to receive signals present on the additional row conductors 10 and to determine a strength for at least one unique signal. In an embodiment, the row receiver circuitry is adapted to receive signals present on the additional row conductors 10 and to determine a strength a plurality of orthogonal signals. In an embodiment, the row receiver circuitry is adapted to receive signals present on the additional row conductors 10 and to determine signal strengths for the same plurality of signals as the circuitry associated with receiving signals on the columns. Thus, in an embodiment, the row receiver is designed to receive any of the transmitted signals, or an arbitrary combination of them, and to individually measure the quantity of each of the orthogonal transmitted signals present on that additional row conductors 10.

In an embodiment, row signals can be conducted from one row conductors 12 to an additional row conductors 10 by a user's interaction with the heterogeneous sensor 20(a). In an embodiment, row receiver circuitry is adapted to receive signals present on the additional row conductors 10 and to determine signal strengths for each of the orthogonal transmitted signals. In an embodiment, row receiver circuitry is adapted to receive signals present on the additional row conductors 10 and to determine signal strengths for one or more of the orthogonal transmitted signals. In an embodiment, determine signal strengths for each of the orthogonal transmitted signals provides additional information concerning a user's interaction with the heterogeneous sensor 20(a). In an embodiment, signal injection conductors (not shown in FIG. 15) may impart unique orthogonal signals into the body of a user. In an embodiment, row receiver circuitry is adapted to receive signals present on the additional row conductors 10 and to determine signal strengths for one or more injected signals. In an embodiment, signal strength is determined for each of the signals for each row. In an embodiment, signal strength is represented in a heatmap.

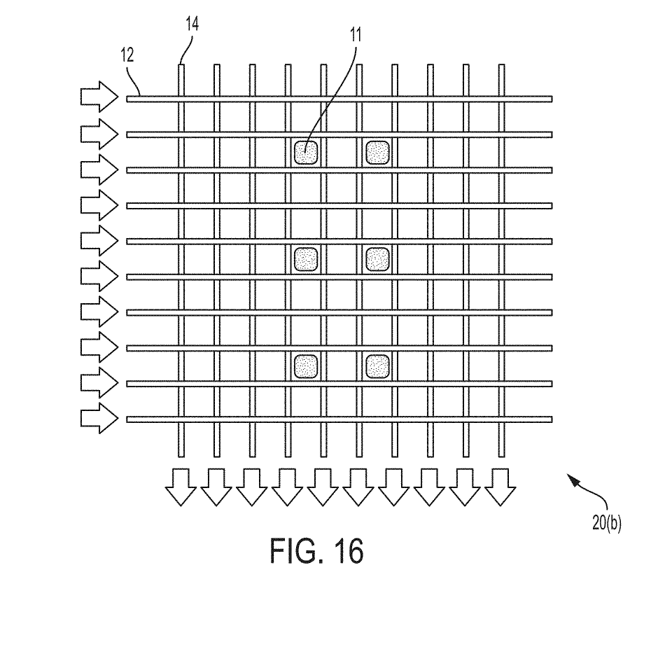

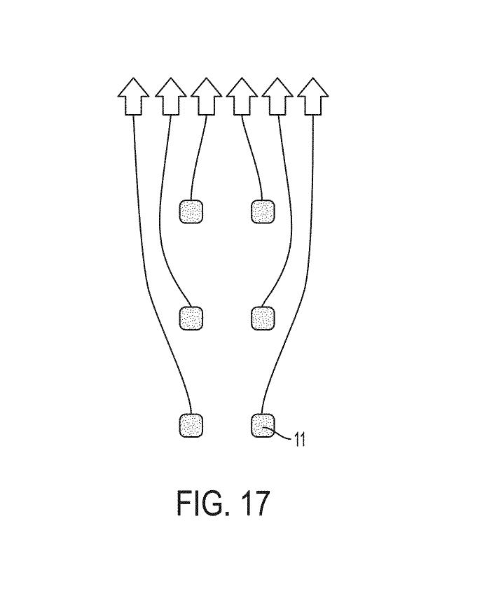

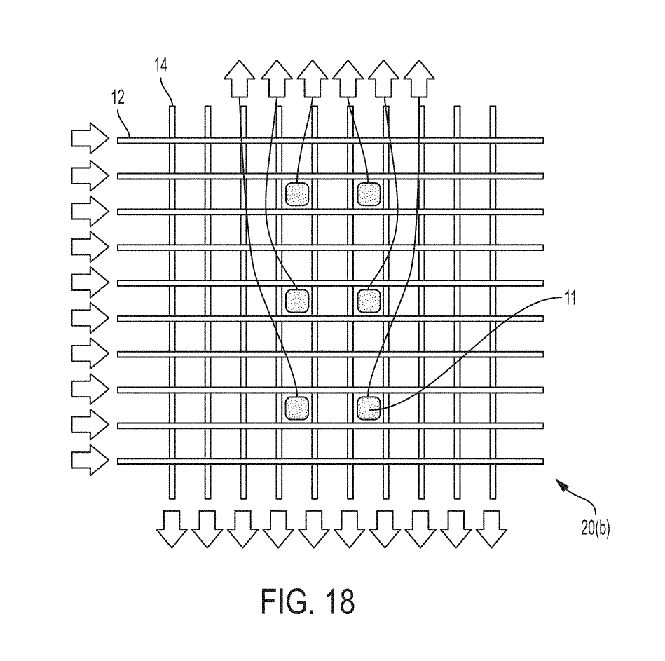

FIG. 16 shows an illustration of an embodiment of a heterogeneous sensor 20(b) having interleaved antennas 11. FIG. 17. shows an illustration of the connection between an interleaved antenna 11 and its associated receiver circuitry. FIG. 18 shows an illustration of an embodiment of a heterogeneous sensor 20(b) having interleaved antennas 11 as shown in FIG. 16, with connections between interleaved antennas 11 and its associated circuitry. As used herein the term “antenna” or “receive antenna” refers to conductive material appropriately connected to a receiver that can detect signals incident on the antenna, a dot sensor or dot, or localized spot, may also be used interchangeable with the term antenna.

As used herein the term “interleaved” is used to describe an orientation wherein the antenna has low coupling (e.g., makes no substantial electrical contact) with the rows or columns. It will be apparent to a person of skill in the art that despite being, interleaved according to this definition, there may nonetheless be some capacitive interaction between the row conductors 12 or column conductors 14 and the antenna 11. In an embodiment, the antenna 11 may be disposed or affixed to the same substrate as the row conductors 12 and/or the column conductors 14. In an embodiment, the antenna 11 may be disposed or affixed to a separate substrate from the row conductors 12 and the columns 14.

In an embodiment, the antennas 11 are oriented generally normal to the direction of hover. In an embodiment, the antennas 11 are generally flat and conductive. In an embodiment, the antennas 11 could be domed and conductive and/or pointed and conductive. In an embodiment, the antennas 11 are made of, for example, and not by way of limitation, copper braid and copper tape, conductive metal, copper, or a combination of all of these materials. In an embodiment, the antenna 11 is small enough to be interleaved with row conductors 12 and column conductors 14. In an embodiment, the antenna 11 is no more than about 1 cm square. In an embodiment, the antenna 11 is less than 0.5 cm square. In an embodiment, the antennas 11 are generally square. In an embodiment, the antennas 11 could also be rectangular, circular, and/or have the shape of a line, polyline, or curve. In an embodiment, the antennas 11 could be comprised of a combination of such shapes.

In an embodiment, the antennas 11 are oriented so signals are transmitted into each of the surface's rows, thereby forming a line, polyline, and/or curve. In an embodiment, the antennas are oriented so signals are transmitted into each of the surface's columns, thereby forming a line, polyline, and/or curve. In an embodiment, the rows or columns of antennas 11 are organized in a grid layout. In an embodiment, the rows or columns of antennas 11 are organized in a spatial layout in a manner similar to the shape of the surface or device's manifold.

In an embodiment, antenna receiver circuitry is adapted to receive signals present on the antenna 11 and to determine signal strengths for each of the orthogonal transmitted signals. In an embodiment, antenna receiver circuitry is adapted to receive signals present on the antenna 11 and to determine signal strengths for one or more of the orthogonal transmitted signals. In an embodiment, antenna receiver circuitry is adapted to receive signals present on the antenna 11 and to determine signal strengths for one or more injected signals. In an embodiment, a strength is determined for each of the signals for each antenna 11. In an embodiment, signal strength is represented in a heatmap.

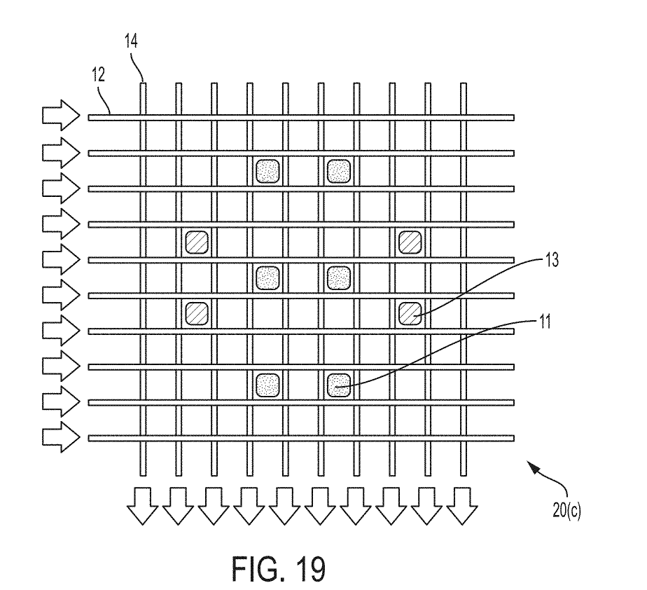

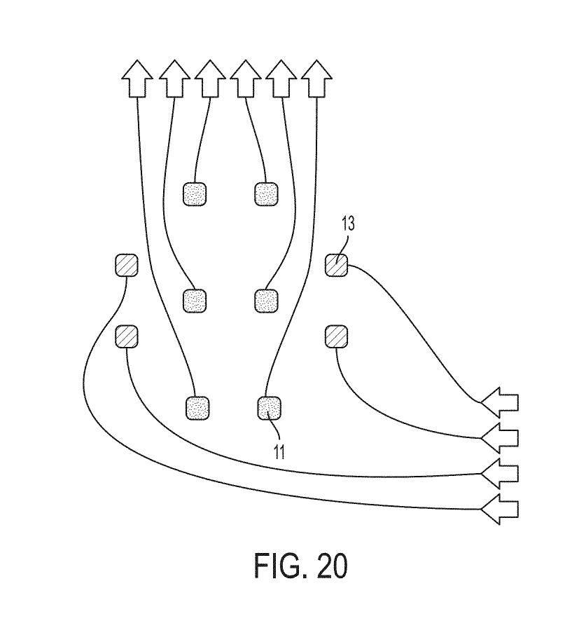

FIG. 19 shows an illustration of another embodiment of a heterogeneous sensor 20(c) having interleaved antennas 11 and signal injection conductors 13. In an embodiment, the signal injection conductors 13 and antennas 11 are substantially identical. In an embodiment, the signal injection conductors 13 and the antennas 11 may be interchangeable. In an embodiment, the signal injection conductors 13 are flush with, or parallel to, the surface of a manifold. In an embodiment, the signal injection conductors 13 are placed or embedded below the surface of a manifold. In an embodiment, the signal injection conductors 13 protrude from a manifold to better ensure contact with the subject of the injection. In an embodiment, the signal injection conductors 13 protrude from a manifold in a domed fashion. In an embodiment, the signal injection conductors 13 are formed from screws or rivets that are otherwise associated with assembly or disassembly of the object.

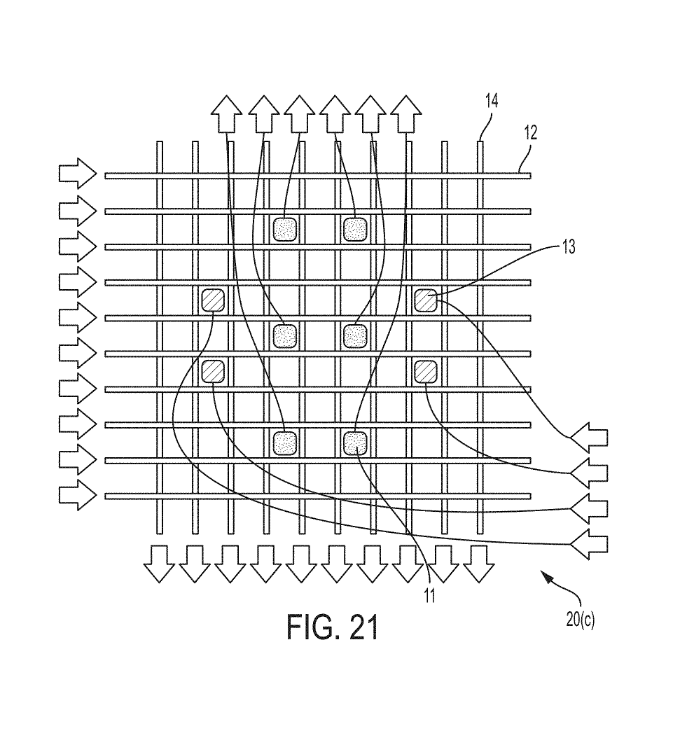

FIG. 20 shows an illustration of an embodiment of connections between interleaved antennas 11 and their associated receiver circuitry, and signal injection conductors 13 and their associated signal drive circuitry. FIG. 21 shows an illustration of an embodiment of a heterogeneous sensor 20(c) having interleaved antennas 11 and signal injection conductors 13 as shown in FIG. 19. The configuration and orientation of the antennas 11 and signal injection conductors 13 is merely illustrative. It will be apparent to a person of skill in the art in view of this disclosure that signal injection conductors 13 are placed in a manner first, to ensure injection of signal and second to ensure that the appropriate signal will reach the desired signal location. It will also be apparent to a person of skill in the art in view of this disclosure that antennas 11 are placed in a manner to ensure appropriate signal reception and resolution. In an embodiment, motion is constrained by the object, (e.g., a game controller), and placement of the signal injection conductors 13 and antennas 11 can take the constraints into account.

In an embodiment, the heterogeneous sensors, 20(a), 20(b) and 20(c), as illustrated herein (see e.g., FIGS. 16, 19 and 21) synergistically combines the two sensing modalities, fast multi-touch and frequency injection, taking advantage of the same orthogonal signal set, and the differing properties and requirements of the two modalities. In an embodiment, injected signals are received as an increased signal on, e.g., column receivers, row receivers and/or dot sensor receivers, whereas, the row signals are often received as a decrease in the signal on column and row receivers. Thus, in an embodiment, the injected signals and row signals appear in different ranges on the receivers, one being positive and the other negative. In an embodiment, the injected signals and row signals can be distinguished by processing the received signal, without a priori knowledge of which frequencies are injected and which signals are transmitted on the rows. In an embodiment, the injection signal can be generated with a 180-degree phase offset of frequency orthogonal signals transmitted on the rows. In an embodiment, shifting the phase of the injected signals magnifies the touch delta.

### Demonstrative Handheld Controller

The term “controller” as used herein is intended to refer to a physical object that provides the function of human-machine interface. In an embodiment, the controller is handheld. In an embodiment, the handheld controller provides six degrees of freedom (e.g., up/down, left/right, forward/back, pitch, yaw, and roll), as counted separately from the sensed touch input and hover input described herein. In an embodiment, the controller may provide fewer than six degrees of freedom. In an embodiment, the controller may provide more degrees of freedom, as in a replica of the movement of a human hand which is generally considered to have 27 degrees of freedom. Throughout, the term “six-DOF controller” refers to embodiments in which the controller's position and orientation are tracked in space, rather than strictly counting the total number of degrees of freedom the controller is capable of tracking; that is, a controller will be called “six-DOF” regardless of whether additional degrees of freedom, such as touch tracking, hover tracking, button pushing, touchpad, or joystick input are possible. Further, we use the term six-DOF to refer to controllers which may be tracked in fewer than six dimensions, such as, for example, a controller whose 3D position is tracked but not its roll/pitch/yaw, or a controller whose movement is tracked only in two dimensions or one dimension, but its orientation is tracked in three, or perhaps fewer, degrees of freedom.

In an embodiment, the controller is designed to fit generally within the palm of a user's hand. In an embodiment, the controller is designed in a manner that permits use in either the left or right hand. In an embodiment, specialized controllers are used for each of the left and the right hand.

Capacitive sensor patterns are generally thought of as having rows and columns. Numerous capacitive sensor patterns have heretofore been proposed, see e.g., Applicant's prior U.S. patent application Ser. No. 15/099,179, filed on Apr. 14, 2016 entitled “Capacitive Sensor Patterns,” the entire disclosure of that application, and the applications incorporated therein by reference, are incorporated herein by reference. As used herein, however, the terms row and column are not intended to refer to a square grid, but rather to a set of conductors upon which signal is transmitted (rows) and a set of conductors onto which signal may be coupled (columns). The notion that signals are transmitted on rows and received on columns itself is arbitrary, as the signals could as easily be transmitted on conductors arbitrarily designated columns and received on conductors arbitrarily named rows, or both could arbitrarily be named something else; further, the same conductor could act as both a transmitter and a receiver. As will be discussed in more detail below, it is not necessary that the rows and columns form a grid; many shapes are possible as long as touch proximate to a row-column intersection increases or decreases the coupling between the row and column. In an embodiment two or more sensor patterns can be employed in a single controller. In an embodiment, three sensor patterns are employed in a single hand-held controller. In an embodiment, one sensor pattern is employed for thumb-centric detection, another sensor pattern is employed for trigger-centric detection, and a yet another sensor pattern is employed for detection at other locations around the body of the controller.

The transmitters and receivers for all or any combination of the sensor patterns may be operatively connected to a single integrated circuit capable of transmitting and receiving the required signals. In an embodiment, where the capacity of the integrated circuit (i.e., the number of transmit and receive channels) and the requirements of the sensor patterns (i.e., the number of transmit and receive channels) permit, all of the transmitters and receivers for all of the multiple sensor patterns on a controller are operated by a common integrated circuit. In an embodiment, operating all the transmitters and receivers for all the multiple sensor patterns on a controller with a common integrated circuit may be more efficient than using multiple integrated circuits.

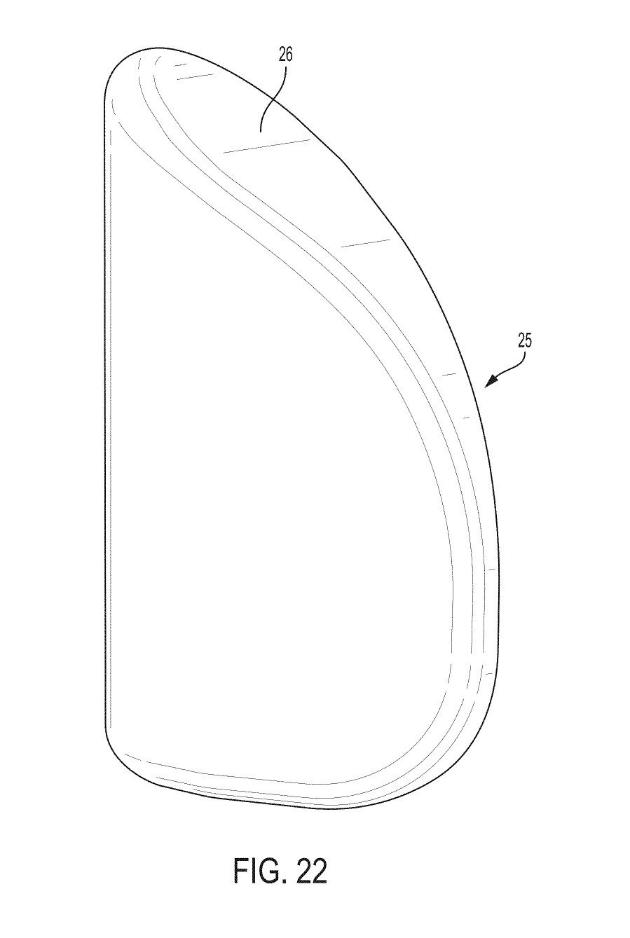

FIG. 22 is an illustration of an embodiment of a handheld controller 25 that can be used with one or more capacitive, injection, and/or heterogeneous sensing elements. In an embodiment, the handheld controller 25 is symmetric such that it can be used in either hand. A curved “finger” portion (curved in only one radius) is provided around which a capacitive, injection or heterogeneous sensor wrap. In an embodiment, the curved portion may have compound curvature (i.e., multiple radii of curvature). For example, in an embodiment, the curved portion of the handheld controller 25 (having a vertical axis) can have finger indents (having a horizontal axis) where fingers may rest in known locations.

FIG. 22 also shows an elongated thumb portion 26 visible on the top side of the handheld controller 25 which can comprise capacitive, injection or heterogeneous sensing elements. In an embodiment, the thumb-centric sensor is deployed on the elongated thumb portion 26, which is a relatively flat surface most near the thumb as the controller is held. The taxel density may vary from sensor pattern to sensor pattern. In an embodiment, a sensor pattern is selected for the thumb-centric area with a relatively high taxel density such as between 3.5 mm and 7 mm. In an embodiment, the thumb-centric area is provided a taxel density of 5 mm to sufficiently improve fidelity to permit the sensed data to be used to accurately model the thumb. In an embodiment, the thumb-centric area is provided a taxel density of 3.5 mm to better improve fidelity.

In addition to the selection of taxel density, a sensor pattern can be selected based on its ability to detect far, near or mid hover, as opposed to contact. In an embodiment, the sensor pattern for the thumb-centric sensor is selected to detect hover up to between 3 mm to 10 mm. In an embodiment, the sensor pattern for the thumb-centric sensor is selected to detect hover to at least 3 mm. In an embodiment, the sensor pattern for the thumb-centric sensor is selected to detect hover to at least 4 mm. In an embodiment, the sensor pattern for the thumb-centric sensor is selected to detect hover to at least 5 mm. In an embodiment, the sensor pattern for the thumb-centric sensor is selected to detect hover to a distance that sufficiently permits the sensed data to be used to accurately model the thumb of a population of intended users.

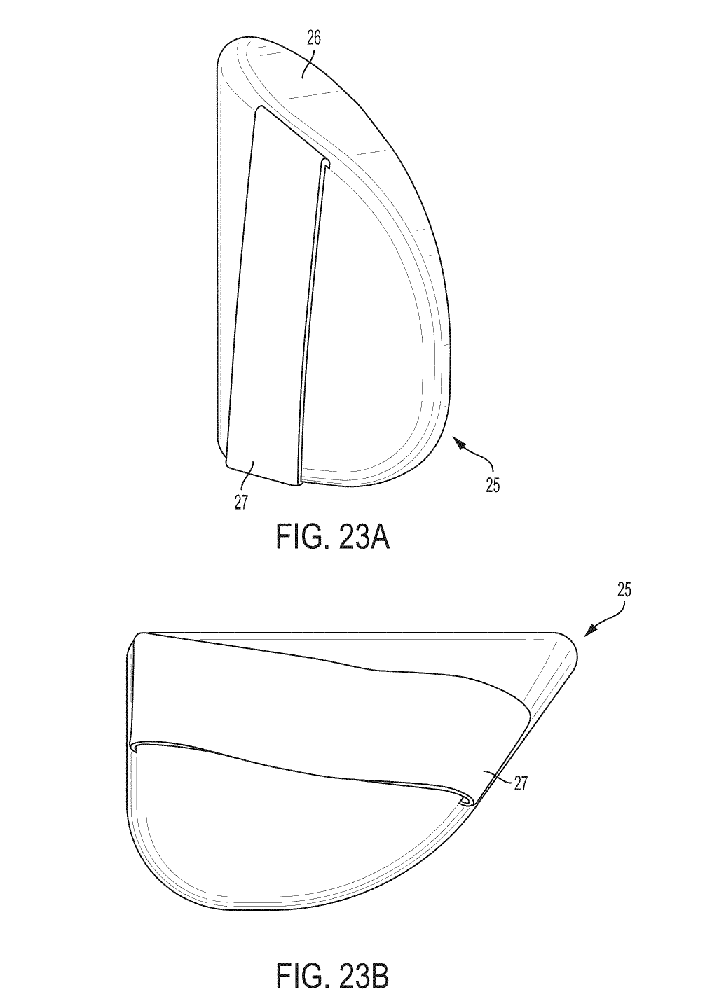

FIGS. 23A-23B are illustrations of a strap configuration for a handheld controller 25. In an embodiment, a single strap 27 wraps about the handheld controller 25 beneath its top and bottom surface, but exterior to its right and left surface. In an embodiment, the strap 27 can be used with either hand by having a slidable connection at either the top or the bottom. In an embodiment, the strap 27 can be used with either hand by being elastic on each side. In an embodiment, one or more electrodes are placed on the strap 27 for frequency injection. In an embodiment, one or more electrodes are placed on the surface of the handheld controller 25 in a position that will cause substantial contact between a hand and the electrodes when the hand is between the strap 27 and the handheld controller 25. In an embodiment, the injected signals from the strap 27 or lanyard (or wearable or environmental source) are used to determine if the strap 27 or lanyard (or wearable or environmental source) is actually being worn by (or is in proper proximity to) the user, or if the handheld controller 25 is being held without use of the strap 27 or lanyard (or wearable or environmental source).

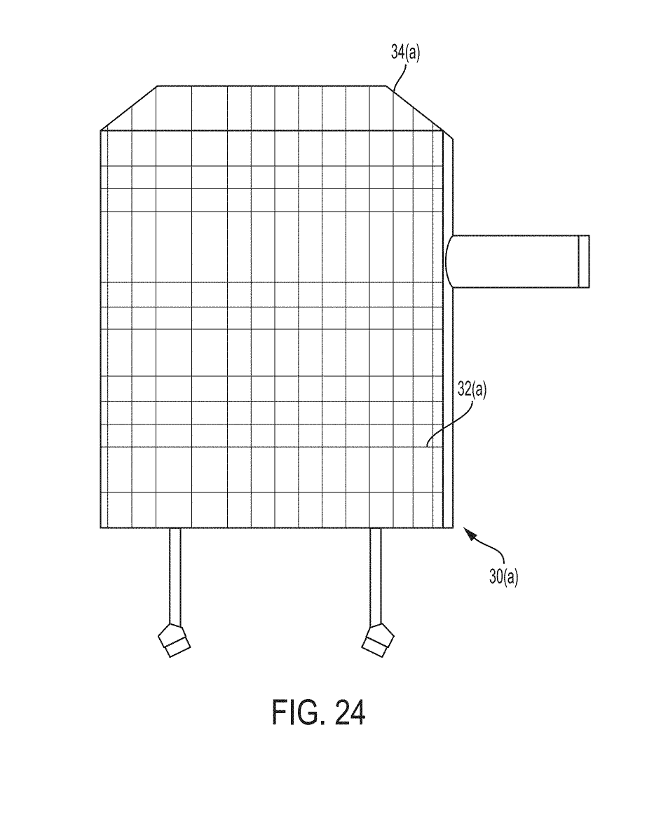

FIG. 24 is an illustration of an embodiment of a multi-layer sensor manifold 30(a) that can be used on a curved surface such as the handheld controller 25. In an embodiment, the multi-layer sensor manifold 30(a) has a layer of row conductors 32(a) and a layer of column conductors 34(a) separated by a small physical distance. In an embodiment, conductive leads are used for connection to the row conductors 32(a) and column conductors 34(a) In an embodiment, at least a portion of the conductive leads for the row conductors 32(a) are on the same layer as the row conductors 32(a). In an embodiment, at least a portion of the conductive leads for the column conductors 34(a) are on the same layer as the column conductors 34(a). In an embodiment, a flexible substrate is used to separate the layers of row conductors 32(a) and column conductors 34(a). In an embodiment, the row conductors 32(a) and column conductors 34(a) are etched, printed, or otherwise affixed onto opposite sides of the flexible substrate used to separate them. In an embodiment, the row conductors 32(a) and the column conductors 34(b) are affixed on separate substrates that are in close proximity with each other in the manifold 30(a).

In an embodiment, the multi-layer manifold 30(a) further comprises a layer of additional rows (not shown). In an embodiment, conductive leads are used for connection to the additional rows. In an embodiment, at least a portion of the conductive leads for the additional rows are on the same layer as the additional rows. In an embodiment, a flexible substrate is used to separate the layer of additional rows from the rows and/or columns. In an embodiment, the additional rows and one of the rows and columns are etched, printed, or otherwise affixed onto opposite sides of the flexible substrate used to separate them. In an embodiment, the additional rows are affixed on a separate substrate that is in close proximity to the substrate or substrates with the row conductors 32(a) and column conductors 34(a) in the manifold 30(a).

In an embodiment, the manifold 30(a) can be wrapped about a curved portion of a handheld controller 25. In an embodiment, the manifold 30(a) can be wrapped about the simple curvature of the curved portion of the handheld controller 25 shown in FIG. 22. In an embodiment, the manifold 30(a) can be wrapped about a handheld controller 25 or other shape that has compound curvature.

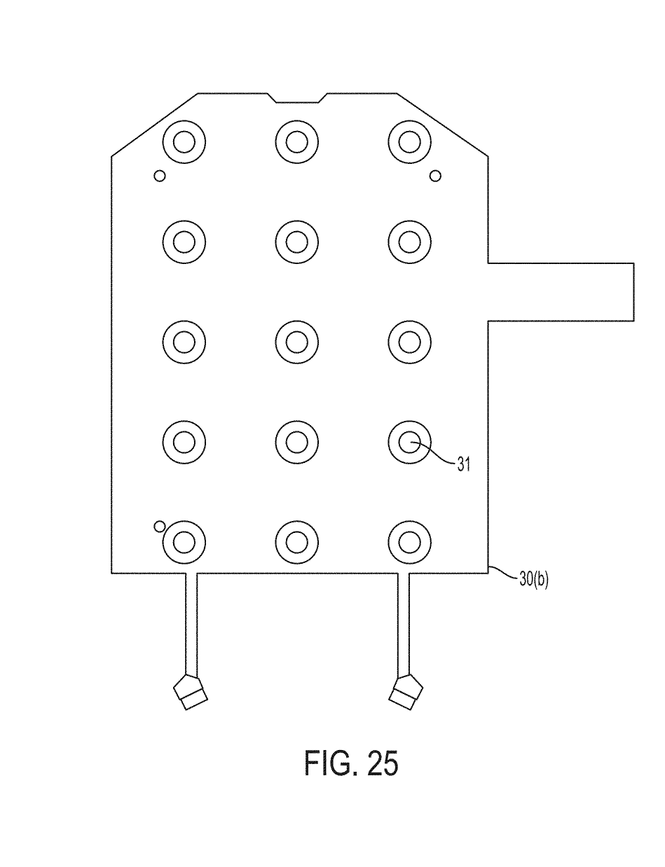

FIG. 25 is an illustration of an embodiment of a multi-layer sensor manifold 30(b) having antennas 31. The manifold 30(b) may be a flexible sensor sheet that used in connection with the hand-held controller 25 shown in FIG. 22. The antennas 31 in FIG. 25 may also be referred to as “dot sensors”, “electrodes”, or “spot sensors.” In FIG. 25 the antennas 31 are situated as islands in a grounded plane. Around each of the antennas 31 is ground. Each of the antennas 31 is operably connected to an integrated circuit capable of transmitting and receiving the required signals. The antennas 31 have improved sensing due to their grounded isolation from each of the other antennas 31 on the manifold 30(b). A signal injection conductor can be located elsewhere on the body, other that at the manifold 30(b). The signal injection conductor injects signals into the body (also referred to as infusion) that are then received at antennas 31. The received signal are then used to model movements of a hand or body part.

In FIG. 25, five rows of antennas 31 consisting of three antennas 31 per a row are shown, these numbers are arbitrary, subject to considerations discussed below, and could be more or less. In an embodiment, the fifteen antennas 31 are adapted to receive an injection (infusion) signal that has been injected into a human hand. The injection (infusion) signal may be infused through a variety of means at a variety of locations, e.g., through a wrist band, through a seat, or even via an electrode elsewhere on the controller 25. Regardless of where and how the injection (infusion) signal is generated, with the signal on the hand, the signal radiates from all points of the hand. In an embodiment, multiple infusion signals from the same, or different locations, are used.

In an embodiment, the manifold 30(b) can be used on a curved surface such as a handheld controller 25. In an embodiment, the antennas 31 are placed in rows or columns on the manifold 30(b). In an embodiment, the antennas 31 are not placed in rows or columns on the manifold 30(b). In an embodiment, the antennas 31 are arranged in an array. In an embodiment, the antennas 31 are distributed randomly. In an embodiment, the antennas 31 are located in predetermined locations with clusters of antennas 31 at specific locations. In an embodiment, the antennas 31 are arranged in dense programmable arrays, wherein antennas can be programmed to change roles. In an embodiment, at least one of the antennas 31 are flush with the surface of the layer in which they are on. In an embodiment, at least one of the antennas 31 protrude from the layer they are on. In an embodiment, at least one of the antennas 31 is electrically connected to drive circuitry. In an embodiment, at least one of the antennas 31 is electrically connected to receiver circuitry. In an embodiment, at least one of the antennas 31 is electrically connected to circuitry via a shielded coaxial cable. In an embodiment, the antennas 31 are electrically connected to circuitry via a shielded coaxial cable. In an embodiment, the antennas 31 are electrically connected to circuitry via a shielded coaxial cable, where the shield is grounded. In an embodiment, the antennas 31 are receive antennas that can be used as dot sensors. In an embodiment, the antennas 31 are signal injection electrodes that can be used for frequency injection (infusion).

Still referring to the manifold 30(b) of FIG. 25, in an embodiment, as the hand moves and/or wraps about the controller 25, one or more individual fingers change their relative distance from the antennas 31 Because the infusion signal decreases with the distance between the finger and the antennas 31, in an embodiment, fingers closer to antennas 31 will make a stronger contribution than fingers farther away. In the illustrated embodiment, five rows of three antennas 31 are used, each pair of adjacent antenna rows corresponding to the position of a fingers wrapped about the controller 25, and each of the antennas 31 corresponding to the position of one of the finger segments wrapped about the controller 25. In an embodiment, four rows of three antennas 31 are used, each of the receiver rows corresponding to the position of a fingers wrapped about the controller 25, and each of the antennas 31 corresponding to the position of one of the finger segments wrapped about the controller 25. In an embodiment, three rows of three antennas 31 are used, each of the rows corresponding to the inter-finger on a hand wrapped about the controller 25, and each of the antennas 31 corresponding to the position of one of the finger segments wrapped about the controller 25.

Because the antennas 31 are omnidirectional when sensing, it may be difficult to identify the position of a probe (e.g., finger) within the receiver's volume. Thus it may be desirable to constrain or steer a receiver's volume in order to more easily identify the position of a probe. When reconstructing the hands, for example, unconstrained receivers close to an index finger can receive contributions from the middle, ring, and pinky finger. This behavior introduces signal confounds and makes it more difficult to reconstruct finger movement. In an embodiment, an isolation trace (a/k/a isolation conductor, isolation antenna) can be placed near an antenna 31 to constraint its sensing volume.

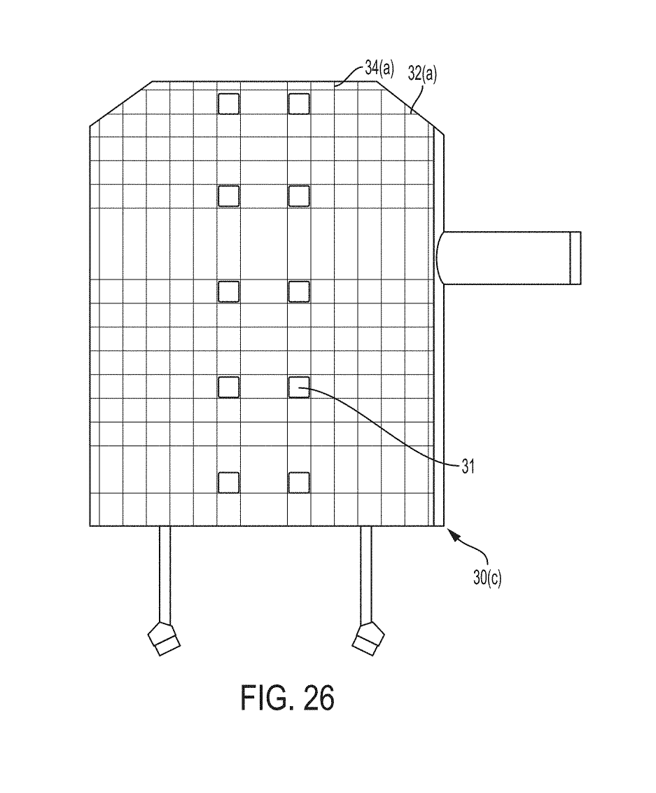

FIG. 26 is an illustration of an embodiment of a multi-layer sensor manifold 30(c) as generally shown in FIG. 24 and but additionally having antennas 31 (as in FIG. 25). In an embodiment, the manifold 30(c) can be used on a curved surface such as a handheld controller 25. In an embodiment, the antennas 31 are interleaved with the rows 32(a) and columns 34(a) on one of the row layer or the column layer. In an embodiment, the antennas 31 are interleaved with the rows 32(a) and columns 34(a) but on a separate layer. In an embodiment, at least one of the antennas 31 are flush with the surface of the layer in which they are on. In an embodiment, at least one of the antennas 31 protrude from the layer they are on. In an embodiment, at least one of the antennas 31 is electrically connected to drive circuitry. In an embodiment, at least one of the antennas 31 is electrically connected to receiver circuitry. In an embodiment, at least one of the antennas 31 are electrically connected to circuitry via a shielded coaxial cable. In an embodiment, the antennas 31 are electrically connected to circuitry via a shielded coaxial cable. In an embodiment, the antennas 31 are electrically connected to circuitry via a shielded coaxial cable, where the shield is grounded. In an embodiment, the antennas 31 are receive antennas that can be used as dot sensors. In an embodiment, the antennas 31 are signal injection electrodes that can be used for frequency injection.

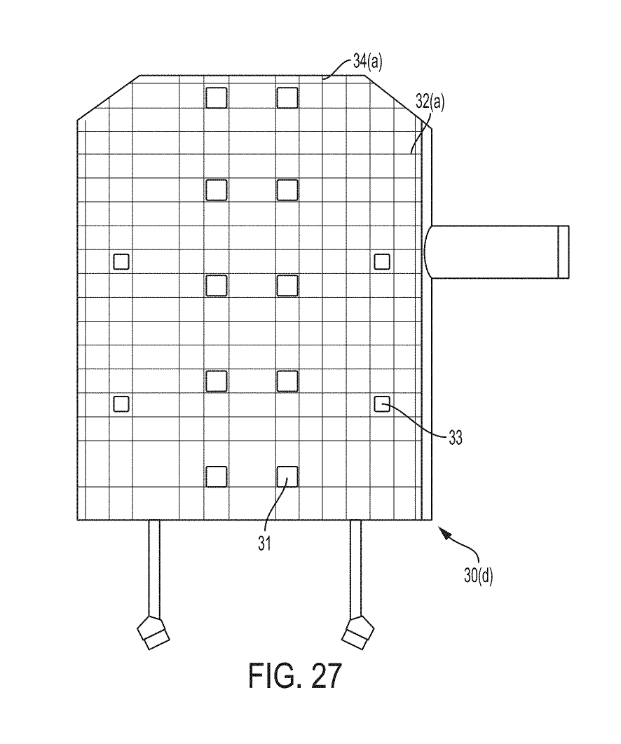

FIG. 27 is an illustration of another embodiment of a multi-layer sensor manifold 30(d) as generally shown in FIG. 26 having antennas 31 and additional signal injection conductors 33. In an embodiment, the manifold 30(d) is curved around a handheld controller 25 such as the one shown in FIG. 22. In an embodiment, the signal injection conductors 33 are provided. In an embodiment, the signal injection conductors 33 are used as a combination of frequency injectors and dot sensors. It will be apparent to one of skill in the art in view of this disclosure that the number, orientation and utilization of the additional signal injection conductors 33 will vary with the application in which the sensor manifold 30(d) is used.

In an embodiment, the signal injection conductors 33 are the outermost electrodes on the left and right sides. In an embodiment, the signal injection conductors 33 are electrically connected to drive circuitry (not shown) that provides a plurality of unique orthogonal signals. In an embodiment, the drive circuitry simultaneously provides at least one of a plurality of unique frequency orthogonal signals to each of the signal injection conductors 33. In an embodiment, the drive circuitry simultaneously provides multiple unique frequency orthogonal signals to each of the signal injection conductors 33. In an embodiment, the drive circuitry simultaneously provides at least one of a plurality of unique frequency orthogonal signals to each of the signal injection conductors 33 and to each of the row conductors 32(a). In an embodiment, the drive circuitry simultaneously provides multiple ones of a plurality of unique frequency orthogonal signals to each of the signal injection conductors 33 and at least one other of the plurality of unique frequency orthogonal signals to each of the row conductors 32(a).

In an embodiment, the five innermost antennas 31 on the left and the five innermost antennas 31 on the right sides are dot sensors. In an embodiment, the dot sensors are electrically connected to receive circuitry (not shown) that can determine a signal strength for a plurality of orthogonal signals, including, at least the orthogonal signals emitted by the signal injection conductors 33. In an embodiment, the dot sensors are electrically connected to receive circuitry (not shown) that can determine a signal strength for a plurality of orthogonal signals, including at least the orthogonal signals emitted by the signal injection conductors 33 and orthogonal signals transmitted on the row conductors 32(a).

In an embodiment, the heterogeneous manifold sensor 30(d) is wrapped about the surface of the handheld controller 25 of FIG. 22, the row conductors 32(a) and signal injection conductors 33 each having a different one or more of a plurality of orthogonal signals thereupon provided by a drive circuitry, and the dot sensors antennas 31 and column conductors 34(a) each being electrically connected to receive circuitry that for each sensor antenna 31 or column conductors 34(a) can determine a signal strength associated with each of the plurality of orthogonal signals. In a further embodiment, the signal strengths are used to determine the position and orientation of a hand with respect to the sensor. And in yet a further embodiment, a strap 27 is used to support the handheld controller 25 on the hand to provide partially constrained freedom of movement to the hand.

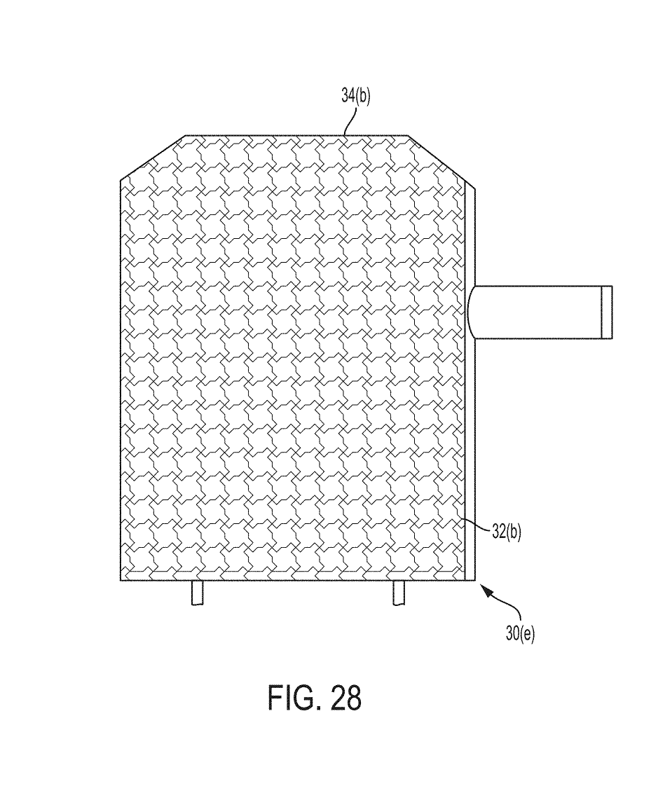

FIG. 28 is an illustration of another embodiment of a multi-layer sensor manifold 30(e). The multi-layer sensor manifold 30(e) has row conductors 32(b) and column conductors 34(b) that are formed in a pattern.

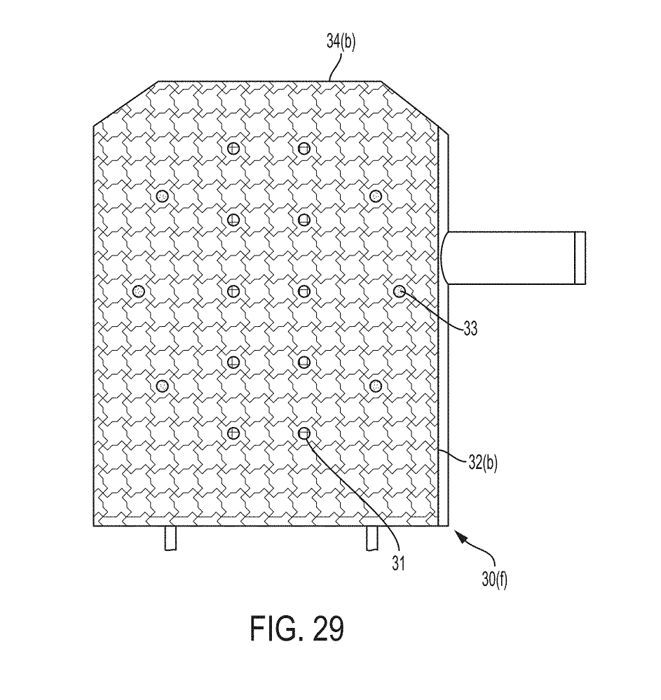

FIG. 29 is an illustration of yet another embodiment of a multi-layer sensor manifold 30(f) having antennas 31 and signal injection conductors 33. Additionally, the multi-layer sensor manifold 30(f) has row conductors 32(b) and column conductors 34(b) having the same pattern as that shown in FIG. 28.

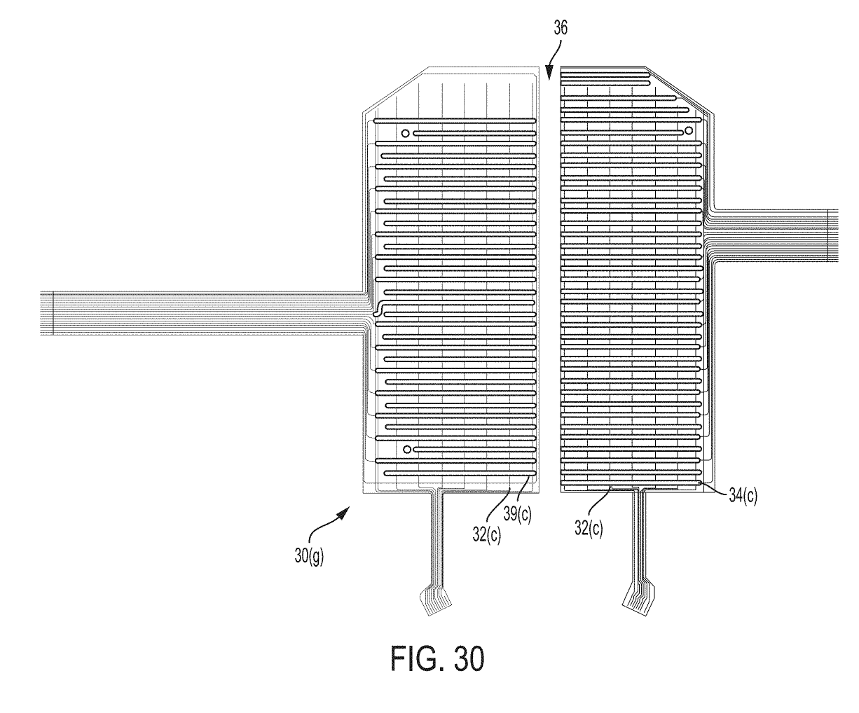

FIG. 30 is an illustration of yet other embodiment of a multi-layer sensor manifold 30(g). In FIG. 30, column conductors 34(c) and row conductors 32(c) are located on two different regions separated by a split 36. Each of first and second regions have column conductors 34(c) and row conductors 32(c). The split 36 (or cavity) separate the regions of column conductors 34(c) and row conductors 32(c). The two different regions form a manifold 30(g) that can be used with, for example, the handheld controller 25.

In an embodiment, a signal injection conductor (not shown) is located in a different area of the controller, or on the body, and provides a signal that is received at the column conductors 34(c) and the row conductors 32(c) on the two different regions. In an embodiment, the two regions are operably connected to different integrated circuits. In an embodiment the two regions are operably connected to the same integrated circuit.

In an embodiment, antennas 31 are on one region having row conductors 32(c) and column conductors 34(c) and the signal injection electrode 33 are on a different region having row conductors 32(c) and column conductors 34(c). In an embodiment, the antennas 31 and the signal injection conductors 33 are on both regions. An embodiment may have one split 36 resulting in two different regions. An embodiment may have more than one split 36 and result in many different regions. An embodiment may be composed of multiple multi-layer sensor manifolds 30(g). Although the rows and columns are oriented differently, the descriptions above applicable FIGS. 28, 29, and 30 are similarly applicable to FIGS. 24, 25, 26, and 27.

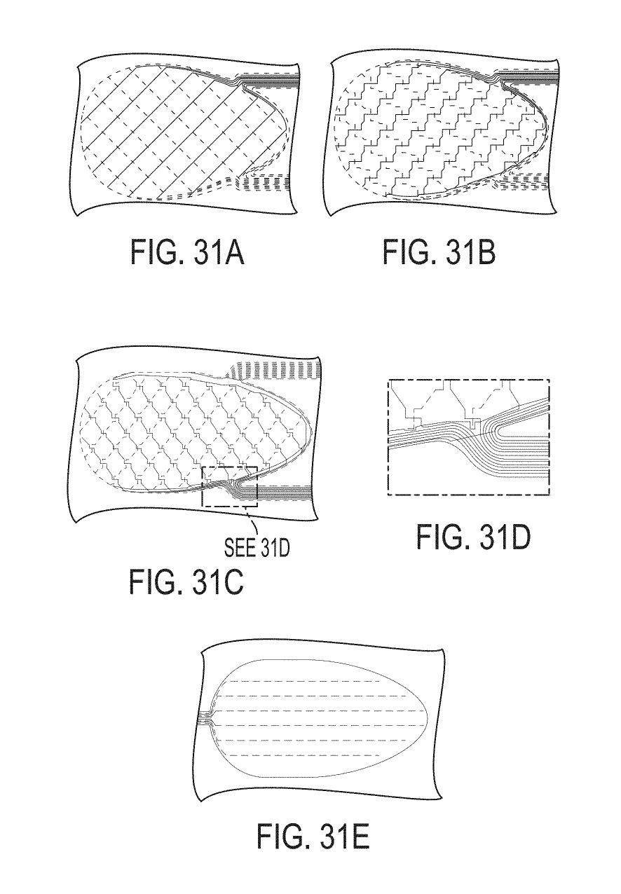

Referring now to FIGS. 31A-31E, shown are sensor patterns for use in connection with a thumb-centric portion of a controller. In an embodiment, the thumb-centric sensor pattern is a made up of a grid of row conductors and column conductors. In an embodiment, the row-column orientation of the thumb-centric sensor pattern is placed at an angle such that the rows and columns run diagonally across the face of the thumb-centric sensor pattern as it is oriented on the controller. In an embodiment, the row conductors, and the column conductors of the thumb-centric sensor pattern are placed at an angle with respect to their respective orientation on the controller of approximately 30 degrees. In an embodiment, the row conductors, and the column conductors of the thumb-centric sensor pattern are placed at an angle with respect to their respective orientation on the controller of approximately 60 degrees. In an embodiment, the thumb-centric sensor pattern is made of three layers, comprising two layers of receivers that run generally diagonally with respect to the thumb-centric portion of the controller, and a third layer of transmitters that operate above, below or between the two layers of receivers, and are oriented either generally horizontally or generally vertically with respect to the thumb-centric portion of the controller.

Turning now to FIGS. 31A-31C, three sensor patterns are illustratively shown which may be employed as a thumb-centric sensor pattern in connection with the present invention. While these specific examples have been found to provide acceptable results, it is within the scope and spirit of this disclosure, to use other sensor patterns as a thumb-centric sensor pattern in connection with the present invention. Many other sensor patterns will be apparent to a person of skill in the art for use as a thumb-centric sensor pattern in view of this disclosure.

The sensor pattern shown in FIG. 31A, where row conductors and column conductors (e.g., transmitting antenna and receiving antenna) are shown in solid and dashed lines, works adequately. The sensor pattern shown in FIG. 31B also shows row conductors and column conductors in solid and dashed lines. The sensor pattern in FIG. 31B additionally comprises decoupling lines that run near the feedlines. FIGS. 31C and 31D show layers of a three-layer sensor, the solid and dashed lines of FIG. 31C each representing a layer of the sensor, and the solid lines of FIG. 31D representing another layer. In an embodiment, the solid and dashed lines of FIG. 31C are all used as columns (e.g., receiving antenna), and the solid lines of FIG. 31D are used as transmitters. In an embodiment, the three-layer sensor provides high quality imaging for the purpose of the thumb-centric sensor pattern in a controller as discussed herein. The sensor pattern in FIG. 31C additionally comprises broader decoupling lines (which can be referred to as decoupling planes) that run near the feedlines. A partial detail of FIG. 31C is also provided for clarity.

As a capacitive object such as a finger approaches the feedlines, smearing may result. In an embodiment, to mitigate the smearing, the feedlines can be moved either to a more remote location, e.g., by enlarging the thumb-centric sensor pattern area. In an embodiment, to mitigate the smearing, the feedlines can be directed away from the surface, and into the object. Each of these has drawbacks that will be apparent to a person of skill in the art. In an embodiment, to mitigate the smearing, decoupling lines as shown in FIG. 31B or broader decoupling planes as shown in FIG. 31C may be added.

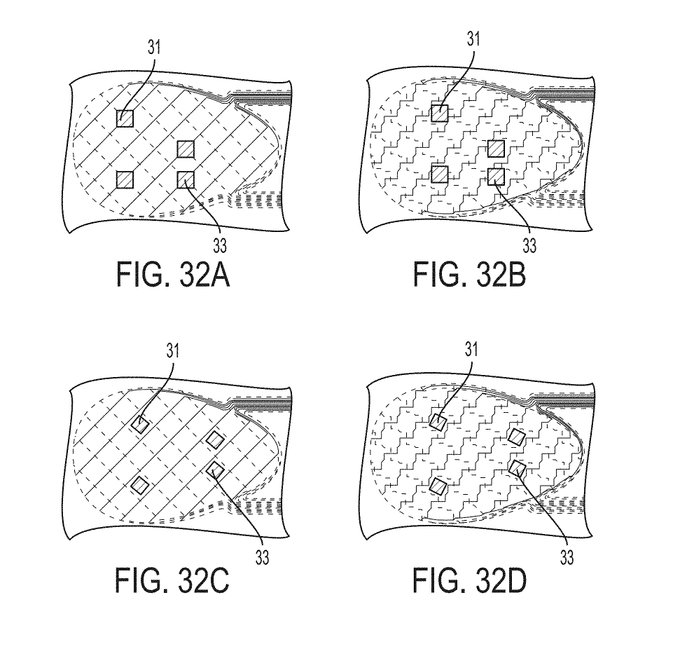

FIGS. 32A-32B are illustrations of an embodiment of a thumb-centric sensor pattern as generally shown in FIGS. 31A-31E, but additionally having antennas 31 and/or signal injection antennas 33. In an embodiment, the antennas 31 and/or signal injection conductors 33 are interleaved with the row conductors and column conductors on one of the row layer or the column layer. In an embodiment, the antennas 31 and/or signal injection conductors 33 are interleaved with the row conductors and column conductors but on a separate layer. In an embodiment, the antennas 31 and/or signal injection conductors 33 overlap the row conductors and/or column conductors on one of the row layer or the column layer. In an embodiment, the antennas 31 and/or signal injection conductors 33 overlap with the row conductors and/or column conductors but on a separate layer. In an embodiment, at least one of the antennas 31 and/or signal injection conductors 33 are flush with the surface of the layer in which they are on. In an embodiment, at least one of the antennas 31 and/or signal injection conductors 33 protrude from the layer they are on. In an embodiment, at least one of the antennas 31 and/or signal injection conductors 33 is electrically connected to drive circuitry. In an embodiment, at least one of the antennas 31 and/or signal injection conductors 33 is electrically connected to receiver circuitry. In an embodiment, at least one of the antennas 31 and/or signal injection conductors 33 are electrically connected to circuitry via a shielded coaxial cable. In an embodiment, the antennas 31 and/or signal injection conductors 33 are electrically connected to circuitry via a shielded coaxial cable. In an embodiment, the antennas 31 and/or signal injection conductors 33 are electrically connected to circuitry via a shielded coaxial cable, where the shield is grounded. In an embodiment, the antennas 31 and/or signal injection conductors 33 are receive antennas that can be used as dot sensors. In an embodiment, the antenna 31 are signal injection antenna that can be used for frequency injection (infusion).

In an embodiment, the characteristics of antennas, signal injection conductors, row conductors and column conductors can change in real-time to dynamically adjust the behavior of a sensor design. In addition to surface area, the behavior of each antenna, signal injection conductors, row conductors and/or column conductors can be changed in real-time to programmatically alter sensor design. Given a matrix of N×M antenna, each e.g., with a square geometry of 5×5 mm, the behavior of each element could be dynamically designated as a transmitter or receiver. Moreover, given the receiver isolation method discussed previously, some antenna could be designated as infusion transmitters (e.g., isolators) to isolate the response volume of a given receiver. Similarly, some antenna could be grounded to reduce the response of nearby receivers.

Beyond identity, surface area of the sensor could be programmed as well. An example: the parallel plate capacitor model demonstrates that capacitance will increase as the surface area of a plate increases. Given a matrix of square antenna, e.g., each with a surface of 5×5 mm, and a set of physical switches between each antenna, it is possible to dynamically change an antenna's surface area. Combinations of these square antennas can be connected using their switches. For example, a group of two antenna can be connected to produce a surface area of 50 mm² (i.e. 5×10 mm), a group four can be connected to form a 100 mm² area (i.e. 10×10 mm), and so on. Of course, the 5×5 size is just illustrative, and this principle would be equally applicable to smaller and larger arrays of antenna.

In an embodiment, e.g., when using a grip controller, the role of each antenna can be updated to reflect a new position of a hand or finger. If a hand position changes relative to a controller's surface, antenna that were previously transmitters could be designated as receivers to ensure a more localized view of a finger

### Frequency Injection Supporting Hand Tracking

In an embodiment, one or more overlaid sensors can be used to track different information. In an embodiment, FMT capacitive sensor contact detection, hand tracking, and hover measurements can be improved when supported by frequency injection. For a description of the FMT capacitive sensor, see, generally, Applicant's prior U.S. patent application Ser. No. 13/841,436, filed on Mar. 15, 2013 entitled “Low-Latency Touch Sensitive Device” and U.S. patent application Ser. No. 14/069,609 filed on Nov. 1, 2013 entitled “Fast Multi-Touch Post Processing.” Frequency injection refers to the application of a frequency, or multiple frequencies, to a user's body, and thus, using the user's body as a conductor of that frequency onto an FMT capacitive sensor. In an embodiment, an injected frequency is frequency orthogonal to the frequencies that are transmitted on the FMT capacitive sensor transmitters. In an embodiment, a plurality of injected frequencies are both frequency orthogonal with respect to each other, and frequency orthogonal to the frequencies that are transmitted on the FMT capacitive sensor transmitters.

Generally, FMT employs a sensor pattern where rows act as frequency transmitters and columns act as frequency receivers. (As discussed above, the designation of row and column are arbitrary, and not intended to designate, e.g., a grid-like organization, nor a generally straight shape of either.) In an embodiment, when combining frequency injection with FMT, the columns are additionally used as receivers to listen for the injected frequency or frequencies. In an embodiment, when combining frequency injection with FMT, both the rows and the columns are additionally used as receivers to listen for the injected frequency or frequencies.

In an embodiment, a known frequency is, or known frequencies are, carried to e.g., the hand of the user, using one or more separate transmitters. In an embodiment, one or more elements (e.g., transmitters) are placed on or near the surface of a device, where they are likely to be in touch with the user's hand during operation of the device. In an embodiment, one or more transmitters are placed on or near the surface of the device body, where they are likely to be in contact with the user's hand during operation of the device body. When there is sufficient touch with the hand in operation of the device, a signal enters and goes through the hand which can be detected by the sensor. The transmission loop goes from a signal generator, to the element on the body of the device, to the hand, to the receive antenna (e.g., column) where it is measured by FMT. In an embodiment, the transmission loop is closed when the hand is in touch (but not necessarily in contact with) the transmitter and in touch (but not necessarily in contact with) the receive antenna. In an embodiment, elements (e.g., antenna) are placed, for example, but without limitation, on the device, a hand strap, ring, bracelet, a wearable, a seating pad, a chair, a tabletop, a floor mat, an armrest, or any other object that is likely to be in touch with the user during operation of the device. A transmission loop is created as described above with the device body elements, except that the strap elements would touch the back of the user's hand rather than, e.g., the palm. In an embodiment, a signal injection system is in the form of, or at least partly in the form of: a wristband; a watch; a smartwatch; a mobile phone; a glove; a ring; a stylus; a pocketable object; a seat cushion or other seating pad; a floor mat; an armrest; a desk surface; a belt; a shoe; a wearable computing device, or any other object that is likely to be in touch with the user during operation of the controller. In an embodiment, a transmission loop is similarly created by the user's body between the injected signal source and the receive antenna.

In an embodiment, with the known frequencies injected, FMT can measure the strength of the known frequency or the known frequencies at each receiver. In an embodiment, with the known frequencies injected, FMT can measure the strength of the known frequency or the known frequencies on each row and on each column by associating a receiver and signal processor with each row and each column. In an embodiment, the measurement of signal strength for the injected frequency or frequencies on each row provides information concerning the location of the body part conducting the injected frequency.

In an embodiment, the measurement of signal strength for the injected frequency or frequencies on each row and each column provides more detailed information concerning the location of the body part conducting the injected frequencies. In an embodiment, the location information from the rows and from the columns provides two separate one-dimensional sets of measurement of the signal strength. In an embodiment, the two one-dimensional sets provide a descriptor which can be used to generate intermediate representations such as a 2D Heatmap (similar to conventional FMT Transmitter/Receiver Heatmap). In an embodiment, the two one-dimensional sets provide a descriptor which can be used to enable better fidelity in reconstruction of the motion of fingers in proximity of the sensor. In an embodiment, detected frequency injection signals provides increased hover range over the range of the FMT sensor pattern alone. In an embodiment the combination of FMT and frequency injection effectively extended the range of hand modeling beyond 4 cm. In an embodiment the combination of FMT and frequency injection effectively extended the range of hand modeling to beyond 5 cm. In an embodiment the combination of FMT and frequency injection effectively extended the range of hand modeling beyond 6 cm. In an embodiment the combination of FMT and frequency injection effectively extended the range of hand modeling to full flexion, i.e., the full range of motion of the hand.

In an embodiment, frequency injection descriptors are used to create predefined profiles of signal strengths corresponding to a set of discrete positions of a finger. In an embodiment, the descriptors are combined with baseline and noise reduction techniques or other multi-dimensional analysis techniques (see, e.g., Applicant's prior U.S. patent application Ser. No. 14/069,609, filed on Nov. 1, 2013 entitled “Fast Multi-Touch Post-Processing” and U.S. patent application Ser. No. 14/216,791, filed on Mar. 17, 2014 entitled “Fast Multi-Touch Noise Reduction”) to extract meaningful information from these descriptors that can correlate to the finger motion. In an embodiment, FMT heatmap processing techniques can also be used on top of this frequency strength signals. By combining FMT heatmap processing and descriptors resulting from detected frequency injection signals, fidelity may be improved. In an embodiment, the intensity of the signal from the signal generator to the element should be sufficient to allow detection of the hand beyond the 4 cm range. In an embodiment, the intensity of the signal from the signal generator to the element should allow detection beyond the 5 cm range. In an embodiment, the intensity of the signal allows for the detection beyond 7 cm. In an embodiment, the intensity of the signal allows for the detection of full flexion of the hand. In an embodiment, the intensity of the signal allows for the detection of full abduction (i.e., finger-to-finger contact) of one or more fingers. In an embodiment, the intensity of the signal allows for the detection palm breadth. In an embodiment, the intensity of the signal allows for the detection of finger length, finger thickness, and/or joint thickness. In an embodiment, the intensity of the signal allows for the detection of crossed fingers. In an embodiment, the intensity of the signal allows for the detection of the hover of crossed fingers.

In an embodiment, hand tracking is computed using a hierarchical skeleton based description of a virtual hand to describe the real hand. In an embodiment, the frequency injection descriptors are mapped into a continuous real-time animation or other digital representation of that hierarchical skeleton based description of a virtual hand, thus mimicking the real hand motion.

It will be apparent to a person of skill in the art that the mapping can be achieved using linear or nonlinear functions, in real time, to translate the signal feed into a feed of finger angles or a feed of skeletal angles. In an embodiment, correlation properties between signal strength samples and a ground truth reference can be employed. In an embodiment, a ground truth reference is captured using another technique, such as, without limitation, motion capture, other vision based processing technique or predefined captured poses.

It will be apparent to a person of skill in the art that the intrinsic properties of the signal injection as applied to and measured from the hand as described above can be used as the basis to define the model mapping. In an embodiment, one or more of the following generalized data techniques can be employed for such mapping: manual or automatic supervised or non-supervised training, data mining, classification or regression techniques. In an embodiment, the data technique is used to identify the adequate definition of the mapping functions which can be used for hand modeling, and thus hand tracking purposes. As discussed above, in an embodiment, the signal injection hardware and software as discussed above, can be combined with FMT capabilities, exploiting the same FMT sensor pattern, transmitters and receivers. In an embodiment, the signal injection hardware and software as discussed above, can be combined with FMT capabilities, thus complementing an FMT touch sensor system with additional receivers. In an embodiment, the signal injection hardware and software as discussed above, can be combined with FMT capabilities, thus complementing an FMT touch sensor system with capacity to recognize additional injected frequencies.

### Finger and Hand Flexion

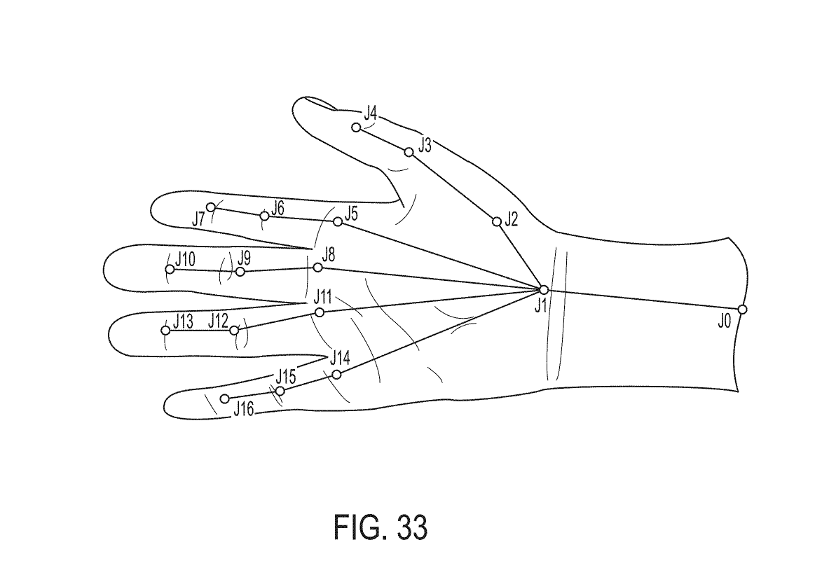

FIG. 33 contains an illustration of the human hand and a series of joints and bones in the hand. The illustration, and the model used, may be simplified to the extent that some parts (e.g., the carpals) are or may not be relevant to the models produced. Specifically, FIG. 33 shows each bone's corresponding position (or the position of a simplification) on a human hand, its' hierarchy with respect to other bones (e.g., J4's parent is J3, J3's parent is J2, J2's parent is J1, J1's parent is J0). In an embodiment, the node in the forearm (J0) is the root node and has no parent). Co-pending U.S. Provisional Patent Application No. 62/473,908, entitled “Hand Sensing Controller” discusses and describes the sensing of finger flexion. In an embodiment, this may be extended to sense multi-finger flexion.

In an embodiment, multi-finger flexion is sensed using hover and contact data via fast multi-touch sensors and methods. In an embodiment, hover and contact data from a trigger-centric sensor pattern is used to sense index, middle, ring, and pinky finger flexion. In an embodiment, multi-finger flexion is sensed using signal injection and dot sensors as herein described. In an embodiment, multi-finger flexion is sensed using a heterogeneous sensor and injectors as described herein.

In an embodiment, a reference frame is stored. In an embodiment, a reference frame reflects the state of the sensor detecting finger flexion when the controller is at rest, i.e., no detectable signals are received as a result of touch. In an embodiment, a single N×M frame of raw signal data is saved as the baseline. In an embodiment, a N×M frame of raw signal data and the state of the dot sensors is saved as the baseline.

In an embodiment, using the baseline, an incoming frame is converted into decibels (i.e., −20.0f log 10(incoming/baseline)). The converted incoming frame may be referred to as the heatmap. In an embodiment, the incoming frame includes data from the dot sensors antennas.

In an embodiment, the average signal value is calculated for the row frequencies. The average signal value is referred to as the multi-finger waveform. In an embodiment, for each column M in the heatmap, the average signal value of the column is calculated as the multi-finger waveform. In an embodiment, the multi-finger waveform is calculated for each row N. In an embodiment, the multi-finger waveform is calculated from a combination of the signal values of rows and columns. In an embodiment, the selection of information for calculation of the multi-finger waveform depends on the sensor pattern.

In an embodiment, the average signal value for each finger may be calculated. The average signal value is referred to as the finger waveform. In an embodiment, for each column M in the heatmap, the average signal value of the column is calculated as the finger waveform. In an embodiment, the finger waveform is calculated for each row N. In an embodiment, the finger waveform is calculated from a combination of the signal values of rows and columns. In an embodiment, the selection of information for calculation of the finger waveform depends on the sensor pattern. In an embodiment, the values for a multi-finger waveform may be calculated.

[1] In an embodiment, a multi-finger waveform representing the nearly vertical fingers (as viewed from the top, i.e., extended away from the controller) may be saved as a template. In an embodiment, the template can be made from a controller grasped with the index, middle, ring, are pinky finger all being nearly vertical. In an embodiment, the template is associated with the hand or user from which the template was acquired. In an embodiment, multiple templates (e.g., for multiple hands and/or users, and/or for the same hand) are also saved for future use. In an embodiment, multiple templates may combine. Templates may be combined to normalize information or obtain statistical data about the hand and finger.

In an embodiment, during typical movement, the incoming multi-finger waveforms can be compared against the template. In an embodiment, the normalized root mean square deviation (NRMSD) is calculated to provide a similarity measure of the incoming waveforms and the template.

In an embodiment, injected frequencies, as detected at one or more dot sensors, may support the determination of finger position and orientation.

To improve the accuracy of the similarity measure, in an embodiment, the incoming waveform and template are split into three regions corresponding to the individual bones of the finger (proximal, middle, distal) and the position of the bones of the finger along the sensor. In an embodiment, three NRMSD values are calculated, one for each section of the finger (NRMSDproximal, NRMSDmiddle, NRMSDdistal). Each portion of the incoming finger waveform is then compared against the template.

In an embodiment, the NRMSD value is used as a weight to calculate the rotation at each joint. For example:

Rproximal=NRMSDproximal*Angle_Maximumproximal.

Rmiddle=NRMSDmiddle*Angle_Maximummiddle.

Rdistal=NRMSDdistal*Angle_Maximumdistal.

In an embodiment, because the NRMSD is always positive, the integral of the template and incoming finger waveform may be calculated to determine when the index finger is extended. The integral of the incoming waveform and the template will be less than zero. In an embodiment:

Rproximal=NRMSDproximal*Angle_Extensionproximal.

Rmiddle=NRMSDmiddle*Angle_Extensionmiddle.

Rdistal=NRMSDdistal*Angle_Extensiondistal.

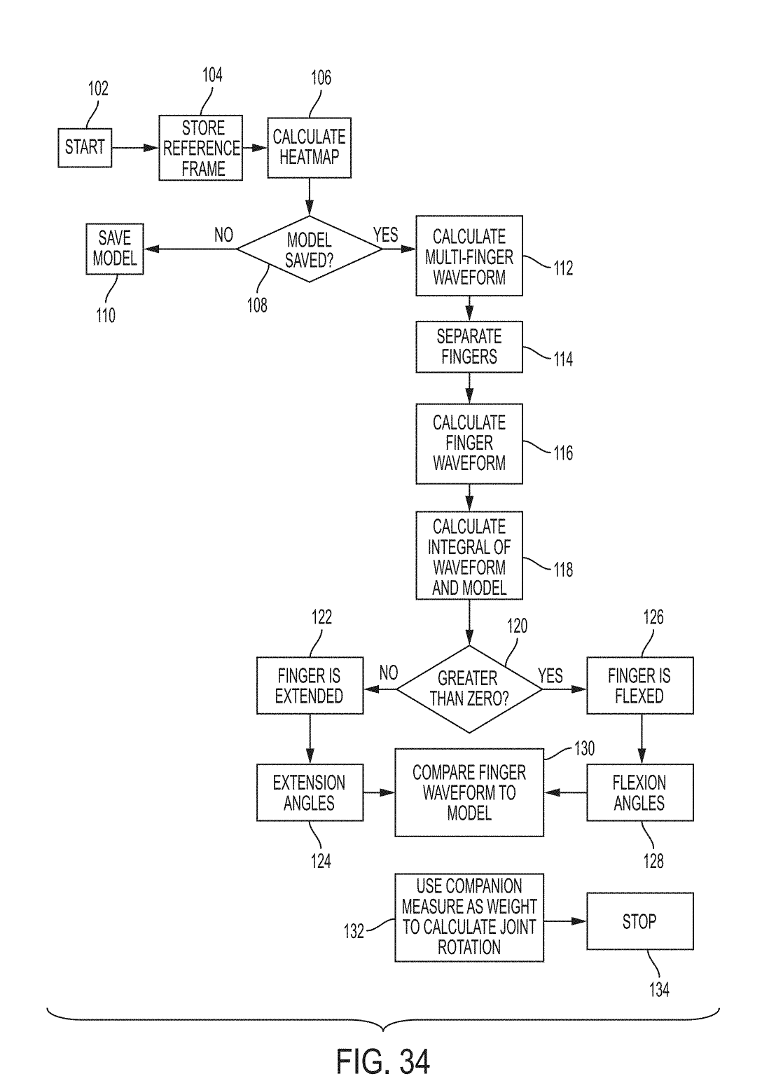

FIG. 34 is a high-level flow diagram showing one embodiment of a method of using sensor data to infer skeletal position relative to the sensor. In step 102, the process is started. In step 104, a reference frame is stored. In step 106, a heatmap is calculated. In step 108, it is determined if the model was saved. In step 110, the model is save if it was not saved before. In step 112, if the model had been saved the multi-finger waveform is calculated. In step 114, the separate fingers are calculated. In step 116, the finger waveform is calculated. In step 118, the integral of the waveform and the model is calculated. In step 120, it is determined if it is greater than zero. If not, in step 122, the finger is extended. In step 124, the extensions angles are determined. In step 126, if the integral of the waveform is greater than zero, the finger is flexed. In step 128, the flexion angles are determined. In step 130, the finger waveform is compared to a model. In step 132, a companion measure is used as a weight to calculate join rotation. In step 134, the calculation from step 132 is stopped.

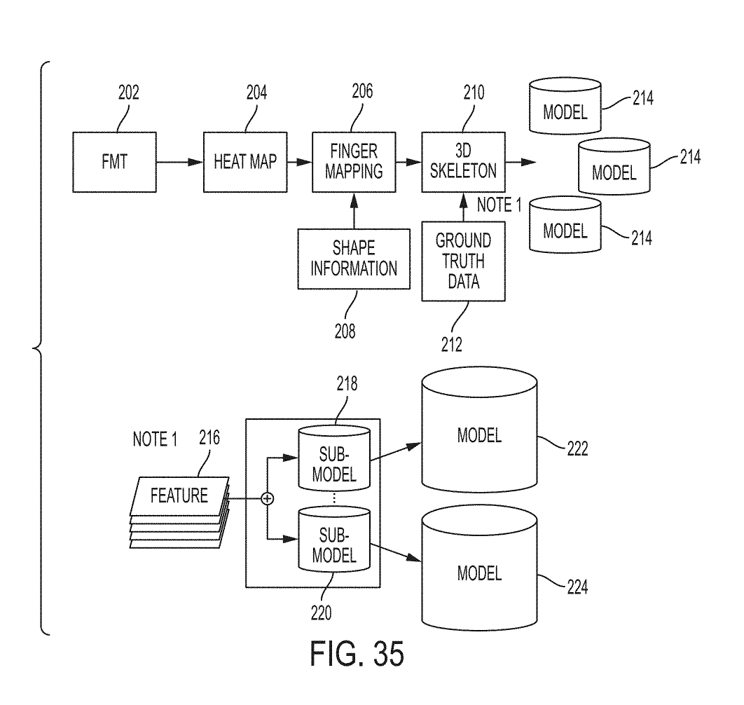

FIG. 35 is a block diagram showing one embodiment of a skeletal reconstruction model creation workflow. In step 202, fast multi-touch sensing occurs. In step 204, a heat map is created. In step 206, finger mapping occurs. In step 208, shape information can be used in the finger mapping. In step 210, a 3D skeleton is created. In step 212, ground truth data is used in creating the 3D skeleton. In step 214, models are created. In step 216 a feature is used. In step 218, sub-models are created. In step 222, models are created.

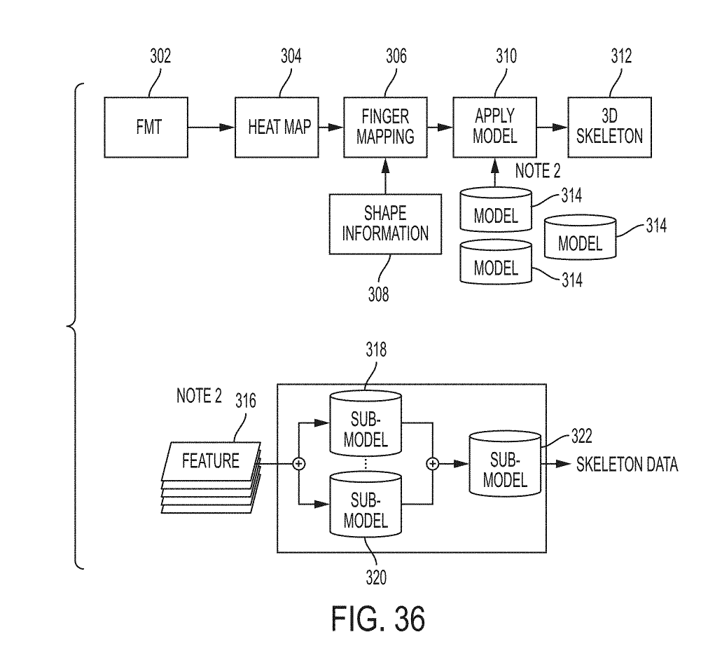

FIG. 36 is a block diagram showing one embodiment of a real-time skeletal hand reconstruction workflow. In step 302 fast multi-touch sensing occurs. In step 304, a heat map is created. In step 306, finger mapping occurs. In step 308, shape information can be used in the finger mapping. In step 310, a model is applied. In step 314, the models for step 310 are provided. In step 312, a 3D skeleton is formed. In step 316 a feature is used. In step 318, sub-models are created. In step 322, a sub-model is created.

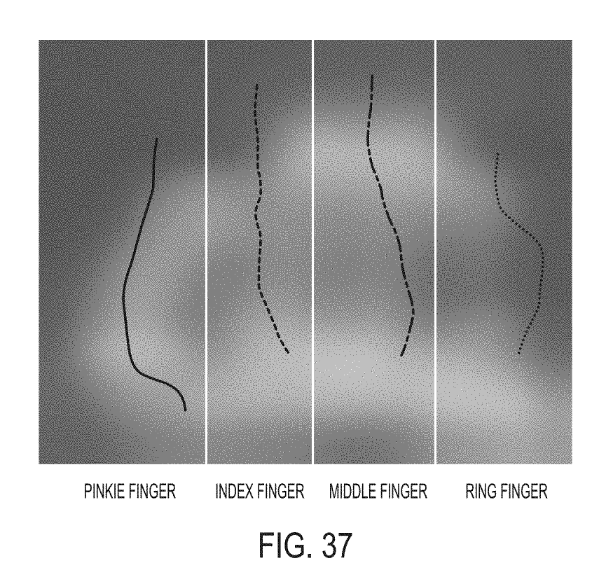

Turning to FIG. 37, a rendering of a heatmap of fingers grasping a handheld controller is shown. In an embodiment, the sensor data is sufficiently clear to delineate between fingers even when the fingers are touching each other.

### Processing the Heatmap to Identify the Fingers and Finger Properties

In an embodiment, one step towards reconstructing a hand skeleton and movement is finger separation. Thus, in connection with the reconstruction of finger movement (e.g., while grasping a handheld controller) separate finger locations (i.e., areas) may be determined on the heatmap before finger waveforms are calculated.

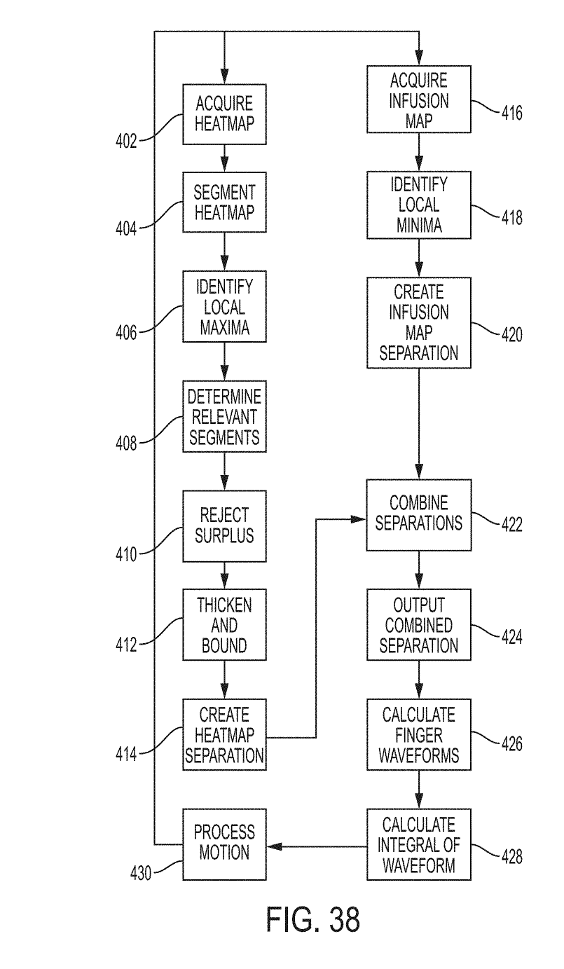

FIG. 38 contains a flowchart showing implementation of one embodiment of the present invention. The steps Acquire Heatmap in step 402, Segment Heatmap in step 404, Identify Local Maxima in step 406, Determine Relevant Segments in step 408, Reject Surplus in step 410, Thicken and Bound and Create Heatmap Separation in step 412, reflect one embodiment of the use of touch data to determine boundaries as described above. In step 414 the heatmap is created.

The steps Acquire Infusion Map in step 416, Identify Local Minima in step 418 and Create Infusion Map Separation in step 420, reflect one embodiment of the use of infusion data to determine boundaries as described below.

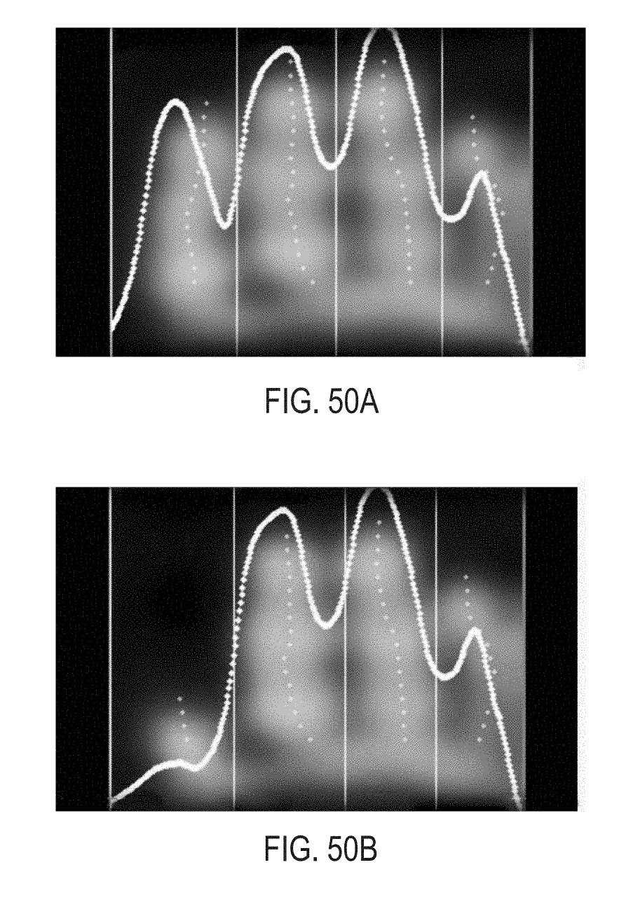

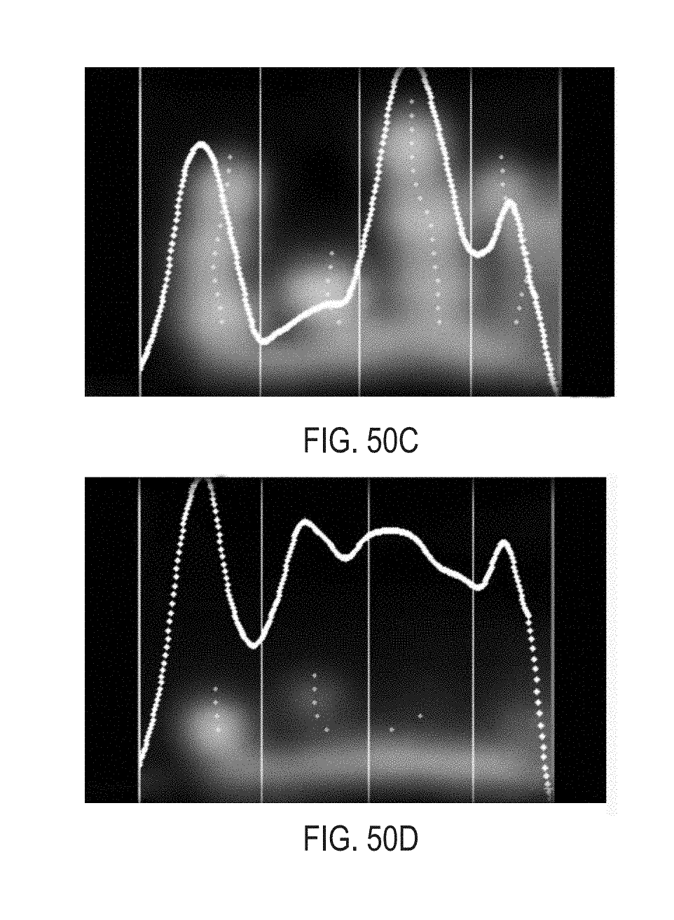

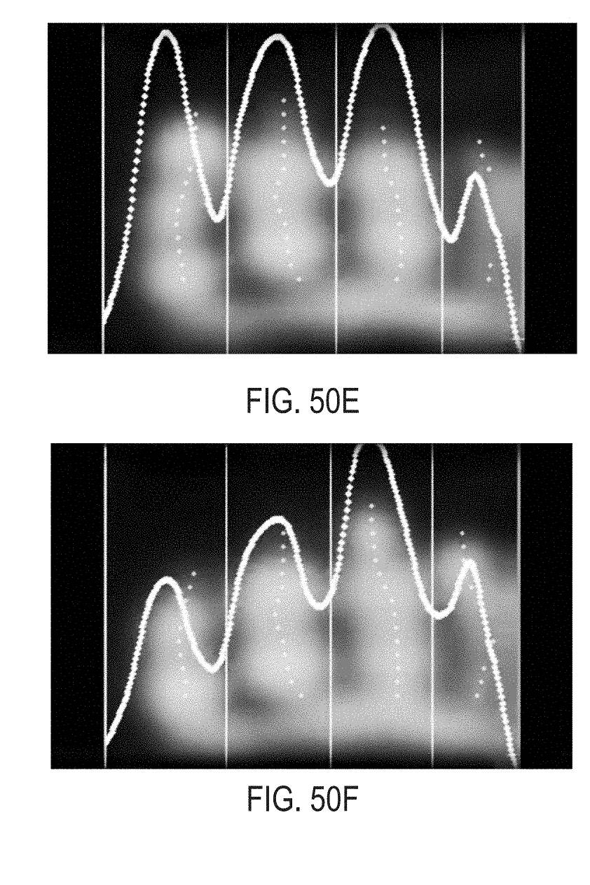

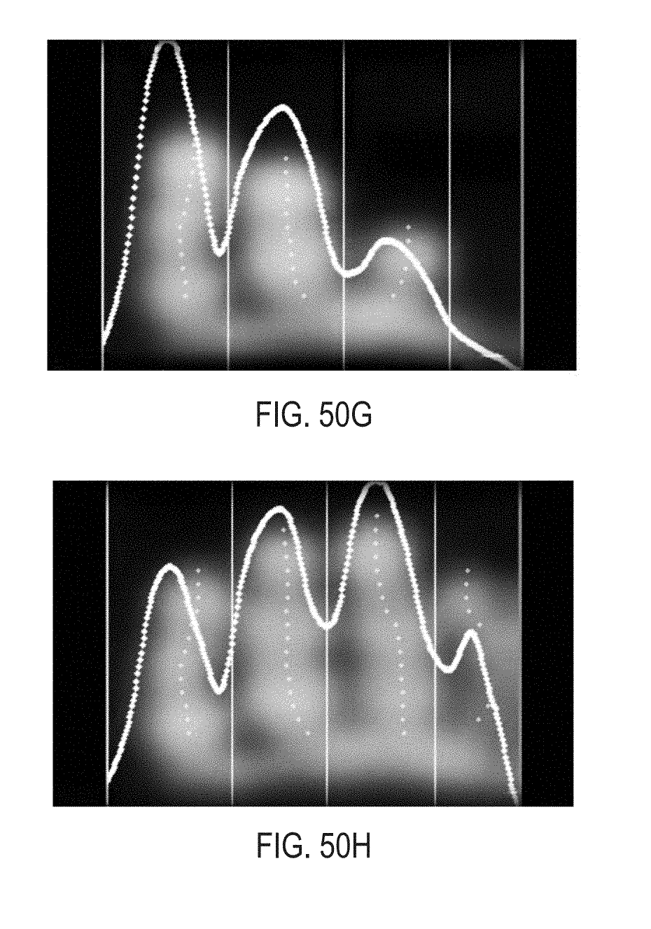

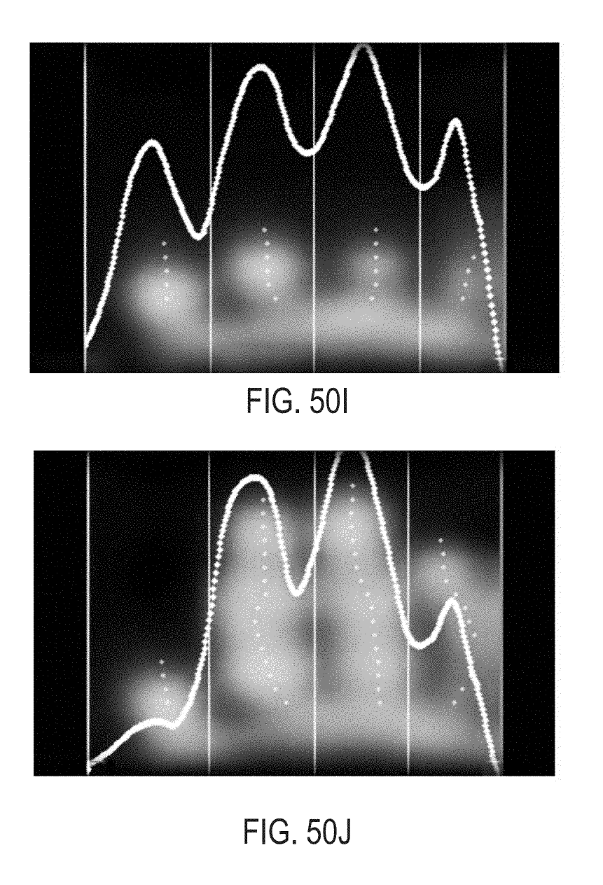

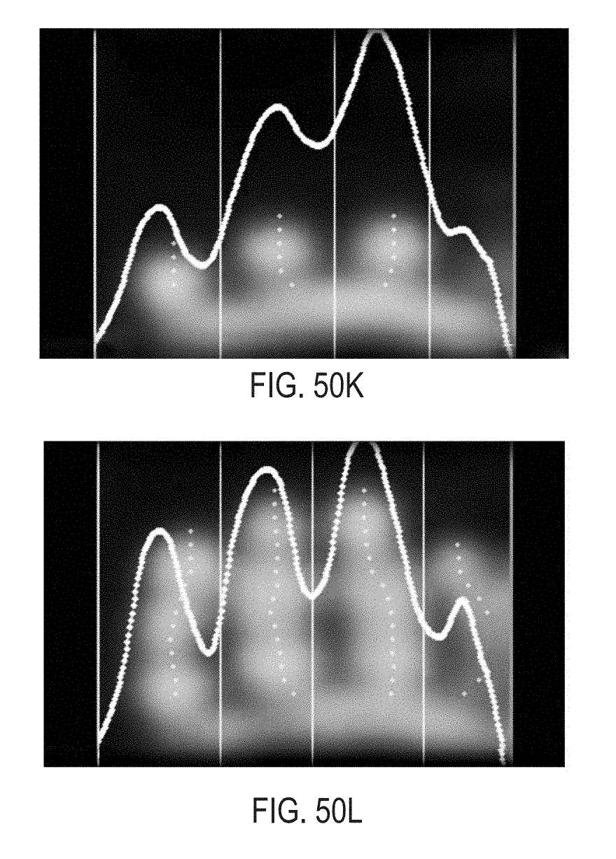

The separation of the heatmap into a plurality of areas representing the separate digits is referred to as finger or digit separation. See, for example, the step from FIG. 38, “Separate Fingers.” The Combine Separations in step 422, as discussed below, identifies boundaries based upon the results of the touch data process and the infusion data process. The Output Combined Separation in step 424 reflects the combined boundaries, as, for example, shown in FIGS. 50A-50L. As described elsewhere in the specification, once separation is determined and thus the motion of each finger can be understood separately, the steps of Calculate Finger Waveforms in step 426, Calculate Integral of Waveforms in step 428 and Process Motion in step 430 may also be performed. See, for example, the description of FIG. 38.

A generalized method of identifying where a finger begins and ends presents a significant challenge due to hand size and shape variation and the bunching of fingers, which can cause the finger boundaries to blend together in the heatmap. Three separation approaches are described below. The first approach analyzes the spatial distribution of inferred points in the touch data, the second approach identifies the local minima of an interpolated infusion signal, and the third approach combines the first and second. Note that the first two approaches are orthogonal and can be applied separately or combined.

For illustrative purposes, the general methods disclosed herein are discussed with respect to a handheld controller 25 such as the one shown in FIG. 22. It should be understood by a person of skill in the art in view of this disclosure that these methods are more generally applicable, and thus, for example, can be used to locate areas of interest (e.g., separate heatmap areas) in any skeletal or positional reconstruction, including any of the numerous hand-measurement applications. Thus, for example, the separation procedures disclosed herein, in addition to applying to a wide variety of handheld game controllers, may be useful for separating digits on other types of hand grips or gripped objects, such as those found on tennis racquets, golf clubs, ping-pong paddles, a wide variety of balls, steering wheels, joysticks, flight sticks, mouse controls, motorcycle and bicycle hand grips, and many others. Moreover, the procedures and apparatus can be applied to other postural and skeletal applications that are not directed only to hands. For example, the methods and apparatus disclosed herein can be used to separate arms or legs from other parts of the body in a bed or seat application. As another example, the methods and apparatus disclosed herein can be used to separate the toes. Also, for example, the methods and apparatus disclosed herein can be used to separate fingers on a touch-sensing keyboard.

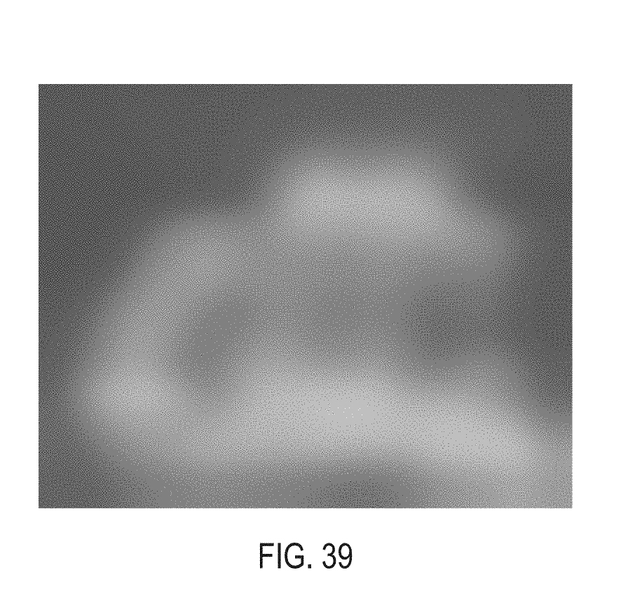

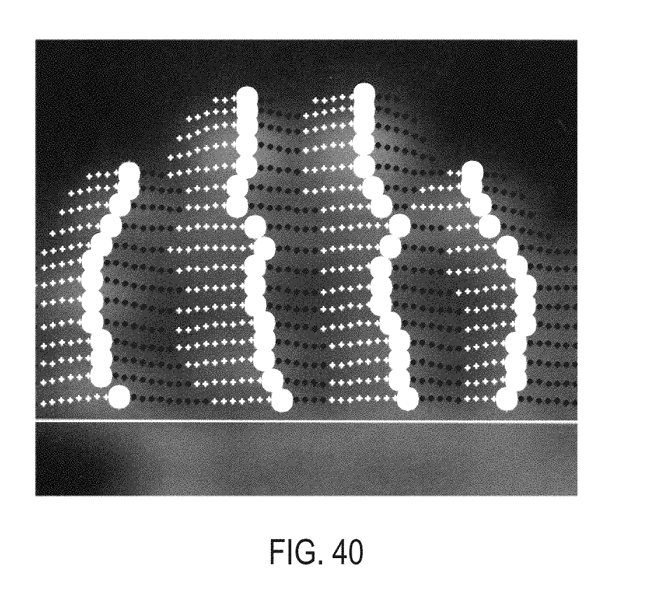

Turning to FIG. 39, an illustrative heatmap is shown, the heatmap reflecting data acquired when a hand is positioned on a handheld controller 25 such as the one illustrated in FIG. 22 is shown. The use of the following novel technique of determining finger separation based on heatmap data is generally limited to the condition where there is a presence of fingers. Such presence refers to a condition that the proximal phalanx is touching and/or detected by the controller 25. In the event that only the metacarpals are present—i.e., assuming that the proximal phalanges are not in touch with the controller 25, which could occur if fingers are all straightened on the controller shown in FIG. 22—the separation algorithms should not be applied. Presence of the proximal phalanx can be detected via the number of skeletal points, strength of injected signal, or by other features, all of which will be apparent to a person of skill in the art in view of this disclosure.

In an embodiment, the heatmap data represents the distance of the hand from the surface of the controller. In an embodiment, the heatmap data represents the pressure of the hand on the surface of the controller. In an embodiment, the heatmap data represents contact between the hand and the surface of the controller. In an embodiment, the heatmap reflects data that represents one or more aspects (e.g., distance/contact/pressure) of the body (e.g., entire body/hand/finger/foot/toe) position with respect to a sensor. The heatmap can be from any source, and need not to be a handheld controller. For example, the heatmap could be provided from a flat surface, or from any three-dimensional shape. For convenience of reference herein, the general direction of the fingers (or other part of interest) in the heatmap will be referred to herein as the vertical. The vertical direction corresponds to the manner in which the heatmaps are generally oriented in the Figures.

In a first step, inferred skeletal points are extracted via first derivative analysis. In this step, cross-sections of the heatmap are averaged column-by-column. Column averages above a threshold are identified as feature points. Local maximas within these feature points correlate with the finger bones and metacarpals. In an embodiment, the heatmap is segmented into horizontal strips, and each strip is processed to find local maxima. The size of each strip may depend on the resolution of the sensor and the size of the objects being detected. In an embodiment, an effective strip height of 10 pixels or less may be used for finger separation. In an embodiment, an effective strip height of 5 pixels may be used for finger separation. In an embodiment, the heatmap is upsampled, having the actual sensor lines 5 millimeters apart. In an embodiment, 10 pixels corresponds to approximately 3 mm; 5 pixels corresponds to approximately 1.5 mm. In an embodiment, an effective strip height of 3 pixels is used for finger separation. In an embodiment, the strips are processed with no overlapping data. In an embodiment, data is overlapped within the strips. Thus, for example, an effective strip height of 10 pixels may be used, but the strips may overlap by 5 pixels in each direction, thus every measurement is accounted for in two measurements. In an embodiment, strips may be of differing sizes. In an embodiment, strips may be of differing sizes with smaller sizing used where more resolution is desired. FIG. 40 shows the results of identifying the local maxima as discussed above. Dots are visually superimposed over the heatmap in FIG. 40, with small crosses dots reflecting upward changes, black crosses reflecting downward changes, and large filled dots representing local maxima.

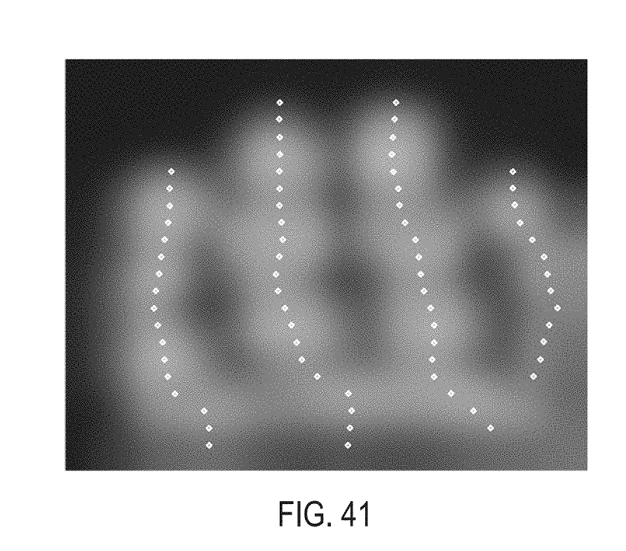

FIG. 41 reflects the same information, with the white crosses and black crosses removed, and the large filled dots resized. Finger data will be apparent in FIGS. 39, 40, and 41 to a person of skill in the art in view of this disclosure. It will also be apparent to a person of skill in the art that some palm data is present in addition to the finger data. For useful finger separation, palm data must be removed.

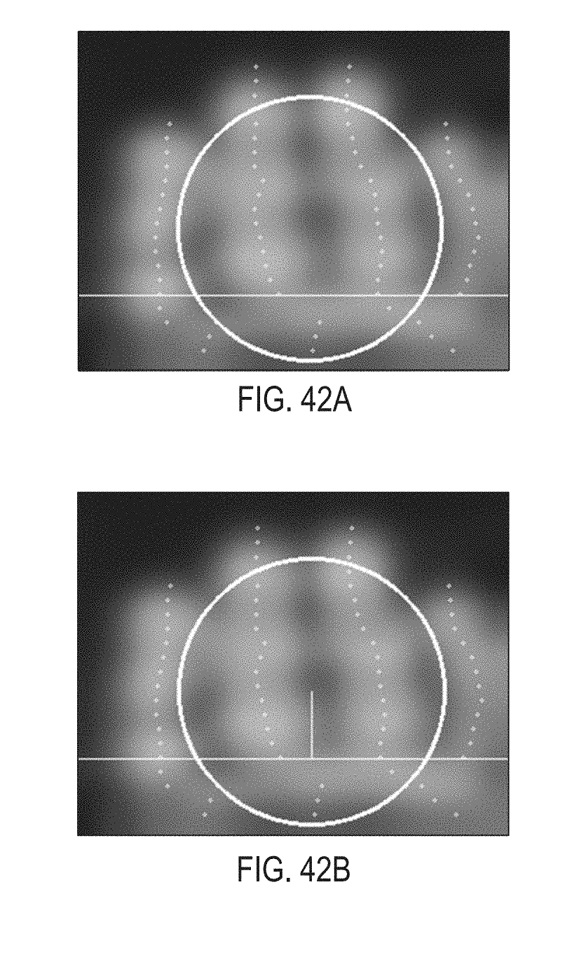

With reference to FIGS. 42A and 42B, in an embodiment, the palm data is removed using a circle fit. A circle fit defines the circle that best represents all of the local maxima. Stated differently, the circle fit minimizes the sum of the squared radial deviations. In an embodiment, given a set of measured (x,y) pairs that are supposed to reside on a circle but with some added noise, a circle is calculated to these points, i.e., find xc,yc,R, such that (x−xc)“2+(y−yc)”2=R″2. In an embodiment, a Taubin method circle fit can be used. Once the circle fit is determined, it may be used to reject or ignore information in the heatmap, for example, palm information. In an embodiment, the local maxima points are rejected if they fall below a horizontal line half of the radius below the circle center, as determined by the circle fit (see FIGS. 42A 42B). It is not required to use a circle fit to represent the local maxima, however, the circle fit provides an adequate reflection of the local maxima data to reject portions of the heat map, such as the palm, in connection with the controller 25 of FIG. 22 and data acquired therefrom. Similarly, while the illustrated controller 25 provides sufficient information to be able to ignore or reject the information below half the radius from the circle center, this is also more generally related to the geometry of the problem to be solved. For example, where arms are being separated from a body on a car seat or a bed, an ellipse fit function may be more appropriate. Similarly, where a handheld controller positions the palm using mechanical means, rejecting or ignoring portions of the heat map may be accomplished by correlating a known position of the palm with the received sensor data.

The circle fitting can also be used to measure the width or breadth of the palm. If the horizontal line that is half the radius below the circle center on the heatmap determines the boundary between the palm and the fingers, then the width or breadth of the palm can be measured by finding the leftmost and rightmost contours in the heatmap, finding the leftmost and rightmost positions in the contour (respectively), and subtracting the difference between the two positions. In instances where the hand may be too large to create a contour on the left, an approximation of the breadth of the palm may be measured by subtracting the maximum width of the heatmap from the rightmost position in the right contour. In instances where the hand may be too large to create a contour on the right, an approximation of the breadth of the palm may be measured by subtracting the leftmost position in the left contour from the minimum width of the heatmap. It will be apparent to those skilled in the art that a variety of methods can be used to find the contours of the palm.

In an embodiment, using the hand controller 25 shown in FIG. 22, it has been discovered that people with different sized and shaped hands naturally position their hands differently on the controller. Thus, for example, the palm of a smaller hand tends to be further “forward” on the controller, and thus, further up on the heatmap in the orientation shown. For this type of application, it has been generally shown that the combination of a circle fit, and the rejection or ignoring of the local maxima on the heatmap below half of the radius from the circle center is appropriate to reject or ignore the palm data. It will be apparent to a person of skill in the art in view of this disclosure how to apply different functions and constants to reject unwanted maxima in other contexts.

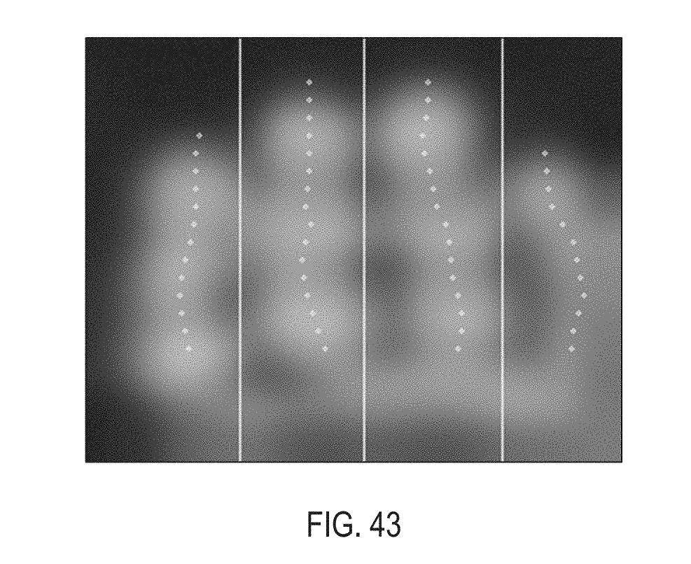

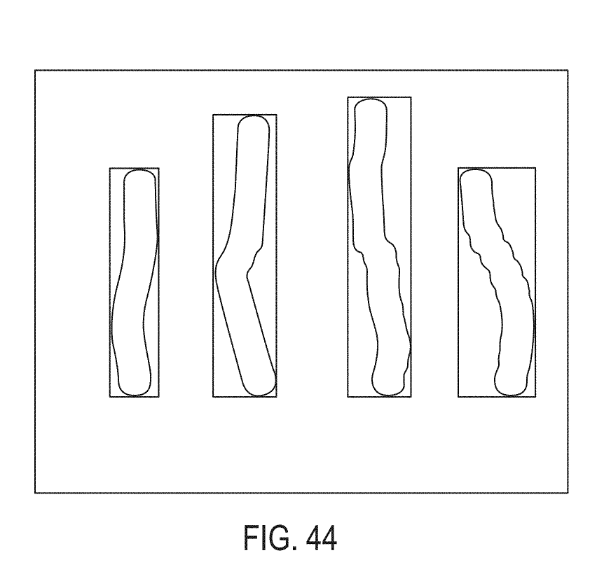

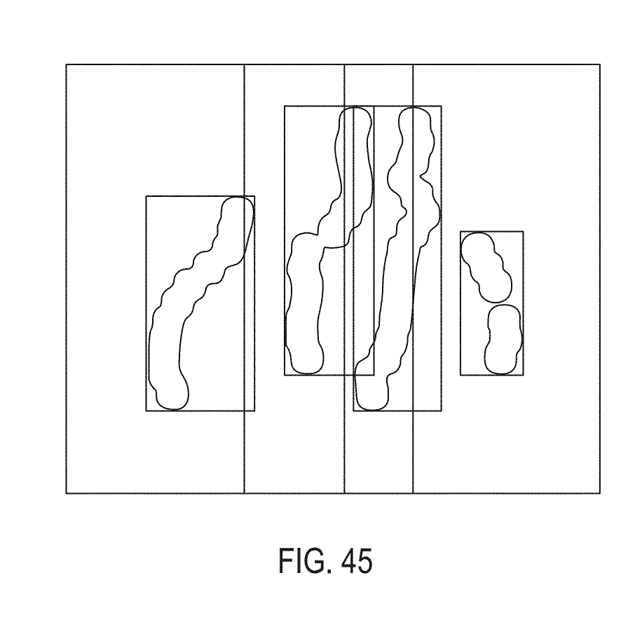

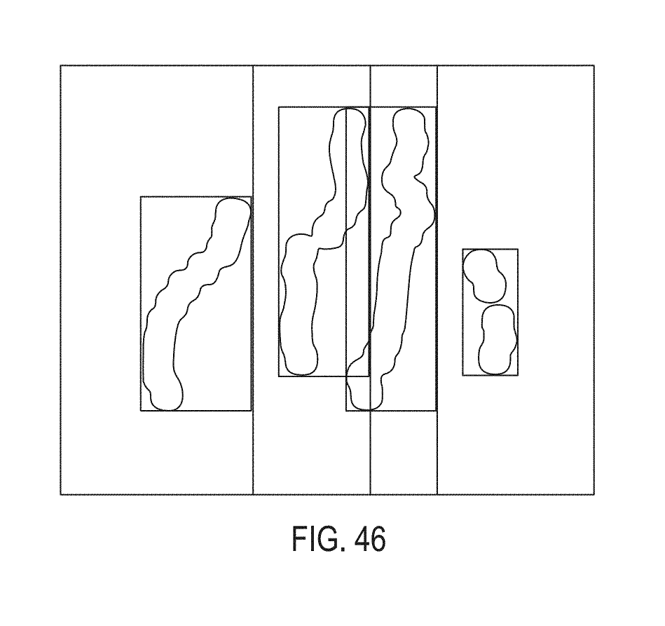

With the superfluous data (e.g., palm data) removed, an initial determination of the boundaries (i.e., the finger separation) may be made. In an embodiment, the set of all maxima points are averaged to produce a centroid, and the centroid is used to define the boundary between the middle and ring finger. In an embodiment, points to the left or right of the centroid are sorted and averaged within their respective regions (FIG. 43). This left/right half averaging produces the index-middle boundary and ring-pinky boundary. Thus, in an embodiment, an average of the X position of every non-rejected maxima is used to determine a center line, thus separating the index and middle finger from the ring finger and pinky finger. An average X position of every non-rejected maxima in each half can then be used to separate the index finger from the middle finger, and the ring finger from the pinky. FIG. 43 illustrates a finger separation as so described. In an embodiment, other methods of segmentation can be used, including when fewer than all of the fingers are present. For example, where three fingers are represented, trisection is possible. If two fingers are represented, only the first bi-section is needed. If there is only one-digit present, finger separation is not required.

While these boundaries may present a sufficient separation, variations in hand size and shape have shown that further processing may provide better separation, especially with the illustrative controller and smaller hand sizes. In smaller hand sizes, some fingers appear less straight (i.e., more curled) on the heatmap. In an embodiment, the local maxima are processed to determine whether the identified boundaries require adjustment. In an embodiment, the maxima are inflated and circumscribed by a bounding box, and the bounding boxes are compared with the other bounding boxes and the initially identified boundaries. Turning to FIG. 44, maxima related to touch have been inflated horizontally for illustration. The inflated maxima create an inferred finger contour. FIG. 44 also illustrates a bounding box around each of the inferred finger contours. There is no overlap between the bounding boxes shown in FIG. 44. Moreover, as the boundaries shown in FIG. 44 do not intersect the bounding boxes shown in FIG. 44, no adjustment to the boundaries is required.

Turning to FIG. 45, an inferred finger contour and the initially determined boundaries are shown for a different hand. The FIG. 45 data results in two issues, first, the bound boxes overlap, and second, the boundary lines intersect the bounding boxes. In an embodiment, the right side of the respective bounding boxes is used as the boundary as shown in FIG. 44. In an embodiment, where two bounding boxes overlap, a weighted computation may be made with respect to the overlapping regions of the bounding boxes, and the boundary shifted to a location within each box, but at a position that is dictated by the contribution of each finger contour to the overlap. In an embodiment, when a boundary line is within a bounding box, but the bounding box does not overlap with its neighbor, the line (instead of being moved to the right edge of the box) is adjusted to a point between the two non-overlapping bounding boxes. In an embodiment, when a boundary line is within a bounding box, but the bounding box does not overlap with its neighbor, the boundary line is adjusted to a point between the two non-overlapping bounding boxes, but weighted to be closer to the larger bounding box.

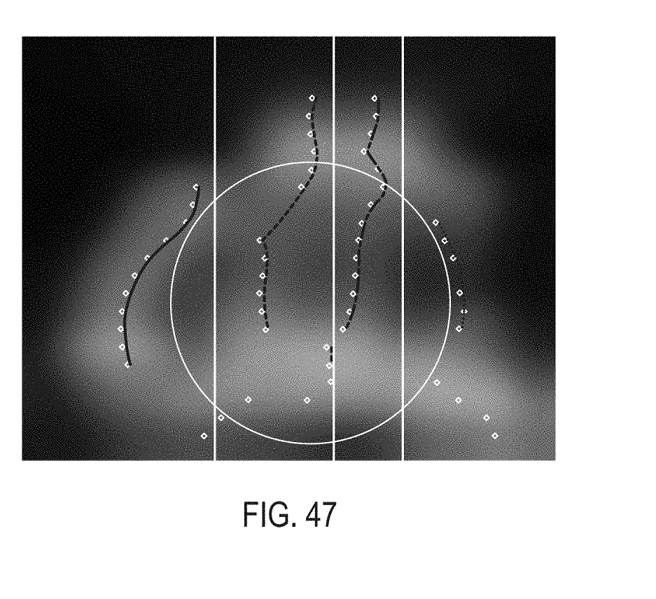

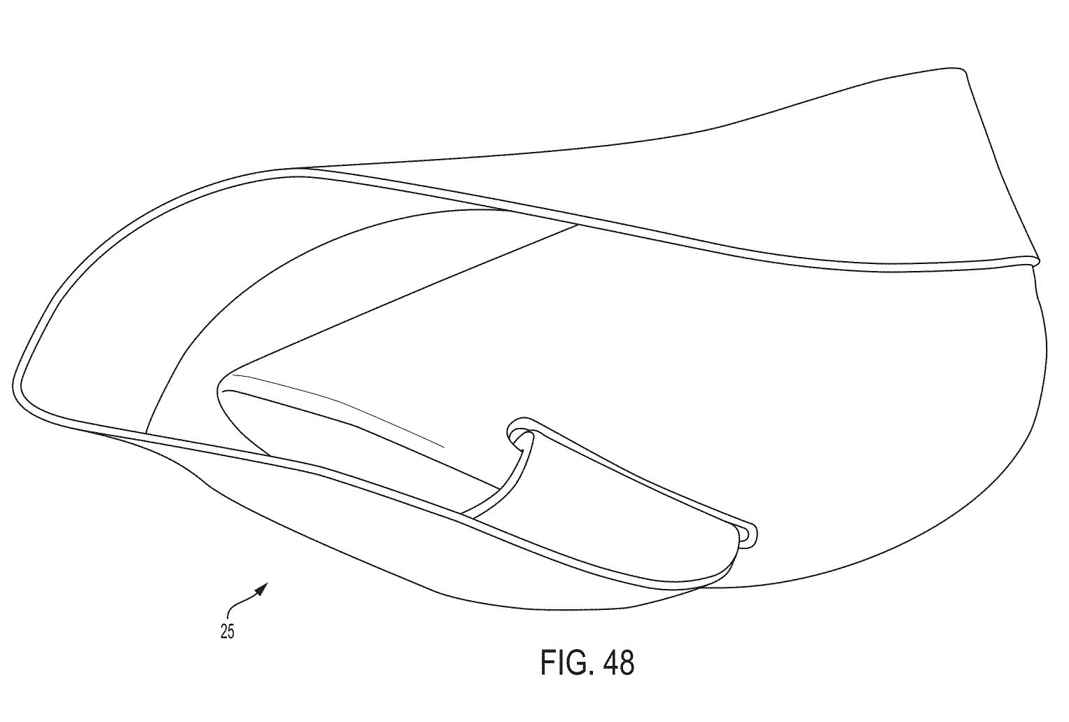

Because the overlap of bounding boxes and determined boundaries arises from the acquired data (and thus ostensibly from the actual hand position and controller geometry), the boundaries not unambiguously determine the entire position of every finger. Turning briefly to FIG. 46, an illustration is shown where boundaries are shifted to the right side of the bounding boxes as described in connection with FIG. 45. Lines are used to connect relevant (i.e., unrejected or unignored maxima) as defined by the boundaries. The small error component can be seen to occur quite close to the palm. Notably, the error position which is proximal to the palm is an unlikely location for the first movement of a finger. Despite the small error, the technique has been found to be a substantial and quick means of assessing boundaries. In an embodiment, additional boundary processing may be employed to resolve such errors, but the resulting boundary may not result in straight lines, as in FIG. 47.

The width and length of each finger can also be measured using each finger's bounding box. To determine the width or thickness of each finger, the rightmost X-coordinate boundary of the finger's bounding box is subtracted from the leftmost X-coordinate boundary of the finger's bounding box. To determine the length of each finger, the bottommost Y-coordinate boundary of the finger's bounding box is subtracted from the topmost Y-coordinate boundary of the finger's bounding box.

The position of each finger joint and thickness of each finger joint can also be measured using each finger's bounding box and the local maxima for each finger. Dividing the length of the finger (as computed as detailed above), by three will give an approximation of the Y-position of each joint location. Using the Y-coordinate, one skilled in the art can use interpolation techniques to find the nearest X-coordinate position for each joint. Once these positions are known, the thickness of each joint can be determined by subtracting the rightmost X-coordinate boundary of the finger's bounding box at that Y-coordinate from the leftmost X-coordinate boundary of the finger's bounding box at that Y-coordinate.

The abduction of the fingers can also be determined using the bounding boxes of two fingers. When the right hand is grasping the controller, to determine the distance between the index finger and the middle finger, the leftmost X-coordinate in the middle finger's bounding box is subtracted from the rightmost X-coordinate in the index finger's bounding box. When the right hand is grasping the controller, to determine the distance between the middle finger and the ring finger, the leftmost X-coordinate in the ring finger's bounding box is subtracted from the rightmost X-coordinate in the middle finger's bounding box. When the right hand is grasping the controller, to determine the distance between the ring finger and the pinkie finger, the leftmost X-coordinate in the pinkie finger's bounding box is subtracted from the rightmost X-coordinate in the ring finger's bounding box. When the left hand is grasping the controller, to determine the distance between the index finger and the middle finger, the leftmost X-coordinate in the index finger's bounding box is subtracted from the rightmost X-coordinate in the middle finger's bounding box. When the right hand is grasping the controller, to determine the distance between the middle finger and the ring finger, the leftmost X-coordinate in the middle finger's bounding box is subtracted from the rightmost X-coordinate in the ring finger's bounding box. When the right hand is grasping the controller, to determine the distance between the ring finger and the pinkie finger, the leftmost X-coordinate in the ring finger's bounding box is subtracted from the rightmost X-coordinate in the pinkie finger's bounding box.

If two fingers are crossing each other while holding a controller, these finger postures can also be measured using the bounding boxes and local maxima. If only three bounding boxes are computed using the method described previously, the width of each bounding box can be computed. The bounding box with the largest width will have the two crossing fingers.

FIG. 48 shows an embodiment of a handheld controller 25 having a strap, with the strap and other concealing material removed to show a signal infusion area. In an embodiment, the infuser area is located under the controller strap to aid in contact between the hand and the infuser area. In an embodiment, an infusion signal transmitted to the infusion area is conducted by a hand holding the controller 25, and received by the receivers in the controller 25. In an embodiment, the receivers in a controller 25 are oriented to be generally parallel with the direction of the fingers, see, e.g., the horizontal conductors shown in FIGS. 26, 27, and 29.

In an embodiment, each receive line is examined to determine a magnitude of the infusion signal present thereon. In an embodiment, one magnitude is determined for each receiver. In an embodiment, additional values are determined by interpolation. In an embodiment, additional values are interpolated by Hermite interpolation.

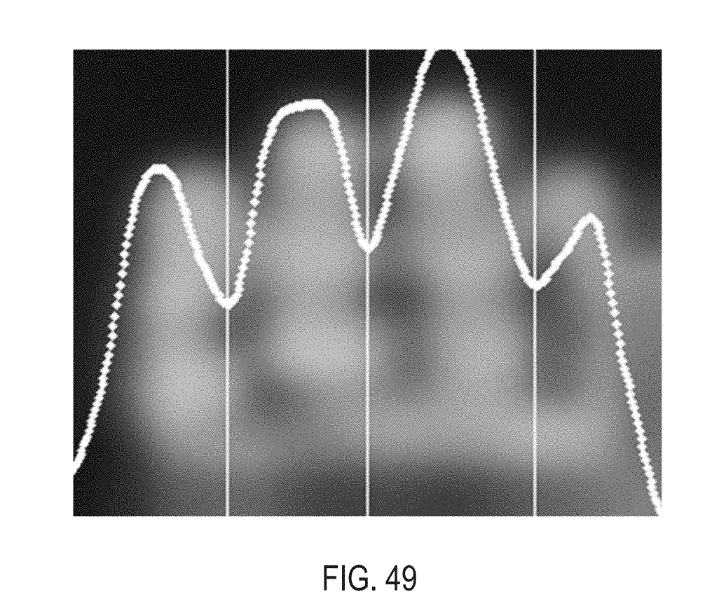

A first derivative analysis is performed on the set of values (i.e., magnitudes, with or without additional interpolated values). Through the first derivative analysis, local minimas are identified as finger boundaries as determined from infusion data. FIG. 49 reflects finger boundaries as determined by infusion data.

As discussed above, in an embodiment, the infusion data and the touch data boundaries may be combined. In an embodiment, the infusion data and the touch data are averaged together. In an embodiment, the infusion data and the touch data are combined through a weighted average. In an embodiment, touch data is weighted based on the total number of maxima present.

In an embodiment, finger boundaries are calculated once in a calibration phase. In an embodiment, finger boundaries are recalculated periodically or upon the happening of an event. In an embodiment, finger boundaries are recalculated when a threshold input is reached, for example, changing from below a threshold number of local maxima in the touch data to more than the threshold number of local maxima. In an embodiment, the threshold number is 20. In an embodiment, the threshold number is between 20 and 30. In an embodiment, the threshold number is 30 or more.

FIGS. 50A through 50L illustrate data acquired in sequence from a handheld controller (white ghosting), calculated local maxima (hollow diamonds) according to an embodiment of the present invention, interpolated infusion data (solid diamonds) according to an embodiment of the present invention, and boundaries determined based on the acquired data. As FIGS. 50A through 50L are reviewed, it is important to note that the boundaries varied between each based upon determinations made according various embodiments of the present invention as disclosed herein. In FIG. 50A, all four fingers appear to be in good contact with the controller and the boundaries between the maxima lines appears complete and accurate. In FIG. 50B, it appears that there is substantially less contact by the index finger. In FIG. 50C, it appears that the middle finger is straightened and the index finger is back in contact with the controller. FIG. 50D may reflect a substantial or complete straightening of all four fingers, which, in an embodiment would make the touch data reliability questionable. FIG. 50E may reflect that all four fingers are back in contact with the touch controller. FIG. 50F similarly appears to reflect substantial contact from all four fingers. In FIG. 50G, it can be inferred that at least the pinky and a substantial part of the ring finger is not in contact with the controller. FIG. 50H again may reflect that all four fingers are back in contact with the touch controller. Likewise, FIG. 50I may again reflect a substantial or complete straightening of all four fingers. FIG. 50J again shows a lack of substantial contact by the index finger. FIG. 50K may yet again reflect a substantial or complete straightening of all four fingers. FIG. 50L may again reflect good contact by all four fingers.

### Thumb Sensing

In an embodiment, an additional step that may be performed to towards reconstructing a hand skeleton and movement is to sense the thumb presence, location, and distance of the thumb on, or above the thumb portion of a controller. Thus, in addition to the reconstruction of separate finger locations (i.e., areas) and finger movement (e.g., while grasping a handheld controller) additional steps may be taken to determine the presence, location, distance, and movement of the thumb on, or above the thumb portion of a controller before the hand skeleton model is created. A generalized method of identifying the presence, location, distance, and movement of the thumb presents a significant challenge due to the variety of thumb sizes, shape variations, and hand postures that are possible and can thus require one skilled in the art to combine, fuse, or consult data from the finger heatmap and/or thumb heatmap. Three approaches are described below. The first approach analyzes the spatial distribution of inferred points in the touch data, the second approach identifies the local minima of interpolated infusion signals, and the third approach combines the first and second. Note that the first two approaches are orthogonal and can be applied separately or combined.

For illustrative purposes, the general methods disclosed herein are discussed with respect to a handheld controller 25 such as the one shown in FIG. 22. It should be understood by a person of skill in the art in view of this disclosure that these methods are more generally applicable, and thus, for example, can be used to locate areas of interest (e.g., separate heatmap areas) in any skeletal or positional reconstruction, including any of the numerous hand-measurement applications. Thus, for example, the separation procedures disclosed herein, in addition to applying to a wide variety of handheld game controllers, may be useful for identifying the presence, location, and distance of the thumb with relation to other types of hand grips or gripped objects, such as those found on tennis racquets, golf clubs, ping-pong paddles, a wide variety of balls, steering wheels, joysticks, flight sticks, mouse controls, motorcycle and bicycle hand grips, and many others.

In an embodiment, a heatmap reflecting data is acquired when a thumb is positioned on a handheld controller 25 such as the one illustrated in FIG. 22 is shown. In an embodiment, the heatmap data represents the distance of the thumb from the surface of the controller. In an embodiment, the heatmap data represents the pressure of the thumb on the surface of the controller. In an embodiment, the heatmap data represents contact between the thumb and the surface of the controller. The heatmap can be from any source, and need not to be a handheld controller. For example, the heatmap could be provided from a flat surface, or from any three-dimensional shape.

In a first step, inferred skeletal points of the thumb are extracted via first derivative analysis. In this step, cross-sections of the heatmap are averaged column-by-column. Column averages above a threshold are identified as feature points. In an embodiment, the heatmap is segmented into horizontal strips, and each strip is processed to find local maxima. The size of each strip may depend on the resolution of the sensor and the size of the objects being detected. In an embodiment, an effective strip height of 10 pixels or less may be used to detect the thumb. In an embodiment, an effective strip height of 5 pixels may be used to detect the thumb. In an embodiment, the heatmap is upsampled, having the actual sensor lines 5 millimeters apart. In an embodiment, 10 pixels corresponds to approximately 3 mm; 5 pixels corresponds to approximately 1.5 mm. In an embodiment, an effective strip height of 3 pixels is used to detect the thumb. In an embodiment, the strips are processed with no overlapping data. In an embodiment, data is overlapped within the strips. Thus, for example, an effective strip height of 10 pixels may be used, but the strips may overlap by 5 pixels in each direction, thus every measurement is accounted for in two measurements. In an embodiment, strips may be of differing sizes. In an embodiment, strips may be of differing sizes with smaller sizing used where more resolution is desired.

In an embodiment, if one local maxima if found within these feature points for each row, this local maxima indicates that a thumb is on or above the surface of the thumb sensor. If multiple local maxima are found for each row, noise is being detected, and thus no thumb is present on or above the sensor. When noise is detected, it is possible that the thumb is located on the body of the controller, not the thumb sensor. In this situation, the heatmap generated by the sensor manifold wrapped around the controller body will have an additional set of local maxima that can be segmented using the process described here to determine the location and distance the thumb is from the body of the controller.

In an embodiment, an ellipse can then be fit to the local maxima using a process similar to the circle fit described herein. The centroid of the ellipse thus represents the X-Y position of the thumb as it is on or above the thumb sensor.

Once the X-Y position of the thumb is known, the data from the FMT sensor manifold can be used to determine the flexion and extension of the thumb above the surface of the thumb sensor. To do so, the strength of the signal magnitudes from each receiver on the last three rows of the receive lines are analyzed. Those columns with the highest magnitudes are combined and this value is mapped to the magnitude of the thumb flexion or extension via a predetermined distance function (which may come from a calibration step as detailed below.

Further to finding the flexion and extension of the thumb, in another embodiment, the left and right movement of the thumb in the air above thumb sensor may be determined via the signal injection spots. At least three signal injection antenna (spot) may be used to derive the left and right movement of the thumb in the air above the thumb sensor (see e.g. FIGS. 32A-32D). At least four signal injection antenna (spot) may be used to derive the left and right movement of the thumb in the air above the thumb sensor. More than four signal injection antenna (spot) may be used to derive the left and right movement of the thumb in the air above the thumb sensor. Each injection antenna (spot) is examined to determine a magnitude of the infusion signal present thereon. In an embodiment, each magnitude is linearized and an integration function is applied to normalize the data. Triangulation techniques are used to determine left/right movement of the thumb above the thumb sensor space. One skilled in the art will be able a variety of methods to triangulate the data from the injection antenna to determine the left/right movement of the thumb above the sensor space, in addition to the forward/backward movement of thumb above the sensor space.

In an embodiment, using the hand controller 25 shown in FIG. 22, it has also been discovered that the thumb may exhibit a hooked posture, wherein only the tip of the thumb is touching the thumb sensor (with the remaining joints held in the air). For this type of application, it has been generally shown that using the local maxima from the thumb sensor's heatmap and the injection data that is obtained from the antennas is appropriate to detect such a thumb posture and the distance, forward/backward movement, up/down movement, and left/right movement such a posture is from the surface of the thumb sensor. It will be apparent to a person of skill in the art in view of this disclosure how to apply different functions and constants to detect the hooked thumb posture in other contexts.

As discussed above, in an embodiment, the infusion data and the touch data boundaries may be combined. In an embodiment, the infusion data and the touch data are averaged together. In an embodiment, the infusion data and the touch data are combined through a weighted average. In an embodiment, touch data is weighted based on the total number of maxima present.

In an embodiment, a calibration procedure or phase may be used to improve the sensing and identification techniques on the thumb sensor. In an embodiment, a user may be asked to hold the controller and perform a number of finger and hand postures. The sensor data that results from these hand postures (e.g., opening the hand, closing the hand, extending the thumb, retracting the thumb, and so on), can be combined with a power function to determine the minimum sensor threshold values and maximum sensor threshold values. These values can then be used to normalize and linearize the heat map values described herein to obtain the distance of the thumb above the thumb sensor. In an embodiment, a calibration procedure may be performed once. In an embodiment a calibration procedure may be performed multiple times. In an embodiment, a calibration procedure may not be performed.

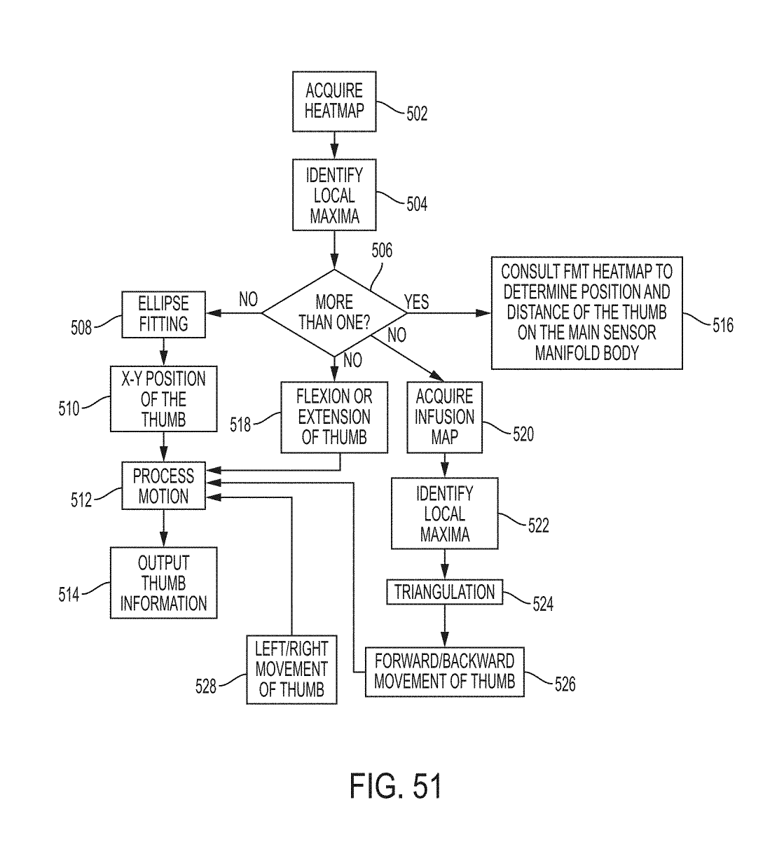

FIG. 51 contains a flowchart showing implementation of one embodiment of the present invention to detect the thumb. The Acquire Heatmap step 502, the Identify Local Maxima step 504, and Ellipse Fitting step 508 reflect one embodiment of the use of touch data to determine the position and distance of the thumb from the thumb sensor as described above.

In step 506, after step 504 of identifying local maxima, the number of local maxima are determined. If not, in step 508 the ellipse fitting 508 occurs. In step 510, the X-Y position of the thumb is determined. In step 518, the flexion or extension of the thumb is determined after step 506. In step 526, the forward/backward movement of thumb is determined. In step 528, the left/right movement of thumb is determined. In step 512, the motion is processed. In step 514, the thumb information is output.

The Acquire Infusion Map in step 520, Identify Local Maxima in step 522, Triangulation in step 524 reflect one embodiment of the use of infusion data to determine the position and distance of the thumb from the thumb sensor as described above. This determination of the forward/backward movement of the thumb occurs in step 526.

In step 516, a FMT heatmap is consulted to determine portion and distance of the thumb on the main sensor of a manifold body. This occurs when more than one local maxima are identified in step 506. As described elsewhere in the specification, once the presence, position, and movement of the thumb is determined, the Process Motion in step 512 and Output Thumb Information in step 514 may be performed.

### Hand Skeleton Modelling

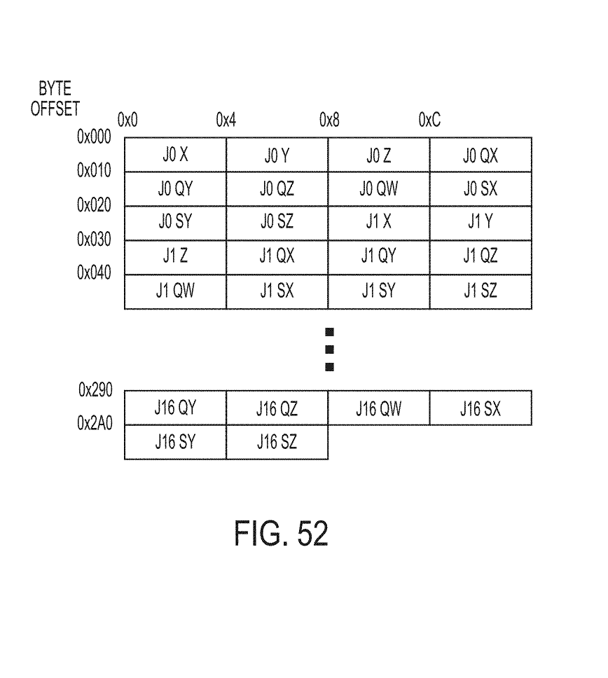

In an embodiment, hand skeleton data is stored in packed 32-bit float arrays, with each bone being treated as a 10-tuple of a (x, y, z) position vector with all quantities in metres, a (qx, qy, qz, qw) rotation quaternion, and a (sx, sy, sz) scale vector, with each tuple being treated as a local transformation with respect to its parent (i.e., translation done in local axes, taking into account any rotation done by its ancestors). It will be apparent to one of skill in the art that many other data structures could be used to represent the hand, especially in view of the sensitivity, capabilities and degrees of freedom permitted by the controller. Accordingly, FIG. 52 is an embodiment of a table of the representation of skeleton data described above. The table in FIG. 52 represents one embodiment of the table as it exists in the memory of a computing device. The name of each bone in the hand in FIG. 52 corresponds with the names of each bone in the hand in FIG. 33.

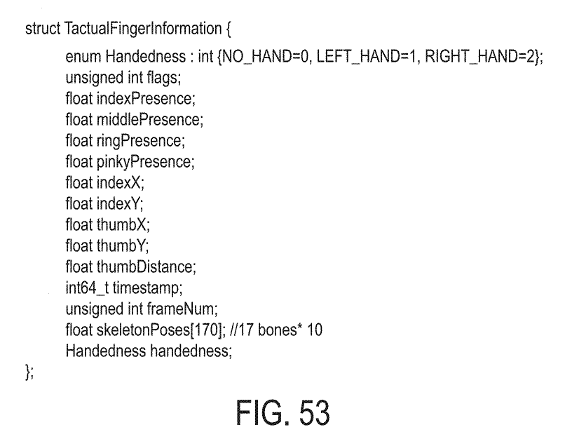

FIG. 53 shows an embodiment of a data structure that can be used to represent a user's finger information while they are holding a device containing a heterogeneous sensor. In accordance with an embodiment, the data structure may represent a variety of information concerning the position and orientation of the user's fingers and/or hand. In an embodiment, the data structure represents user's finger information using the following: flags is a bitset; indexPresence, middlePresence, ringPresence, and pinkyPresence each represent values indicative of the presence of a finger near the device—in an embodiment, the values are normalized floats between 0 and 1, where a value of 0 represents the finger being fully extended away from the device, and a value of 1 represents the finger being fully contracted and touching the device; thumbX and thumbY represent a position on a thumbpad if the embodiment has a thumbpad. If the embodiment doesn't have a thumbpad, thumbX and thumbY represent the position of the thumb in a dedicated thumb area. In an embodiment thumbX and thumbY are Cartesians where an x value of −0.5 is at the very left of the thumb area and a value of 0.5 is at the very right of the thumb area; similarly, a y value of −0.5 is at the bottom of the thumb area, and a value of 0.5 is at the top of the thumb area; thumbDistance represents the distance from the device—in an embodiment, a value of 0 indicates contact with the device, a value of 1 indicates that the thumb is not near the device, and a value between 0 and 1 indicates that the thumb is hovering some distance away from the device; frameNum is an indicator of when this data was relevant, for recorded data sessions, this may represent position within a set of recorded frames, and for live stream sessions, this may represent an increasing number for each sensor frame received; skeletonPoses representing the position and rotation of each bone in the hand skeleton—in an embodiment, is an array of floats where each bone is given as an 10-tuple of floats representing an (x,y,z) position vector, (qx,qy,qz,qw) rotation quaternion, and (sx,sy,sz) scale vector; handedness represents which hand is currently holding the device—in an embodiment, handedness has an integer value between 0-2, where 0 represents no hands holding the device, 1 represents the left hand holding the device, and 2 represents the right hand holding the device.

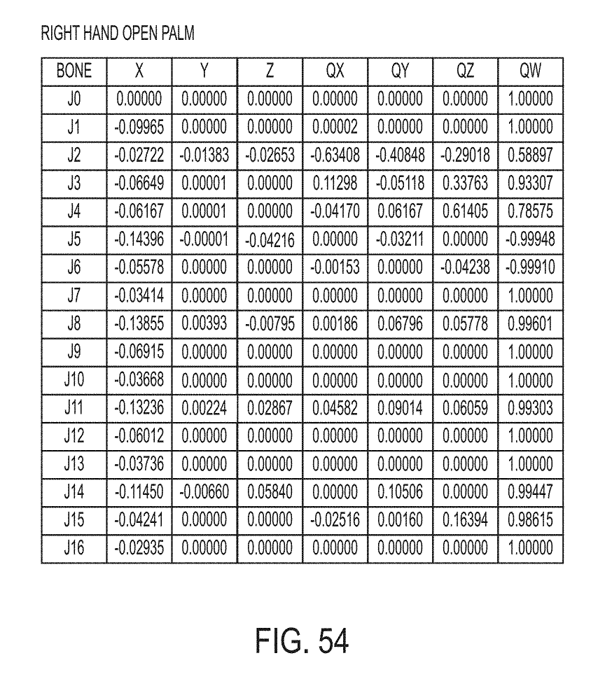

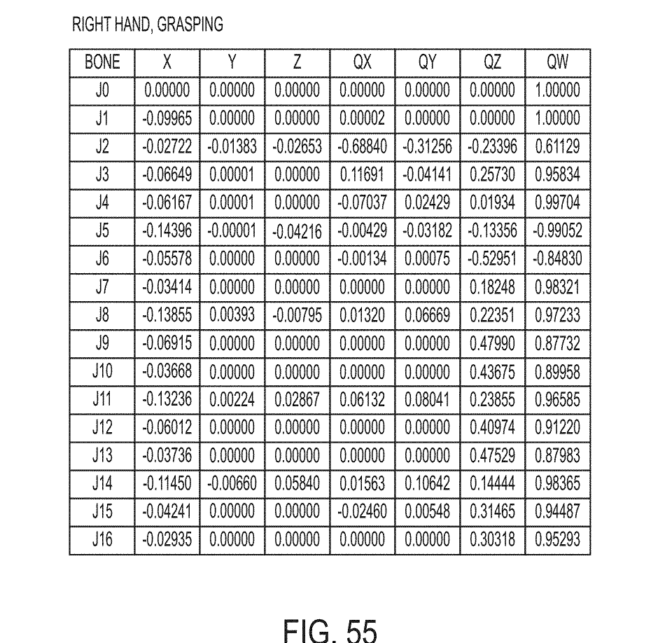

FIGS. 54 and 55 are tables reflecting an embodiment of skeletonPoses for an exemplary right hand, FIG. 54 having an open palm, and FIG. 55, grasping. Each bone is reflected on a separate row, and the ten tuple represents an x,y,z position vector, a qx, qy, qz, qw rotation quaternion, and an sx, sy, sz scale vector. Positions (x,y,z) are in meters. The axes for each bone takes into account any rotation done by any of the bone's ancestors (refer to FIG. 33 for a depiction of each bone's position on a human hand and their hierarchy). Translation and rotation are relative to a bone's parent. Exemplary quantities are shown only to five decimal places.

In an embodiment, information acquired from one or more sensor patterns on a device can provide the basis for providing a model of the user's fingers, hands and wrists in 3-D with low latency. The low latency delivery of skeletal models may permit VR/AR system to provide real-time renditions of the user's hand. Moreover, the skeletal data presented herein allows application and operating system software to have information from which not only hover, contact, grip, pressure and gesture on a touch-sensitive object can be identified, but it further provides the hand position and orientation, finger abduction, joint thickness, palm breadth, crossed fingers, crossed finger hover, and finger thickness, from which gestural intent may be more easily derived.

In an embodiment, a calibration step may be performed, and subsequent measurements are interpreted given the information in the calibration step.

In an embodiment, the calibration step may include moving the fingers to specified positions while the contributions of the injected signals are measured.

In an embodiment, the calibration step may include performing a gesture or set of gestures with the fingers while the contributions of the injected signals are measured.

### Body Skeletal Modeling

In an embodiment, data from a surface manifold (e.g., a manifold having a capacitive sensor or heterogeneous sensor) and a constrained model with limited degrees of freedom can be used to infer skeletal positioning. In an embodiment, using frequency injection descriptors, predefined profiles of signal strengths corresponding to a set of discrete positions of the skeleton (e.g., hand or spine) can be created or recorded. In an embodiment, descriptors are combined with baseline and noise reduction techniques or other multi-dimensional analysis technique to extract meaningful information from these descriptors that can correlate to the skeletal motion.

[2] In an embodiment, fast multi-touch heatmap processing techniques may be used in addition to frequency strength signals. In an embodiment, hand tracking may be computed using a hierarchical skeleton-based description of a virtual hand to describe the real hand. In an embodiment, techniques can be applied to map the frequency injection descriptors into a continuous real-time animation of that skeleton mimicking the real hand motion. In an embodiment, mapping methods can rely on linear or nonlinear functions used in real time translating the signal feed into a feed of finger angles. In an embodiment, mapping methods can employ any correlation properties existing between signal strength samples and a ground truth reference captured using other techniques such as motion capture, other vision-based processing techniques, or predefined captured poses. In an embodiment, manual or automatic, supervised or unsupervised training, data mining, classification, MIMO-like techniques (such as principal component analysis) or regression techniques can be used to identify the adequate definition of these mapping functions priorly exploring the intrinsic properties of the signal injection techniques for hand tracking purposes. In an embodiment, software and hardware solutions can be combined with traditional fast multi-touch capabilities, exploring the same fast multi-touch sensor, or complementing a fast multi-touch touch sensor with additional receivers. In an embodiment, software and hardware solutions can be combined with traditional fast multi-touch capabilities, exploring the same fast multi-touch sensor, or complementing a fast multi-touch touch sensor with additional receivers and signal injectors.

It will be apparent to a person of skill in the art in view of this disclosure that the intrinsic properties of the signal injection as applied to and measured from the hand as described above can be used as the basis to define the model mapping. In an embodiment, the data technique is used to identify the adequate definition of the mapping functions which can be used for hand modeling, and thus hand tracking purposes. In an embodiment, the signal injection hardware and software as discussed above, can be combined with fast multi-touch capabilities, thus complementing a fast multi-touch touch sensor system with capacity to recognize additional injected frequencies.

It will be apparent to a person of skill in the art in view of this disclosure capacitive sensing has historically been used for two-dimensional positioning; detecting touch versus non-touch, or hard touch versus soft touch. Although capacitive sensing has some capability to detect hover, capacitive sensing was not known to be heretofore used to infer skeletal position. In an embodiment, the surface manifold can be conformed to a large variety of shapes, which can provide a known mathematical relation between sensors. Thus, in an embodiment, the surface manifold as conformed to an object can be mixed with a constrained model to infer skeletal position.

Where the surface manifold is conformed to a shape that itself is alterable or deformable within its own set of known constraints, the surface manifold can be used to track such alterations or deformations. For example, a manifold conformed to a folding object (e.g., folding smartphone) can use its own capacitive interaction and injected signals to interpret or infer the position of the phone. In another example, a game ball (e.g., a football or basketball) with known deformation characteristics when used can use a manifold conformed within or without its surface to interpret or infer its own deformation. Thus, in an embodiment, the surface manifold as conformed to an object can be mixed with a constrained model to infer information about the object.

Hand Modelling and Tracking with Multiple Devices and Users

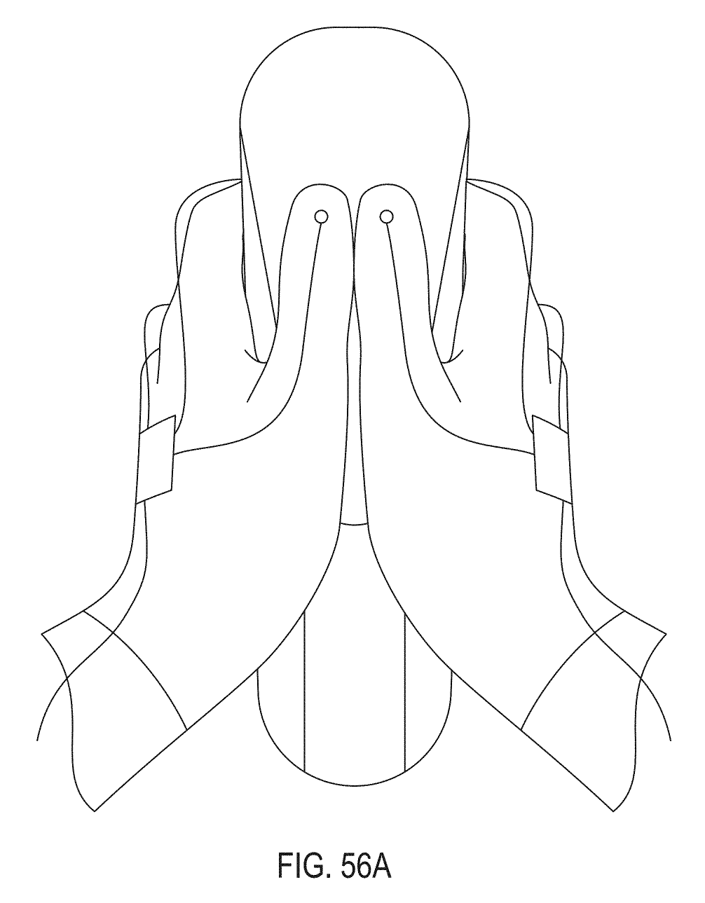

In many systems, bimanual input is desirable (see FIGS. 56A and 565B). In an embodiment, the user wears two gloves that inject signals into each hand. The two devices are configured to inject signals into the hands of the user as described above. In an embodiment, the user holds two devices with heterogeneous sensors, one in each hand. In an embodiment, a single device and its signal injectors are used to sense contact between fingers of different hands. The two devices are configured to inject signals into the hands of the user as described above. Additionally, injected signals from one device can be sensed by the other device when the user's hands come into contact with or close proximity to one another. In an embodiment, the pair of devices and signal injectors are used to sense contact between fingers of different hands.

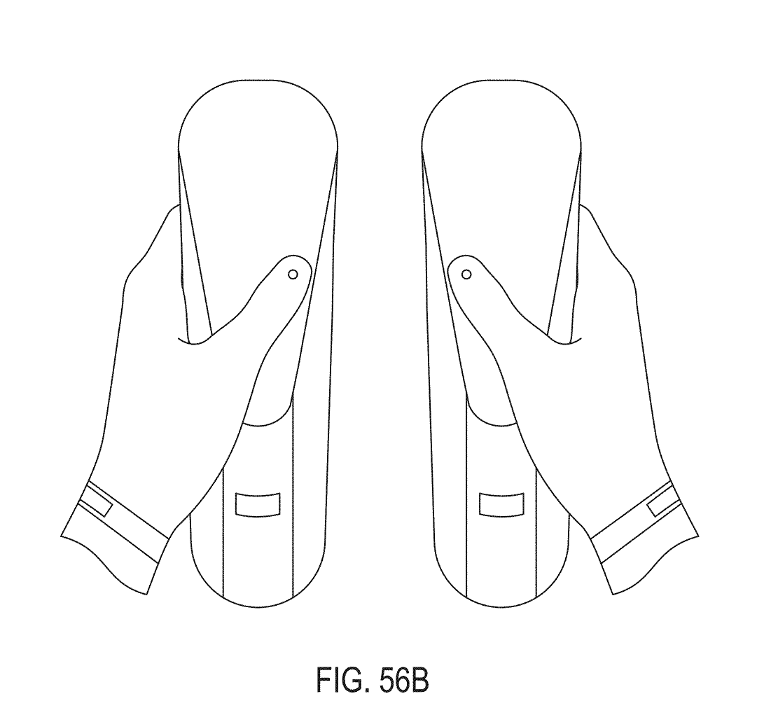

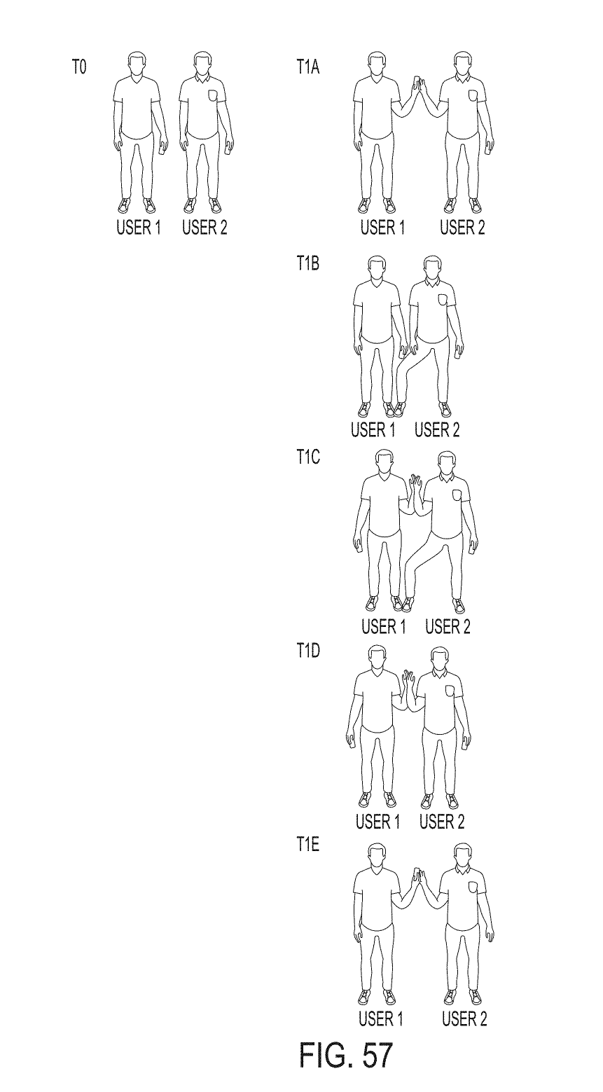

In many systems, multi-user input is desirable (see FIG. 57). In an embodiment, two or more users work with independent devices with heterogeneous sensors. In an embodiment, signals injected into the hands of one user can be detected by the device of another user when intentional (e.g., a handshake, fist-bump, or high-five) or unintentional contact is made between users. In an embodiment, the type of contact between users (e.g., a handshake, fist-bump, high-five or an unintentional or incidental contact) may be distinguished by the signals injected into the hands of one user that are detected by the device of another user. In an embodiment, signals injected into the hands of one user can be detected by signal receivers that are proximate to signal injectors of another user when contact (intentional or unintentional) is made. In an embodiment, the type of contact between users (e.g., a handshake, fist-bump, high-five or an unintentional or incidental contact) may be distinguished by the signals injected into the hands of one user that are detected by signal receivers that are proximate to signal injectors of another user.

In an embodiment, signals injected into the fingers of a user can be sensed by multiple devices with heterogeneous sensors, but it is not necessary for such devices to be associated with one or more signal injectors. In other words, as an example embodiment, two users may each use a wearable strap-based signal injector, each of the wearable strap-based injectors having their own frequency orthogonal signals—and each user may use one or more of a plurality of touch objects that can detect the frequency orthogonal signals of each of the two wearables.

The present systems are described above with reference to are described above with reference to block diagrams and operational illustrations of controllers and other objects sensitive to hover, contact and pressure using FMT or FMT-like systems. It is understood that each block of the block diagrams or operational illustrations, and combinations of blocks in the block diagrams or operational illustrations, may be implemented by means of analog or digital hardware and computer program instructions. Computer program instructions may be provided to a processor of a general-purpose computer, special purpose computer, ASIC, or other programmable data processing apparatus, such that the instructions, which execute via a processor of a computer or other programmable data processing apparatus, implements the functions/acts specified in the block diagrams or operational block or blocks.

Except as expressly limited by the discussion above, in some alternate implementations, the functions/acts noted in the blocks may occur out of the order noted in the operational illustrations. For example, the order of execution of blocks shown in succession may in fact be executed concurrently or substantially concurrently, or, where practical, any blocks may be executed in a different order with respect to the others, depending upon the functionality/acts involved.

### Signal Injection/Infusion for Enhanced Appendage Detection

This section relates to touch and in-air sensitive input devices, specifically input devices that sense the human hand on and/or above and/or near, the surface of the object. Signal injection (a/k/a signal infusion) can be used to enhance appendage detection and characterization. See, e.g., U.S. Provisional Patent Application No. 62/428,862 filed Dec. 1, 2016. The three-dimensional position, orientation and “curl” or “flex” of fingers on a hand holding a controller can be measured by infusing signals into the hand or other body party and measuring the contribution of each of these signals at various points on a controller (e.g., a handheld or hand operated controller). In an embodiment, infusion signals are measured at a sensor near the hand or as distance between the sensor and the hand changes. In an embodiment, the receive apparatus on the controller (i.e., the sensor) can be a capacitive sensor, especially a projected-capacitive sensor that uses simultaneous orthogonal signals.

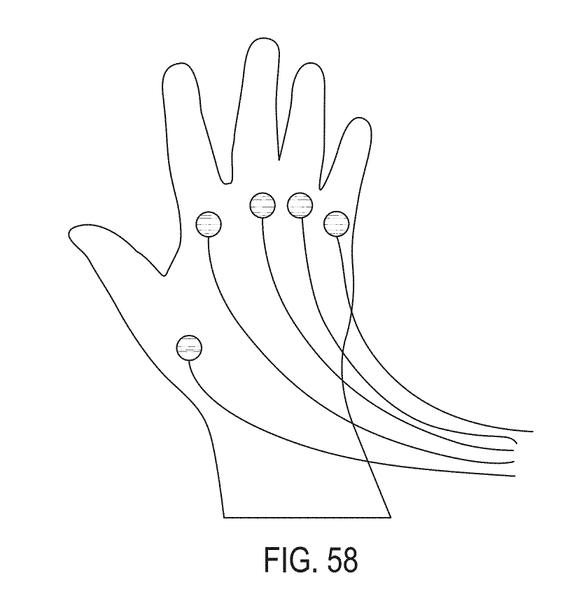

Briefly turning to FIG. 58, in an embodiment, signals may be infused into the hand in a manner that the signal levels should be different for each finger due to the different amounts of flesh through which the signals must pass. In an embodiment, each injected signal will be present on each finger, but in different amounts. In an embodiment, to determine the position of each finger, it will be necessary to determine the amounts of each signal to determine where one or more fingers are touching, or where one or more fingers are hovering.

Briefly turning to FIG. 59, there is illustrated the use of a strap, lanyard or glove to inject the signals into the hand. The strap, lanyard or glove may be designed to be form-fit to the hand, or may be elastic. One or more signals are injected into the hand by electrodes that are in capacitive or ohmic contact with the hand. The strap, lanyard or glove may infuse the signals near the fingers, or farther away. It may infuse them on the back or front of the hand, or on the surface of some other part of the body. For example, a wrist-strap may be used to infuse signals at that point.

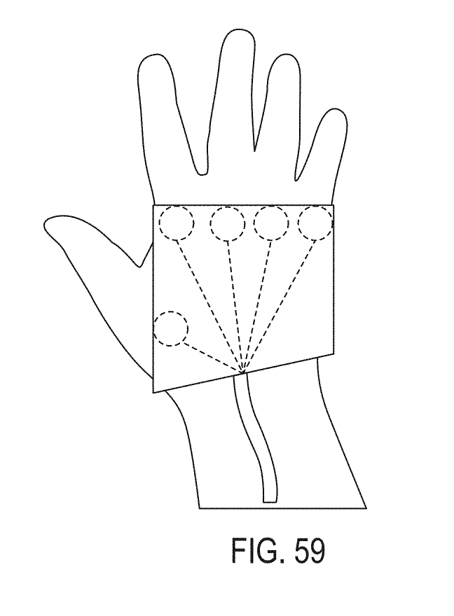

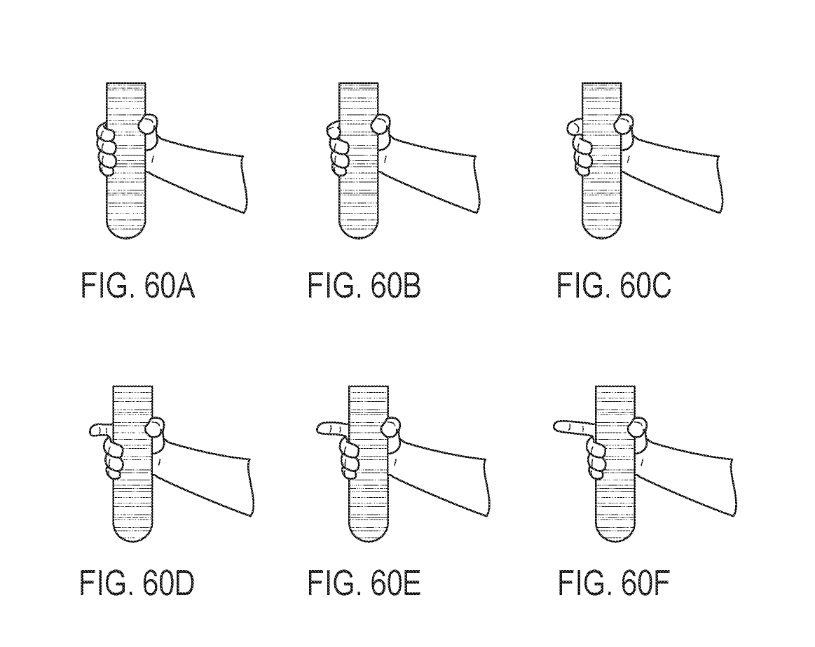

Briefly turning to FIGS. 60A-60F, illustrations of several hand poses are shown about an object to simulate grip on a generic version of a controller for a discussion concerning detecting the position and “curl” of a finger. In an embodiment, the index finger can be used as a trigger for the controller and thus, it may be desirable to determine its placement, how far it extends from the surface of the controller, and the angles of the finger joints. In an embodiment, because most sets of joint angles are unnatural positions (and so unlikely to occur), it may be sufficient to roughly determine position of the finger be able to deduce how the finger is positioned or curled.

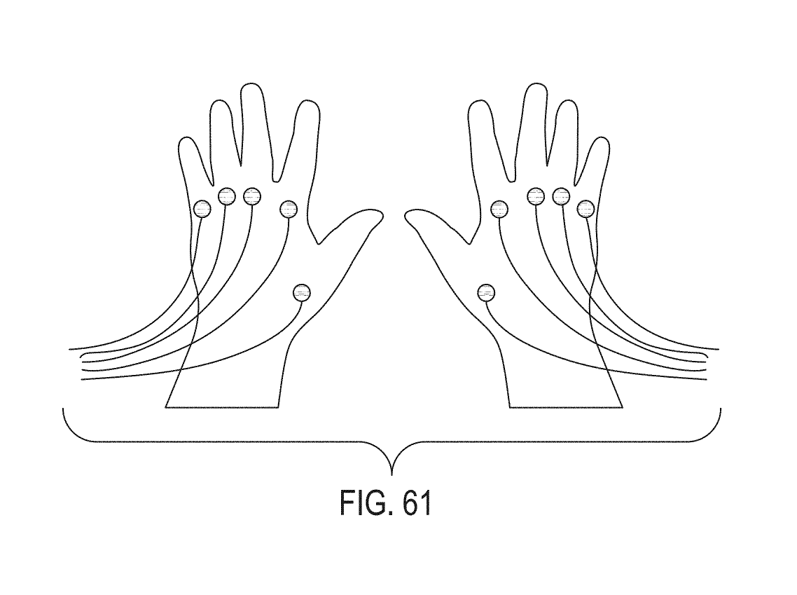

Turning briefly to FIG. 61, a bimanual variation of the embodiment shown in FIG. 58 is shown. Signals are infused into both hands of a user at a variety of locations. In an embodiment, signals from one hand flow through the fingers of the other hand when the hands are in close contact to one another or touching. Contact between fingers of the same hand (e.g. an OK gesture) create a path from one signal injector to another on the same hand, and contact between fingers of both hands (e.g. touching index fingers together) creates a path between signal injectors on both hands. In the case of a multi-user system, contact between the hands of multiple users creates a number of pathways for signals to travel that can be interpreted as command gestures.

With a controller (e.g., a game controller) or other user interface device, it is desirable to be able to detect and characterize the location of the holding hand's fingers, even when they are not actually touching the device. In an embodiment, an index finger can be detected as a “trigger finger”, and thus, an input device would sense its position and “curl”, including the parts of the finger that are not in contact with a touch-detecting surface.

In an embodiment, a game controller's surface is a touch sensitive surface (e.g., a detector or touch screen) that can detect where on the surface the hand and fingers are touching. In an embodiment, the touch sensitive surface is a capacitive touch screen or other touch surface, and small changes in capacitance are used to detect when conductive or capacitive objects touch or are “hovering” nearby. As used in this context, the hovering means sufficiently close to the touch surface to cause a recognizable change, despite the fact that the conductive or capacitive object, e.g., a finger, is not in actual physical contact with the touch surface.

In an embodiment, an electrical signal is injected (a/k/a infused) into the hand or other part of the body, and this signal (as conducted by the body) can be detected by the capacitive touch detector in proximity to the body, even when the body (e.g., hands, fingers or other part of the body) are not in direct contact with the touch surface. In an embodiment, this detected signal allows a proximity of the hand or finger or other body part to be determined, relative to the touch surface. In an embodiment, this detected signal allows a proximity and orientation of the hand or finger or other body part to be determined, relative to the touch surface.

In an embodiment, the signal infusion (also referred to as signal injection) described herein is deployed in connection with a capacitive touch detector that uses a plurality of simultaneously generated frequency orthogonal signals to detect touch and hover, including, without limitation, the touch sensitive surfaces illustrated in U.S. Pat. Nos. 9,019,224, 9,158,411 and 9,235,307, to name a few. In an embodiment, the infused signal is simultaneous with, and frequency orthogonal to, the plurality of simultaneously generated frequency orthogonal signals that are used to detect touch and hover. In an embodiment, each of a plurality of infusion signals are infused into the hand or finger at a location near the proximal knuckle (i.e., where the fingers join the hand). In an embodiment, one signal is infused proximate to a first finger, and another signal is injected proximate to another finger. In an embodiment, a plurality of unique, frequency orthogonal signals (which are both frequency orthogonal with the other infused signals and the signals used by the touch detector) are infused into the hand in a plurality of locations. In an embodiment, five unique, frequency orthogonal signals (which are both frequency orthogonal with the other infused signals and the signals used by the touch detector) are infused into the hand proximate to each finger (as used herein, the thumb being considered a finger).

The touch detector—which absent the infused signals is configured to measure and identify changes in the level of the frequency orthogonal signals that are received on receivers of the capacitive touch detector—is also configured to measure and identify changes in the level of the infused frequency orthogonal signals. Identification of the change in the infused frequency orthogonal signals, allows the proximity of the hand (or finger or some other body part) to be determined, relative to the touch surface. Orientation may also be determined from interpretation of the infusion signal as received by the touch sensor receivers.

In an embodiment, more than one electrical signal is infused into and conducted by the body, allowing the relative characteristics of these signals (as received by the touch detector) to be used to determine the relative proximity and orientation of the body or body parts to the touch surface. As an example, five infusion pads (e.g., electrodes) may be positioned proximate to the five knuckles where the fingers join to the hand, and ten unique, frequency orthogonal signals (frequency orthogonal with the other infused signals and the signals used by the touch detector) are infused into the hand, two via each of the five injector pads. In the example, each of the five injector pads conducts two separate signals to the hand. In an embodiment, each pair of signals are relatively distant frequencies from each other, e.g., one high and one low frequency in each pair, because higher and lower frequency signals have differing conduction characteristics across the body, and therefore differing detection characteristics at the touch sensor.

In an embodiment, the infusion signals are infused through a strap or lanyard that touches (or is in close proximity to) the user's hand, wrist or other body part. In an embodiment, one or more infusion pads or infusion electrodes are integrated into a strap or lanyard associated with the touch object including the touch surface. In an embodiment one or more infusion pads or electrodes are integrated into a wearable garment, e.g., a glove. In an embodiment, one or more infusion pads are integrated into an object in the physical environment, for example, but without limitation, a chair back, seat or arm, a table top, or a floor mat.

In an embodiment, the injected signals from the infusor's device (which may be a strap, lanyard, wearable or provided as an environmental source) are used to determine whether the infusor's device is being worn by or is in proper proximity to the user. In an embodiment, the injected signals from the infusor's device are used to determine whether a controller is being used without the benefit of the infusor's device.

In an embodiment, the “curl” of some or all of the fingers of the hand holding a controller can be determined by analyzing the relative characteristics of the injected signals as they are received by the touch detector. In an embodiment, these characteristics include the relative amplitudes and time offsets or phases of the received signals. In an embodiment, MIMO-like techniques (such as principal components analysis) are used to determine the relative contributions of infused signal received that are contributed by each finger. In an embodiment, a calibration step is performed and subsequent measurements are interpreted given the information in the calibration step. In an embodiment, the calibration step includes moving the fingers to specified positions while the contributions of the infusion signals are measured. In an embodiment, the calibration step includes performing a gesture or set of gestures with the fingers while the contributions of the infusion signals are measured.

In an embodiment, impedances are placed in series with the signal infusors to enhance the ability to distinguish the contributions of the infusion signals from what is received from each finger. In an embodiment, the impedances are resistances. In an embodiment, the impedances are capacitances. In an embodiment, the impedances are parallel and series combinations of resistors and capacitors. In an embodiment, the impedances are general and include resistance and reactance components that may vary according to frequency. In an embodiment, the impedances in series with the signal infusors have an impedance approximately the same as the impedance that would be experienced by the infused signal if it traversed the amount of human flesh equivalent to the distance between its infusion location and the bases of the other fingers. In an embodiment, signals infused into the fingers are used to sense contact between the fingers themselves. In an embodiment, the signal infusers are paired with signal receivers and the signals receive by such signal receivers are used to sense finger-to-finger contact.

In many systems, bimanual input is desirable. In an embodiment, a user holds two controllers, one in each hand. The two controllers are configured to infuse one or more distinct infusion signals into each of the hands of the user as described above. In an embodiment, infused signals from one controller can be sensed by the other controller when the user's hands come into contact with or close proximity to one another. In an embodiment, the pair of controllers and signal injectors are used to sense contact between fingers of different hands.

In many systems, multi-user input is desirable. In an embodiment, two or more users work with independent controllers. In an embodiment, signals infused into the hands of one user can be detected by the controller of another user when intentional (e.g., a handshake, fist-bump, or high-five) or unintentional contact is made between users. In an embodiment, the type of contact between users (e.g., a handshake, fist-bump, high-five or an unintentional or incidental contact) may be distinguished by the signals infused into the hands of one user that are detected by the controller of another user. In an embodiment, signals infused into the hands of one user can be detected by signal receivers that are proximate to signal infusors of another user when contact (intentional or unintentional) is made. In an embodiment, the type of contact between users (e.g., a handshake, fist-bump, high-five or an unintentional or incidental contact) may be distinguished by the signals infused into the hands of one user that are detected by signal receivers that are proximate to signal infusors of another user.

In an embodiment, signals infused into the fingers of a user can be sensed by multiple controllers, but it is not necessary for such controllers to be associated with one or more signal infusors. In other words, as an example embodiment, two users may each use a wearable strap-based signal infusor (which may look like, e.g., a watch), each of the wearable strap-based infusors having their own frequency orthogonal signals—and each user may use one or more of a plurality of touch objects that can detect the frequency orthogonal signals of each of the wearables.

In various embodiments, the controller/user-interface device may be one or more of the following—a handheld controller, a bimanual handheld controller, a VR headset, an AR headset, a keyboard, a mouse, a joystick, earphones, a watch, a capacitive touch sensitive mobile phone, a capacitive touch sensitive tablet, a touchpad, including a hover sensitive touchpad (e.g., as described in U.S. patent application Ser. No. 15/224,266), a touch keyboard (e.g., as described in U.S. patent application Ser. No. 15/200,642), or other touch sensitive objects (e.g., as described in U.S. patent application Ser. No. 15/251,859).

Other body parts and appendages can be measured as well, such as ears, nose, mouth, jaw, feet, toes, elbows, knees, chest, genitals, buttocks, etc. In an embodiment, a plurality of injector or infusor pads or electrodes are distributed among the body, each of the pads or electrodes infusing one or more signals that are unique and frequency orthogonal with respect to the others, and with those used by a sensing device with which interaction is desired or intended.

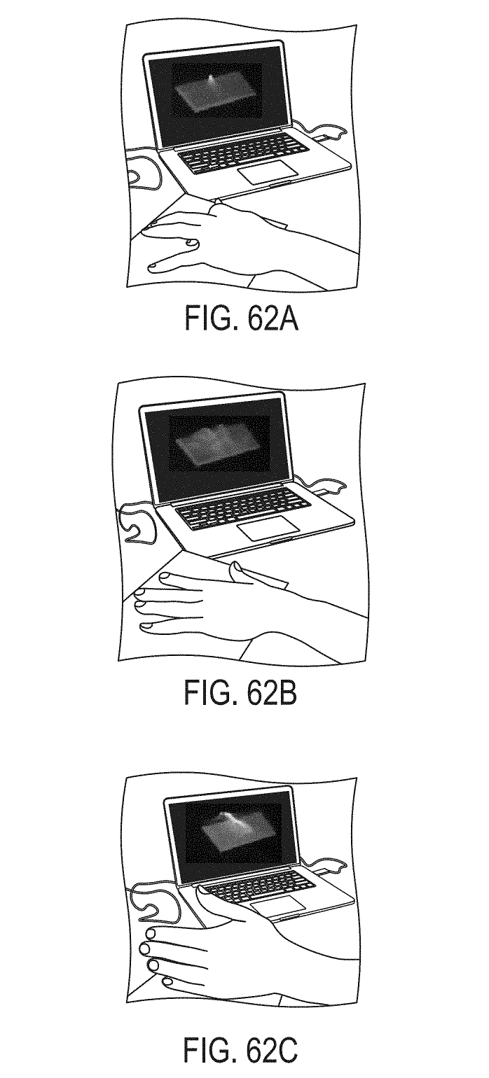

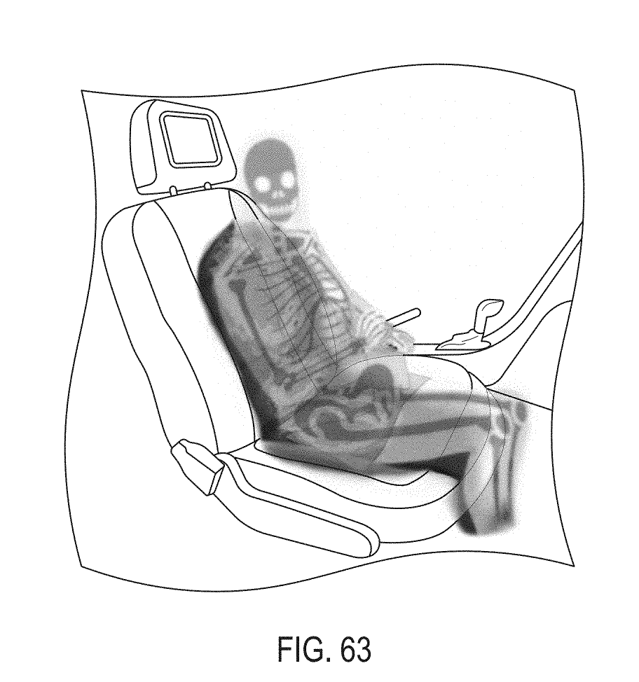

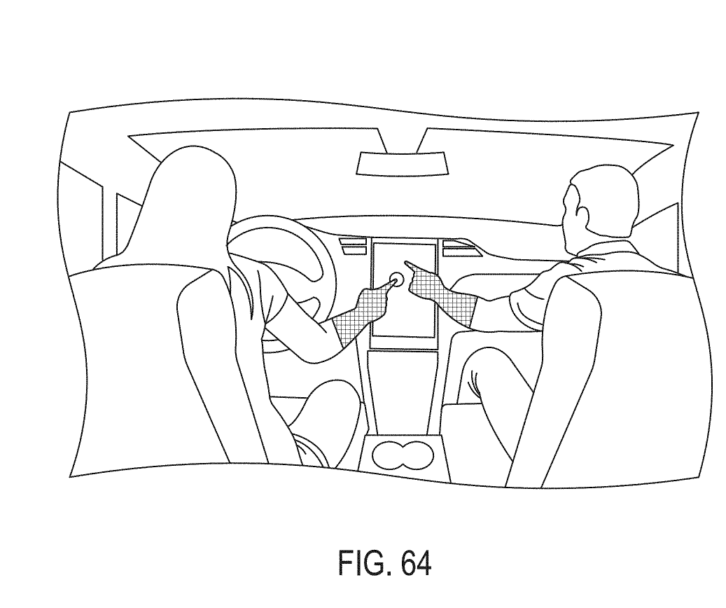

Turning to FIGS. 62A-62C, a capacitive and/or heterogeneous sensor integrated with a foam cushion is shown. In an embodiment, the flexible manifold may be joined above, below or with foam. FIGS. 62A-62C illustrate the sensitivity of a soft sensor. FIG. 63 shows an embodiment of soft foam capacitive and/or heterogeneous sensor being used to infer skeletal positioning in much the same manner as the capacitive and/or heterogeneous sensor described above inferred the skeletal position of the hand from sensor data.

In an embodiment, frequency injection from relatively large electrodes can be accomplished through clothing, fabric and foam to inject one or more signals into a person sitting in a seat, like the seat of an automobile. Accordingly, in an embodiment, signals are injected into a driver, and/or into a passenger in an automobile.

Turning to FIG. 64, there is an illustration of a heterogeneous flat panel display that can distinguish driver from passenger based on a frequency injection that may come from any other portion of the body. In an embodiment, frequency injectors may be present on one or more of the following: the seat, the seat back, the seat belt, the steering wheel, the footwell, the carpet in the footwell, or any other location likely to be proximate to the driver or the passenger, but not both. In an embodiment, two frequency-injected users can simultaneously use the same interface, being distinguished by the sensor, and thus the user interface.

Similarly, a heterogeneous sensor located on a steering wheel can take substantial advantage of a signal-injected driver—being able to distinguish the driver's input from other occupants, and being able to see the driver's hands approach the steering wheel from many centimeters away. In an embodiment, controls on the dashboard or other controls accessible to the driver provide a signal injection, thus allowing a heterogeneous sensor on the steering wheel to understand the location of the driver's other hand. In an embodiment, where the music system volume control injects one frequency, the tuning knob injects another frequency, and another control injects a third frequency, if the driver has one hand on the steering wheel and another touches one of these controls, it can be clearly detected. In an embodiment, with appropriate gain on the signal injectors, even the approach to injection points can be detected, thus permitting potential advance knowledge of potential or imminent driver interactions.

As disclosed herein, embodiments relate to using heterogeneous capacitive data from a surface manifold, discrete capacitive sensors, and frequency injection transmitters and receiving layers alongside a constrained model with limited degrees of freedom to infer skeletal positioning.

As disclosed herein, embodiments relate to a heterogeneous sensor for detecting touch and non-contact touch events (e.g., hover events) occurring more than a few millimeters from the sensor surface. In some embodiments, the sensor includes additional sensor layers. In some embodiments, the sensor comprises one or more receive antennas, which may be, but need not be, located on a common layer with the rows or the columns. In some embodiments, the sensor comprises one or more injection signal conductors, which may be, but need not be, located on a common layer with the rows or the columns.

As disclosed herein, embodiments relate to the orientation of a heterogeneous sensor manifold on the surface of an object. In some embodiments, the manifold includes additional sensor layers, which may be associated with drive circuitry to generate additional orthogonal signals for transmission thereupon. In some embodiments, the sensor comprises one or more receive antennas, which may be, but need not be, located on a common layer with the rows or the columns. In some embodiments, the sensor comprises one or more injection signal conductors, which may be, but need not be, located on a common layer with the rows or the columns, and which may be associated with drive circuitry to generate additional orthogonal signals for transmission thereupon.

As disclosed herein, embodiments relate to a heterogeneous sensor having drive circuitry for the rows, and drive circuitry for one or more additional antennas or rows, the signals simultaneously generated by the drive circuitries being orthogonal to one-another, which orthogonality may be, but is not necessarily limited to frequency orthogonality. In some embodiments, signals received by receivers are processed to determine a strength for each of the orthogonal signals, and this information may be used to determine touch events. In some embodiments, the touch events are associated with discrete sources, and a skeletal model may be inferred from the touch events.

As disclosed herein, embodiments relate to a heterogenous sensor that creates a first heatmap from orthogonal signals in a first range, and creates a separate heatmap from orthogonal signals in a second range. In some embodiments, the first heatmap is used as a basis to infer a, or multiple, skeletal models. In some embodiments, the second heatmap is used as a basis to infer a, or multiple, skeletal models. In some embodiments, the two heatmaps are both used as a basis to infer a, or multiple, skeletal models.

As disclosed herein, embodiments relate the measurement of the three-dimensional position, orientation, “curl” or flex, thickness, length, and abduction of the fingers, position, orientation, and length of the joints of the fingers, breadth of the palm, identification of the hand (i.e., right or left), and crossing of the fingers, of the hand holding a device with a heterogeneous sensor that are measured by the signals injected into the hand and the contribution of each of these signals at various points along the heterogeneous sensor.

As disclosed herein, embodiments relate to a system for modeling the movement of separate identifiable body parts (having a known relationship to each other) about a sensor having a plurality of receiver lines and a plurality of transmitter lines, and an infusion area, where a touch signal transmitter is associated with the plurality of transmitter lines and configured to simultaneously transmit a unique signal on each of the plurality of transmitter lines, and an infusion signal transmitter is associated with the infusion area and configured to transmit an infusion signal to the infusion area, a receiver is associated with each of the plurality of receiver lines, and a processor is configured to generate a heatmap reflecting touch signal interaction on the receiver lines, generate an infusion map reflecting the infusion signal interaction on the receiver lines, determine a boundary between identifiable body parts on the sensor based, at least, in part, on the heatmap and the infusion map, and output a model reflecting movement of the body parts about the sensor.

As disclosed herein, embodiments relate to a hand operated controller having at least one heterogeneous sensor manifold that surrounds at least a portion of the controller body. In some embodiments, the heterogeneous sensor manifold comprises a third layer of rows. In some embodiments, the heterogeneous sensor manifold comprises a third layer of columns. In some embodiments, the heterogeneous sensor manifold comprises a plurality of antennas. In some embodiments, an injection signal conductor supplies an injected signal, the injection signals may be, but need not be, on or within the manifold. In some embodiments, an injection signal conductor is internal to a hand held, hand worn, finger held, and/or finger worn, device, and may be, but need not be, physically separated from the device. In some embodiments, an injection signal conductor is external to a hand held, hand worn, finger held, and/or finger worn, device, and may be, but need not be, physically separated from the device.

As disclosed herein, embodiments of the sensor are deployed in a manner such that touch events can be used to infer a constrained skeletal model. In some embodiments, the sensor is deployed on a hand operated controller. In some embodiments the sensor is deployed on a hand held or worn input peripheral such as a stylus or mouse. In some embodiments the sensor is deployed as part of a hand held or worn artifact such as a bracelet, watch, ring, ball, smartphone, shoe, or tangible object. In some embodiments, the sensor is deployed proximate to the surface such as a steering wheel, keyboard, touchscreen, or flight control, and may be, but need not be also, deployed proximate to the surface of other areas within reach of the operator of that control (such as proximate to the surface of the dashboard, the surface of controls on the dashboard, or the surface of other controls). In some embodiments, the sensor, or additional sensors are deployed proximate to the surface of an operator seat, armrest, headrest, seat belt, or restraint. In some embodiments, one or more injection signal conductors supply an injected signal. In some embodiments, one or more injection signal conductors are deployed in, or proximate to, the sensor manifold. In some embodiments, one or more injection signal conductors are deployed in an operator seat, armrest, headrest, seat belt, or restraint.

As disclosed herein, embodiments of the sensor are deployed proximate to the surface of an object having known constraints of deformation such as a flexible screen or ball, and the sensor is used as a self-sensing mechanism to detect deformation. In some embodiments, one or more injection signal conductors are deployed in, or proximate to, the sensor manifold on the surface of the deformable object.

As disclosed herein, heterogeneous sensing may be accomplished using a combination of data reflecting mutual-capacitance and frequency injection. In some embodiments, heterogeneous sensing is accomplished using a combination of data reflecting mutual-capacitance, frequency injection, and cross-talk. In some embodiments, heterogeneous sensing is accomplished using a combination of data reflecting mutual capacitance and frequency injection, and a known constraint model or plurality of known constraint models, of which a known constraint model could, for example, be a model of object deformation or a model of skeletal constraints, such as a model of object pose or degrees of freedom. In some embodiments, a model of object pose or degrees of freedom could be further constrained by a shape, such as a hand controller shape, that limits the object's poses.

The present disclosure describes a sensor that combines the results of two separate types of sensing to enable better detection. The present disclosure describes a sensor receiving system that can receive and interpret two separate types of sensor data. The present disclosure describes a sensor that combines the results of two separate types of sensing using the same receivers to enable better detection. The present disclosure describes methods for combining the results of separate sensing data to reduce errors, improve accuracy and/or improve overall sensing. The present disclosure describes methods and apparatus to use signal infusion to enhance appendage detection. The present disclosure describes a method for determining finger separation from touch data using the results of a Fourier transform reflecting the interaction of touch with the sensor. The present disclosure also describes a method for determining finger separation from touch data and using infusion information to overcome various hand posture challenges that cannot be resolved using touch data. The present disclosure describes a sensor layout on controller, with a segmented spatial orientation that provides a robust heterogenous design to sense touch and infusion data.

The present disclosure describes, in an embodiment, a touch sensor having a plurality of row conductors on a first row layer and a plurality of column conductors on a first column layer, the path of each of the row conductors crossing the path of each of the column conductors, each of the plurality of column conductors being associated with a column receiver adapted to receive signals present on its associated column conductor, the touch sensor comprising, a second plurality of row conductors on a second row layer, each of the second plurality of row conductors being associated with a row receiver adapted to receive signals present on its associated row conductor; and a processor adapted to determine a strength for each of a plurality of unique orthogonal signals in a signal received by each row receiver and each column receiver. In an embodiment, the touch sensor has a manifold formed from the first row layer, the first column layer and the second row layer. In an embodiment, the touch sensor has the first row layer and the first column layer disposed on opposite sides of a common substrate. In an embodiment, the touch sensor has the second row layer disposed on a different substrate. In an embodiment the touch sensor has a manifold that has a surface adapted to conform to a surface of at least a portion of an object having a shape. In an embodiment the touch sensor has a manifold that has a surface adapted to conform to a flat surface of at least a portion of an object. In an embodiment the touch sensor has a plurality of row receivers that are part of one integrated circuit. In an embodiment the touch sensor has a plurality of column receivers that are part of one integrated circuit. In an embodiment the touch sensor has a plurality of column receivers and a plurality of the row receivers that are part of one integrated circuit.

The present disclosure describes in an embodiment, a touch sensor having a plurality of row conductors and a plurality of column conductors, the path of each of the row conductors crossing the path of each of the column conductors, each of the plurality of column conductors being associated with a column receiver adapted to receive signals present on its associated column conductor, the touch sensor comprising: a plurality of local antennas interleaved between the row conductors and the column conductors, each of the plurality of local antennas being associated with an antenna receiver adapted to receive signals present on its associated local antenna. In an embodiment the touch sensor has a processor adapted to determine a strength for each of a plurality of unique orthogonal signals in a signal received by each antenna receiver and each column receiver.

The present disclosure describes in an embodiment a touch sensor having a plurality of row conductors and a plurality of column conductors, the path of each of the row conductors crossing the path of each of the column conductors, each of the plurality of column conductors being associated with a column receiver adapted to receive signals present on its associated column conductor, the touch sensor comprising: a plurality of local antennas interleaved between the row conductors and the column conductors; first drive signal circuitry adapted to transmit a first plurality of orthogonal signals on the first plurality of row conductors, wherein each of the first plurality of orthogonal signals are orthogonal to each other of the first plurality of orthogonal signals; second drive signal circuitry adapted to transmit at least one additional orthogonal signal to at least one of the plurality of local antennas, the at least one additional orthogonal signal being orthogonal to each of the first plurality of orthogonal signals; and a processor adapted to determine a strength for each of a plurality of unique orthogonal signals and each of the at least one additional orthogonal signals in a signal received by each column receiver.

The present disclosure describes in an embodiment a touch sensor having a plurality of row conductors and a plurality of column conductors, the path of each of the row conductors crossing the path of each of the column conductors, each of the plurality of column conductors being associated with a column receiver adapted to receive signals present on its associated column conductor, the touch sensor comprising: a plurality of local antennae interleaved between the row conductors and the column conductors; first drive signal circuitry adapted to transmit a first plurality of orthogonal signals on the first plurality of row conductors, wherein each of the first plurality of orthogonal signals are orthogonal to each other of the first plurality of orthogonal signals; second drive signal circuitry adapted to transmit at least one additional orthogonal signal to at least one of the plurality of local antennae, the at least one additional orthogonal signal being orthogonal to each of the first plurality of orthogonal signals; and at least one of the plurality of local antenna being associated with an antenna receiver adapted to a receive signal present on its associated local antenna; and a processor adapted to determine a strength for each of a plurality of unique orthogonal signals and each of the at least one additional orthogonal signals in a signal received by each antenna receiver and each column receiver.

The present disclosure describes in an embodiment a touch sensor comprising a manifold having a plurality of row conductors and column conductors, the path of each of the row conductors crossing the path of each of the column conductors, the manifold having a surface adapted to conform to a surface of at least a portion of an object having a shape; a plurality of column receivers, each of the plurality of column receivers associated with each of the plurality of column conductors, and each of the plurality of column receivers adapted to receive signals present on the column for a duration (τ); signal processor adapted to process signals received by the column receivers to determine a signal strength for each of a plurality of orthogonal frequencies, the plurality of orthogonal frequencies being spaced apart from one another (Δf) by at least the reciprocal of the duration (1/τ); identifying from the determined signal strengths a first set of orthogonal frequencies in a first range, and creating a first heatmap reflecting signal strengths in the first range; and identifying from the determined signal strengths a second set of orthogonal frequencies in a second range, and creating a second heatmap reflecting signal strengths in the second range.

The present disclosure describes a touch sensor comprising a manifold having a plurality of row conductors and column conductors, the path of each of the row conductors crossing the path of each of the column conductors, the manifold having a surface adapted to conform to a surface of at least a portion of an object having a shape; a plurality of column receivers, each of the plurality of column receivers associated with each of the plurality of column conductors, and each of the plurality of column receivers adapted to receive signals present on the column for a duration (τ); signal processor adapted to process signals received by the column receivers to determine a signal strength for each of a plurality of orthogonal frequencies, the plurality of orthogonal frequencies being spaced apart from one another (Δf) by at least the reciprocal of the duration (1/τ); identifying touch events from the determined signal strengths of a first set of orthogonal frequencies in a first range; and identifying other touch events from the determined signal strengths of a second set of orthogonal frequencies in a second range. In an embodiment. the first range and the second range are ranges of frequency. In an embodiment, the first range and the second range are ranges of amplitude.

The present disclosure describes a touch sensing system having a manifold having a plurality of row conductors and column conductors, the path of each of the row conductors crossing the path of each of the column conductors, the manifold having a surface adapted to conform to a surface of at least a portion of an object having a shape; first drive signal circuitry adapted to transmit a first plurality of orthogonal signals on the row conductors, respectively, wherein each of the first plurality of orthogonal signals are orthogonal to each other of the first plurality of orthogonal signals; second drive signal circuitry adapted to conduct at least one additional orthogonal signal on a body of a user, the at least one additional orthogonal signal being orthogonal to each of the first plurality of orthogonal signals; plurality of column receivers, each of the plurality of column receivers associated with separate ones of the plurality of column conductors, and each of the plurality of column receivers adapted to receive a signal present its associated conductive column for a duration (τ); signal processor adapted to determine from a signal received by the column receivers a signal strength for each of a plurality of orthogonal frequencies and the at least one additional signal, wherein each of the plurality of orthogonal frequencies and the at least one additional signal are spaced apart from one another (Δf) by at least the reciprocal of the duration (1/τ); identifying a first set of orthogonal frequencies having a determined signal strength in a first range and creating a first touch-related heatmap reflecting determined signal strengths in the first range; identifying a second set of orthogonal frequencies having a determined signal strength in a second range, and creating a second touch-related heatmap reflecting signal strengths in the second range.

The present disclosure describes a touch sensing system comprising manifold having a plurality of row conductors and column conductors and at least three antennae, the path of each of the row conductors crossing the path of each of the column conductors, the manifold having a surface adapted to conform to a surface of at least a portion of an object having a shape; first drive signal circuitry adapted to transmit a first plurality of orthogonal signals on the row conductors, respectively, wherein each of the first plurality of orthogonal signals are orthogonal to each other of the first plurality of orthogonal signals; second drive signal circuitry adapted to conduct at least one additional orthogonal signal on a body of a user, the at least one additional orthogonal signal being orthogonal to each of the first plurality of orthogonal signals; plurality of column receivers, each of the plurality of column receivers associated with separate ones of the plurality of column conductors, antenna receiver associated with each one of the at least three antennae; each of the plurality of column receivers and antenna receivers adapted to receive a signal present its associated conductive column or antenna during a measurement period (τ); and signal processor adapted to: determine from a plurality of received signal a signal strength for each of a plurality of orthogonal frequencies and the at least one additional signal; identify a first set of orthogonal frequencies having a determined signal strength in a first range and creating a first heatmap reflecting determined signal strengths in the first range; and identify a second set of orthogonal frequencies having a determined signal strength in a second range, and creating a second heatmap reflecting signal strengths in the second range.

The present disclosure describes a touch sensor comprising a manifold having a plurality of row conductors and column conductors and at least one injection signal conductor, the path of each of the row conductors crossing the path of each of the column conductors, the manifold having a surface adapted to conform to a surface of at least a portion of an object having a shape; first drive signal circuitry adapted to transmit a first plurality of orthogonal signals on the row conductors, respectively, wherein each of the first plurality of orthogonal signals are orthogonal to each other of the first plurality of orthogonal signals; and second drive signal circuitry adapted to conduct an additional orthogonal signal on each of the at least one injection signal conductor, each additional orthogonal signal being orthogonal to each of the first plurality of orthogonal signals.

The present disclosure describes a touch sensor comprising a manifold having a plurality of rows conductors and column conductors and a plurality of antennas, the path of each of the row conductors crossing the path of each of the column conductors, the manifold having a surface adapted to conform to a surface of at least a portion of an object having a shape; the plurality of antennas including a set of injection antennas and a set of receive antennas; first drive signal circuitry adapted to transmit a first plurality of orthogonal signals on the row conductors, respectively; second drive signal circuitry adapted to conduct second plurality of orthogonal signals on the set of injection antennas, respectively; wherein each of the first plurality of orthogonal signals and the second plurality of orthogonal signals are orthogonal to each other of the first plurality of orthogonal signals and the second plurality of orthogonal signals. In an embodiment the touch sensor further comprises a plurality of column receivers, each of the plurality of column receivers associated with separate ones of the plurality of column conductors columns, each of the plurality of column receivers adapted to receive a signal present its associated conductive column during a measurement period (τ); and a plurality of antenna receivers, each of the plurality of antenna receivers associated with separate ones of the set of receive antennas, each of the plurality of antenna receivers adapted to receive a signal present its associated receive antenna during the measurement period (τ). In an embodiment the touch sensor further comprises a signal processor adapted to: determine from a plurality of received signals a signal measurement for each of the first and second plurality of orthogonal signals; identify a first set of orthogonal frequencies having a determined signal measurement in a first range and creating a first touch-related heatmap reflecting determined signal measurements in the first range; identify a second set of orthogonal frequencies having a determined signal measurement in a second range, and creating a second touch-related heatmap reflecting signal measurements in the second range.

The present disclosure describes a hand operated controller comprising: a body portion, with a curved finger area around which a user's fingers may wrap, the finger area having a vertical axis; manifold comprising a plurality of row conductors in a first layer, a plurality of column conductors in a second layer, the path of each of the row conductors in the first layer crossing the path of each of the column conductors in the second layer; a plurality of additional row conductors in a third layer, and the manifold being disposed upon a surface of at least a portion of the body portion; at least one injection signal conductor; each of the plurality of row conductors in the first layer and each of the at least one injection conductors being associated with a drive signal circuit, the drive signal circuit adapted to transmit a unique orthogonal signal upon each; each unique orthogonal signal being orthogonal to each other unique orthogonal signal; each of the plurality of column conductors being associated with a column receiver adapted to receive signals present on its associated column; and each of the plurality of additional row conductors in the third layer being associated with a row receiver adapted to receive signals present thereon. In an embodiment the hand operated controller has a first layer and second layer disposed on opposite sides of the same substrate. In an embodiment the hand operated controller has a signal processor adapted to determine from a plurality of received signals a signal strength for each unique orthogonal signal; identify a first set of orthogonal frequencies having a determined signal measurement in a first range and creating a first touch-related heatmap reflecting determined signal measurements in the first range; identify a second set of orthogonal frequencies having a determined signal measurement in a second range, and creating a second touch-related heatmap reflecting signal measurements in the second range. In an embodiment the hand operated controller further comprises a signal processor adapted to determine from a plurality of received signals a signal strength for each unique orthogonal; identify touch events from the determined signal strengths of a first set of orthogonal frequencies in a first range; and identify other touch events from the determined signal strengths of a second set of orthogonal frequencies in a second range. In an embodiment the hand operated controller has a manifold that further comprises a plurality of antenna, and the device further comprise an antenna receiver associated with each one of the plurality of antenna, the antenna receiver adapted to receive signals present on its associated antenna. In an embodiment the hand operated controller further has a thumb portion having a widthwise axis normal to the vertical axis of the body portion; second manifold comprising a plurality of thumb-portion rows in a first thumb-portion layer, a plurality of thumb-portion columns in a second thumb-portion layer, the path of each of the thumb-portion rows crossing the path of each of the thumb-portion columns, the second manifold being disposed upon a surface of at least a portion of the thumb-portion.

The present disclosure describes a hand operated controller comprising a body portion, with a curved finger area around which a user's fingers may wrap, the finger area having a vertical axis; a manifold comprising a plurality of row conductors in a first layer, a plurality of columns in a second layer, the path of each of the row conductors in the first layer crossing the path of each of the columns in the second layer, a plurality of antenna, and the manifold being disposed upon a surface of at least a portion of the body portion; antenna receiver associated with each one of the plurality of antenna, the antenna receiver adapted to receive signals present on its associated antenna, at least one injection signal conductor; each of the plurality of row conductors in the first layer and each of the at least one injection conductors being associated with a drive signal circuit, the drive signal circuit adapted to transmit a unique orthogonal signal upon each; each unique orthogonal signal being orthogonal to each other unique orthogonal signal; each of the plurality of columns being associated with a column receiver adapted to receive signals present on its associated column; and the injection signal conductor being associated with a row receiver adapted to receive signals present thereon.

Although examples have been fully described with reference to the accompanying drawings, it is to be noted that various changes and modifications will become apparent to those skilled in the art. Such changes and modifications are to be understood as being included within the scope of the various examples as defined by the appended claims.

What is claimed is:

1. Touch sensor having a plurality of row conductors on a first row layer and a plurality of column conductors on a first column layer, the path of each of the row conductors and the path of each of the column conductors being oriented such that a touch event proximate to the touch surface causes a change in coupling between at least one of the row conductors and at least one of the column conductors, each of the plurality of column conductors being associated with a column receiver adapted to receive signals present on its associated column conductor, the touch sensor comprising:
a second plurality of row conductors on a second row layer, each of the second plurality of row conductors being associated with a row receiver adapted to receive signals present on its associated row conductor; and
processor adapted to determine a measurement for each of a plurality of unique orthogonal signals in a signal received by each row receiver and each column receiver.

2. The touch sensor of claim 1, further comprising:
manifold formed from the first row layer, the first column layer and the second row layer.

3. The touch sensor of claim 2, wherein the first row layer and the first column layer are disposed on opposite sides of a common substrate.

4. The touch sensor of claim 2, wherein the manifold has a surface adapted to conform to a surface of at least a portion of an object having a shape.

5. The touch sensor of claim 1, wherein a plurality of the column receivers and a plurality of the row receivers are part of one integrated circuit.

6. Touch sensor having a plurality of row conductors and a plurality of column conductors, the path of each of the row conductors and the path of each of the column conductors being oriented such that a touch event proximate to the touch sensor causes a change in coupling between at least one of the row conductors and at least one of the column conductors, each of the plurality of column conductors being associated with a column receiver adapted to receive signals present on its associated column conductor, the touch sensor comprising:
a plurality of antennas interleaved between the row conductors and the column conductors, each of the plurality of antennas being associated with an antenna receiver adapted to receive signals present on its associated antenna.

7. The touch sensor of claim 6, further comprising;
a processor adapted to determine a measurement for each of a plurality of unique orthogonal signals in a signal received by each antenna receiver and each column receiver.

8. The touch sensor of claim 6, further comprising a plurality of signal injection conductors interleaved between the row conductors and the column conductors.

9. The touch sensor of claim 6, further comprising first drive signal circuitry adapted to transmit a first plurality of orthogonal signals on the first plurality of row conductors, wherein each of the first plurality of orthogonal signals are orthogonal to each other of the first plurality of orthogonal signals;
second drive signal circuitry adapted to transmit at least one additional orthogonal signal to at least one of the plurality of antennas, the at least one additional orthogonal signal being orthogonal to each of the first plurality of orthogonal signals; and
processor adapted to determine a measurement for each of a plurality of unique orthogonal signals and each of the at least one additional orthogonal signals in a signal received by each column receiver.

10. The touch sensor of claim 6, further comprising a plurality of signal injection conductors interleaved between the row conductors and the column conductors.

11. The touch sensor of claim 6 further comprising:
manifold formed from the plurality of row conductors and the plurality of column conductors.

12. A sensor system comprising:
a signal injection conductor located on a body, wherein the signal injection conductor is adapted to transmit a signal through the body;
a plurality of antennas, wherein the plurality of antenna are adapted to receive signals transmitted through the body; and
a processor adapted to determine a measurement for each of the signals transmitted through the body, wherein the measurements are used to determine a position of a portion of the body when compared to a predetermined model.

13. The sensor system of claim 12, wherein each of the plurality of antennas is surrounded by ground.

14. Touch sensor comprising:
manifold having a plurality of row conductors and column conductors, the path of each of the row conductors and the path of each of the column conductors being oriented such that a touch event proximate to the manifold causes a change in coupling between at least one of the row conductors and at least one of the column conductors, the manifold having a surface adapted to conform to a surface of at least a portion of an object having a shape;
plurality of column receivers, each of the plurality of column receivers associated with each of the plurality of conductive columns, and each of the plurality of column receivers adapted to receive signals present on the column for a duration (τ);
signal processor adapted to process signals received by the column receivers to determine a signal measurement for each of a plurality of orthogonal frequencies, the plurality of orthogonal frequencies being spaced apart from one another (Δf) by at least the reciprocal of the duration (1/τ);
identifying from the determined signal measurements a first set of orthogonal frequencies in a first range, and creating a first heatmap reflecting signal measurements in the first range; and
identifying from the determined signal measurements a second set of orthogonal frequencies in a second range, and creating a second heatmap reflecting signal measurements the second range.

15. The touch sensor of claim 14, further comprising a split in the manifold, wherein the split in the manifold forms at least a first region and a second region.

16. The touch sensor of claim 14, wherein the first range and the second range are ranges of frequency.

17. Touch sensor comprising:
manifold having a plurality of row conductors and column conductors, the path of each of the plurality of row conductors and the path of each of the plurality of column conductors being oriented such that a touch event proximate to the manifold causes a change in coupling between at least one of the plurality of row conductors and at least one of the plurality of column conductors, the manifold having a surface adapted to conform to a surface of at least a portion of an object having a shape;
first drive signal circuitry adapted to transmit a first plurality of orthogonal signals on each the plurality of row conductors, respectively, wherein each of the first plurality of orthogonal signals are orthogonal to each other of the first plurality of orthogonal signals;
second drive signal circuitry adapted to conduct an additional orthogonal signal on at least one injection signal conductor, each additional orthogonal signal being orthogonal to each of the first plurality of orthogonal signals.

18. Touch sensor comprising:
manifold having a plurality of row conductors and column conductors, the path of each of the plurality of row conductors and the path of each of the plurality of column conductors being oriented such that a touch event proximate to the manifold causes a change in coupling between at least one of the plurality of conductive rows and at least one of the plurality of conductive columns, the manifold having a surface adapted to conform to a surface of at least a portion of an object having a shape;
a plurality of signal injection conductors;
first drive signal circuitry adapted to transmit a first plurality of orthogonal signals on the row conductors, respectively;
second drive signal circuitry adapted to conduct a second plurality of orthogonal signals on the plurality of signal injection conductors, respectively;
wherein each of the first plurality of orthogonal signals and the second plurality of orthogonal signals are orthogonal to each other of the first plurality of orthogonal signals and the second plurality of orthogonal signals.

19. The touch sensor of claim 18, further comprising:
signal processor adapted to:
determine from a plurality of received signals a measurement for each of the first and second plurality of orthogonal signals;
identify a first set of orthogonal frequencies having first determined measurements and creating a first touch-related heatmap reflecting the first determined measurements;
identify a second set of orthogonal frequencies having second determined measurements and creating a second touch-related heatmap reflecting the second determined measurements.

20. A hand operated controller comprising:
body portion, with a curved finger area around which a user's fingers may wrap, the finger area having a vertical axis;
manifold comprising;
a plurality of row conductors in a first layer,
a plurality of column conductors in a second layer, the path of each of the row conductors in the first layer and the path of each of the column conductors in the second layer being oriented such that a touch event proximate to the manifold causes a change in coupling between at least one of the plurality of row conductors and at least one of the plurality of column conductors, and
a plurality of additional row conductors in a third layer,
the manifold being disposed upon a surface of at least a portion of the body portion;
at least one signal injection conductor;
each of the plurality of row conductors in the first layer and each of the at least one signal injection conductors being associated with a drive signal circuit, the drive signal circuit adapted to transmit a unique orthogonal signal upon each;
each unique orthogonal signal being orthogonal to each other unique orthogonal signal;
each of the plurality of column conductors being associated with a column receiver adapted to receive signals present on its associated column conductor; and
each of the plurality of additional row conductors in the third layer being associated with a row receiver adapted to receive signals present thereon.

21. The device of claim 20, further comprising:
signal processor adapted to:
determine from a plurality of received signals a measurement for each unique orthogonal;
identify a first set of orthogonal frequencies having a first determined measurements and creating a first touch-related heatmap reflecting the first determined measurements; and
identify a second set of orthogonal frequencies having a second determined measurements, and creating a second touch-related heatmap reflecting the second determined measurements.

22. The device of claim 20, further comprising:
thumb portion having a widthwise axis normal to the vertical axis of the body portion;
second manifold comprising a plurality of thumb-portion row conductors in a first thumb portion layer, a plurality of thumb-portion column conductors in a second thumb-portion layer, the path of each of the thumb-portion row conductors and the path of each of the thumb-portion column conductors being oriented such that a touch event proximate to the second manifold causes a change in coupling between at least one of the plurality of thumb-portion row conductors and at least one of the plurality of thumb-portion column conductors, the second manifold being disposed upon a surface of at least a portion of the thumb-portion.
